(19) United States
(12) Patent Application Publication
(10) Pub. No.: US 2018/0330303 A1
(43) Pub. Date: Nov. 15, 2018

(54) Systems and Methods for Analyzing Recognition and Feedback Data for Talent and Culture Discovery

(71) Applicant: Globoforce Limited, Southboro, MA (US)

(72) Inventors: Eric Mosley, Wellesley, MA (US); Grant Beckett, Wellesley, MA (US); Julie Sargent, Clinton, MA (US); Jonathan Hyland, Dublin (IE)

(21) Appl. No.: 15/991,530

(22) Filed: May 29, 2018

Related U.S. Application Data
(63) Continuation-in-part of application No. 15/184,527, filed on Jun. 16, 2016.
(60) Provisional application No. 62/512,162, filed on May 29, 2017.

(51) Int. Cl. G06Q 10/06; G06F 3/0481

(52) U.S. Cl. CPC G06Q 10/06398; G06F 3/04817

(57) ABSTRACT

A system and method for promoting employee recognition and feedback are disclosed. The system is programmed to automatically collect and monitor an organization to detect recognition and feedback moments between employees and teams of the organization. Embodiments of the invention further facilitate the composition and delivery of feedback and recognition through real-time sentiment analysis of user-entered feedback. Additional embodiments are directed to the analysis of the feedback and recognition data to improve employee performance, engagement, and the company culture.

### RELATED APPLICATIONS

This application is a Continuation-In-Part application of U.S. patent application Ser. No. 15/184,527, filed Jun. 16, 2016, which claims priority to Provisional application Ser. No. 62/180,049 filed on Jun. 16, 2015. This application hereby further claims priority to and incorporates by reference U.S. Provisional Application Ser. No. 62/512,162, filed on May 29, 2017. This application further is related to and incorporates by reference U.S. Provisional Application Ser. No. 61/568,999 filed on Dec. 9, 2011, U.S. application Ser. No. 13/708,707 filed Dec. 7, 2012 and PCT Application Serial No. PCT/US12/68549 filed Dec. 7, 2012. All of the foregoing applications are incorporated herein by their entirety.

### FIELD OF THE INVENTION

Embodiments of the invention relate generally to systems and methods for promoting recognition and feedback of people and teams within an organization and performing data analytics to further improve employee performance, engagement, and company culture.

### BACKGROUND OF THE INVENTION

Performance reviews and rewards and recognition through formal programs are known in the art. Employees may be provided with constructive comments or recognized by their employers through “point-in-time” performance reviews or through traditional recognition programs. Typical rewards may range from stock options and bonuses, to “employee of the month” plaques on the wall of employee break-rooms, for example. While these programs do provide employees with feedback from time-to-time, these solutions are deeply flawed and provide limited benefits.

For instance, performance reviews are a traditional part of talent assessment and typically involve aggregating comments from managers according to an arbitrary calendar demarcation (i.e., bi-annually). An employee's direct manager may review the aggregated comments and provide the employees with the results, often by analyzing both positive and negative contributions of an employee.

However, these performance reviews are flawed as they fail to provide an accurate, ongoing assessment of an employee's potential, performance, and value to the company. For one, many of these reviews are provided by a limited subset of the company population. The employee's true impact on the organization, including his or her impact on other employees, managers, divisions, groups or teams is typically not collected. Instead, reviews are typically given only by direct-managers of employees. As a result, only a limited portion of the employee's impact may be realized through the collection of comments provided by only the employee's direct supervisor. Therefore, the data collected and relied upon may not adequately provide a meaningful and complete picture in determining the employee's performance and impact with respect to the company.

Furthermore, performance reviews are often entirely based on the subjective opinions of the managers, which may also vary from manager to manager. Such opinions, while important, may be inaccurate or flawed. Moreover, the comments and feedback collected from the performance reviews are limited to a single point in time. Managers and other reviewers are often asked to provide their opinion of the employee's performance once per review period. Therefore, as is the usual case, managers are asked once, or at most twice a year, to review the employee's work from the past 6 to 12 months. While such feedback theoretically should provide data of the employee's work for the entire review period, the nature of the single point-in-time review ultimately results in the review of the employee's performance only at the particular review date, potentially ignoring the employee's performance for much of the review period.

By the nature of these reviews, it is also difficult for a manager to recall, much less analyze, the performance of the employee over such a long period and from so far in the past. Yet, these performance reviews are dependent on such subjective and potentially inaccurate data. Even if the reviews are assumed to be accurate at the time of writing to cover the entire review period, it often takes weeks or months for feedback to be provided to the employee. As a result, by the time the employee receives feedback, it is likely out of date.

Additionally, employees are often not formally recognized for personal events outside of the work environment. For example, platforms are not formally in place for employees to inform managers or colleagues of upcoming life events, such as the birth of a child, and vice versa, for colleagues or managers to congratulate their peers.

Point-in-time performance reviews also limit employers from reviewing the employees at any desired time. Instead, employers must often wait until the end of each review period, after review forms are provided to managers and after the reviews have been completed and analyzed—a formalistic process that can take months. Accordingly, employers can only determine an employee's performance and impact on the company once a review period, e.g., once every year.

As with performance reviews, companies also often utilize recognition programs in an attempt to reward employees performance, such as by rewarding standout employees with a plaque or a special bonus quarterly or annually. However, these recognition programs also provide limited benefits. For instance, these programs are typically limited to only managers or senior managers nominating their employees for quarterly or annual awards whereby the winners are selected by a committee with only a small percentage of the entire workforce (e.g., less than 10%) receiving any type of recognition award on an annual basis. By failing to provide full participation to the workforce with a free flow of recognition moments, these programs fail to identify relationships among employees and various other organizational members and fail to fully incentivize beneficial employee actions.

Furthermore, typical employee recognition programs fail to capture all of an employee's “recognition moments,” such as those opportunities to “recognize” an employee's contributions or efforts and improve the organizational climate and culture, as well as promote the employee's actions that initiated the recognition moment. Employees are unlikely to receive recognition for actions and performance that otherwise should be recognized, even if in minor ways. Indeed, the typical recognition programs provide a minimal amount of recognition and fail to, therefore, drive improvement in behavior and culture across the entire workforce.

Recognition programs and point-in-time reviews also provide employers with a very little data that describes employee performance, impact and potential. While reviews, plaques and bonuses provide employers with some insight into the employee's impact, this limited set of data fails to capture a plethora of other meaningful metrics of the employees at the individual, team and organizational level. Even when data is provided, it is often difficult to understand and it fails to provide a comprehensive picture of the employee's performance. Moreover, they fail to provide employers with insight into the performance, impact and potential of each employee with respect to other employees within the organization. Critical talent information is extremely important to a business's success, and holds great value. Key understandings about employees at large companies, such as their likelihood of leaving the company, their engagement in their work, their connectedness to others in the organization, their readiness for promotion and other information, have quantifiable value. For example, the costs of turnover are usually estimated at 30-50 percent of the annual salary of entry-level employees, 150 percent for middle level employees, and up to 400 percent for specialized, high-level employees. However, currently available recognition programs and point-in-time reviews do not provide employers with such important information.

Existing recognition programs also lack the ability to analyze and compile complex data that can be used for quickly determining recognitions and quickly delivering recognition over a network. Existing recognition programs further lack the ability to provide feedback in real-time, referencing databases, to the recognizer regarding, for example, the language or tone of the recognition. Existing recognition programs are not interactive, and do not allow for crowdsourced funding to be automatically pulled and allocated, over a network, for a recognizee.

Employee recognition programs and point-in-time reviews can be an important aspect of creating a positive organizational climate and organizational culture and for promoting and encouraging effective skills, habits and behaviors by an employee. Employee recognition programs may deliver the most impact to the culture of an organization and overall employee engagement in the business of the organization when all employees (not just managers) are encouraged to recognize other employee's work efforts and their demonstration of the behavioral values of the company. A well designed and implemented program may allow for any employee to recognize and to provide feedback to any other employee with little corporate friction (e.g., by not requiring multiple levels of approval or by not limiting the number of award winners by committee selection). Awards may also be collected and delivered in various formats. Yet, current solutions fail to fully provide companies with these potential benefits.

There is a need for a system that can improve upon the deficiencies of currently utilized employee recognition programs and point-in-time reviews currently utilized as a means to collect, analyze and provide data on employee performance, impact, and potential. There is a need to provide all employees and supervisors, alike, with a solution that can allow for the recognition and feedback of beneficial actions and the impact of employees in “real-time,” such that employees may be awarded for actions that align with corporate goals and values. Recognitions and feedback should not be limited to those within an employee's team or division, as a solution should recognize that employees may have substantial impact on the company in a number of facets and manners, including impact on other teams and divisions, or even on other organizations. Nor should recognitions and feedback be limited to a single point-in-time, but rather, should be generally available, providing employees with incentive to perform and improve the company in accordance with the company's goals and, in return, be recognized at any time of the year. As a further benefit, the data collected may more accurately reflect the employee's impact on the company.

A need further exists to automatically collect and analyze these recognition and feedback moments and provide employers with real-time access to such data in a manner that will allow the employers to easily and efficiently determine employee performance, influence, and impact in the organization. The solution should dynamically provide data in manners that will allow the employers to easily understand multiple facets of their employees, their teams, and the organization whole at any number of data levels and to understand the employees' impact on the company with respect to other employees. As examples, managers should be able to determine which employees have and will, in the future, help the company achieve corporate objectives and to identify relationships among organizational members and relative employee ranking, rating, or scoring on talent attributes such as performance, potential, influence, connectedness, flight risk, amongst others. The solution may utilize statistical analysis and predictive analytics techniques upon the core employee data, recognition and feedback activity, and behavioral patterns in order to derive probability ratings for various talent attributes. Indeed, the solution should overcome the deficiencies identified above with respect to currently available programs and employee reviews.

### SUMMARY OF THE INVENTION

Embodiments of the invention provide members, teams, and other groups with tools for collecting and creating recognition and feedback activity in real-time (i.e., as recognition and feedback are earned). Thus, embodiments of the invention collect and analyze recognition and feedback activities over a period of time and in an ongoing fashion, thereby allowing an employer to accurately gather, analyze and understand the employee's total impact and influence on the company over an entire period, eliminating any discrepancies or inconsistencies.

Embodiments of the invention are generally described in the context of “participants” or “users”. System participants may be or include employees, managers, members of an organization, organizational affiliates, external participants, etc. Accordingly, the scope of participants should not be unduly limited.

An embodiment of the invention includes an interactive performance monitoring and enhancement system for system participants. The system includes at least one non-transitory electronic storage medium storing data and instructions and at least one computer processor executing the stored instructions and utilizing stored data. The computer processor operates as a web rendering engine rendering a unique profile page for the system participants. Each unique profile page facilitates interconnectedness between the participants in the organization. The unique profile page provides a feedback option for entry of feedback to the system participants and a recognition option for recognizing the system participants. Each unique profile page provides a unique history of feedback and recognition for each system participant. The system additionally may include a feedback engine for receiving textual feedback from the system participants directed to other participants through corresponding unique profile pages The feedback engine further performs text analysis on the feedback, the text analysis determining a degree of positivity of the feedback. The feedback engine additionally provides guidance based on the determined degree of positivity. Embodiments of the invention may further include a recognition engine for receiving input of recognition for an achievement of a target participant. The recognition is received from another member of the organization through a corresponding unique profile page. The recognition engine delivers and displays the recognition to the target participant and to other participants connected with the target participants, wherein the web rendering engine provides a unique timeline of feedback and recognitions on each unique profile page enabling rapid visualization of performance over time.

In a further embodiment, an interactive performance monitoring and enhancement method is provided for system participants. The method comprises storing data and instructions in at least one non-transitory electronic storage medium and executing the stored instructions and utilizing the stored data to perform steps. The steps include rendering a unique profile page for each organizational participant, each unique profile page facilitating interconnectedness between the system participants and providing a feedback option for entry of feedback to the system participants. The unique profile page further provides a recognition option for recognizing the system participants and a unique history of feedback and recognition for each system participant. The method additionally includes receiving textual feedback from the system participants through corresponding unique profile pages, the textual feedback directed at a target participant and performing text analysis on the feedback, the text analysis determining a degree of positivity of the feedback. The method further includes providing guidance based on the determined degree of positivity, and delivering the feedback to the target participant. The method additionally includes receiving input of a recognition of an achievement of the target participant and delivering and displaying the recognition to the target participant through the corresponding unique profile page, and providing by the web rendering engine a unique timeline of feedback and recognitions on each unique profile page enabling rapid visualization of performance over time.

An additional embodiment of the invention is directed to a performance monitoring and enhancement system for facilitating feedback exchange between system participants. The system includes at least one non-transitory electronic storage medium storing data and instructions and at least one computer processor executing the stored instructions and utilizing stored data. The computer processor operates as a web rendering engine rendering a unique profile page for the system participants, each unique profile page facilitating interconnectedness between the participants and providing a feedback option for entry of feedback to the system participants. The computer processor further operates as a feedback engine for receiving textual feedback from the system participants entered through corresponding unique profile pages provided by the web rendering engine, the textual feedback directed to a target participant. The feedback engine includes a text analysis module for operating on the entered text along a sentiment spectrum to determine a degree of positivity of the feedback and to evaluate the entered text against stored company values. The feedback engine additionally includes a recommendation module for providing guidance in response to the entered text based on the determined degree of positivity and compliance with the stored company values and a notification module for electronically notifying the target participant of the received feedback.

An additional embodiment of the invention includes a performance monitoring and enhancement method for facilitating feedback exchange between system participants. The method includes storing data and instructions in at least one non-transitory electronic storage medium and executing the stored instructions using at least one computer processor using the stored data perform multiple steps. One step includes rendering a unique profile page for the system participants, each unique profile page accessible over a network and facilitating interconnectedness between the system participants and providing a feedback option for entry of feedback to the system participants. An additional step includes receiving textual feedback from the system participants entered through corresponding unique profile pages provided by the web rendering engine, the textual feedback directed at a target participant. Further steps include operating on the entered text using a text analysis module to evaluate the entered text along a sentiment spectrum to assess a degree of positivity and to evaluate the entered text against stored company values and providing guidance based on the text analysis on the feedback based on the determined degree of positivity and compliance with stored company values. A further step includes electronically notifying the target participant of received feedback.

### BRIEF DESCRIPTION OF DRAWINGS

In order to facilitate a fuller understanding of the invention, reference is now made to the accompanying figures. These figures should not be construed as limiting the invention, but are intended to be exemplary only.

FIG. 1 depicts an operating environment for an interactive performance monitoring and enhancement system in accordance with an embodiment of the invention;

FIG. 2 depicts an interactive performance monitoring and enhancement system in accordance with an embodiment of the invention;

FIG. 3 depicts an embodiment of a feedback engine of the interactive performance monitoring an enhancement system of the invention;

FIG. 4 depicts a check-in engine of the interactive performance monitoring and enhancement system;

FIG. 5 depicts a recognition engine of the interactive performance monitoring and enhancement system in accordance with an embodiment of the invention;

FIG. 6 is a flow chart illustrating a method for generating feedback in accordance with an embodiment of the invention;

FIG. 7 is a flow chart illustrating a check-in method in accordance with an embodiment of the invention;

FIG. 8 depicts a flowchart of a method for providing recognition in accordance with an embodiment of the invention;

FIG. 9 depicts a user interface illustrating a profile page in accordance with an embodiment of the invention;

FIG. 10 illustrates a feedback interface including analysis in accordance with an embodiment of the invention;

FIGS. 11A-11D illustrate a user interface for textual analysis of feedback in accordance with an embodiment of the invention;

FIGS. 12-16 illustrate a series of user interfaces that may be presented to a user to assist the user in creating a recognition moment in accordance with embodiments of the invention;

FIG. 17 illustrates a user interface for transmitting recognition in accordance with an embodiment of the invention;

FIGS. 18 and 19 depict recognition network graphs in accordance with embodiments of the invention;

FIG. 20 illustrates a user interface containing an award and recognition feed in accordance with an embodiment of the invention;

FIGS. 21A and 21B illustrate a user interface containing user watch list and an employee recognition digest in accordance with embodiments of the invention;

FIG. 22 depicts a user interface for delivering recognition announcements in accordance with an embodiment of the invention;

FIGS. 23A, 23B and 23C depict additional recognition and awards graphs in accordance with embodiments of the invention;

FIG. 24 depicts a user interface for providing users with data of employee recognition and feedback metrics using infographics and other tools in accordance with an embodiment of the invention;

FIG. 25 provides an exemplary schematic and equation for ranking an award newsfeed in accordance with an embodiment of the invention;

FIG. 26 provides an exemplary schematic and equation for calculating a connection weight in accordance with an embodiment of the invention;

FIG. 27 is an exemplary recognition and feedback interface in accordance with an embodiment of the invention;

FIG. 28 is an exemplary schematic for recognition of a life event in accordance with an embodiment of the invention;

FIG. 29 illustrates a check-in interface in accordance with an embodiment of the invention;

FIG. 30 illustrates a check-in record and a performance timeline in accordance with an embodiment of the invention;

FIG. 31 illustrates a cross company recognition in accordance with an embodiment of the invention;

FIGS. 32A-C illustrate recognition analysis in accordance with an embodiment of the invention;

FIGS. 33A-33D illustrate group recognition in accordance with an embodiment of the invention;

FIG. 34 illustrates a user interface showing performance metrics in accordance with an embodiment of the invention;

FIGS. 35A and 35B illustrate a manager interface showing performance metrics in accordance with an embodiment of the invention;

FIGS. 36A, 36B, and 36C graphically illustrate organizational data analytics in accordance with an embodiment of the invention; and

FIGS. 37A-37D illustrate additional data analytics in accordance with an embodiment of the invention.

### DETAILED DESCRIPTION OF THE INVENTION

The following describes in detail various embodiments of the invention. One of ordinary skill in the art would understand that standard programming and engineering techniques may be used to produce such embodiments including software, firmware, hardware, or any combination thereof to implement the disclosed subject matter. The attached figures depict exemplary embodiments and are meant to be understood in view of the details disclosed herein.

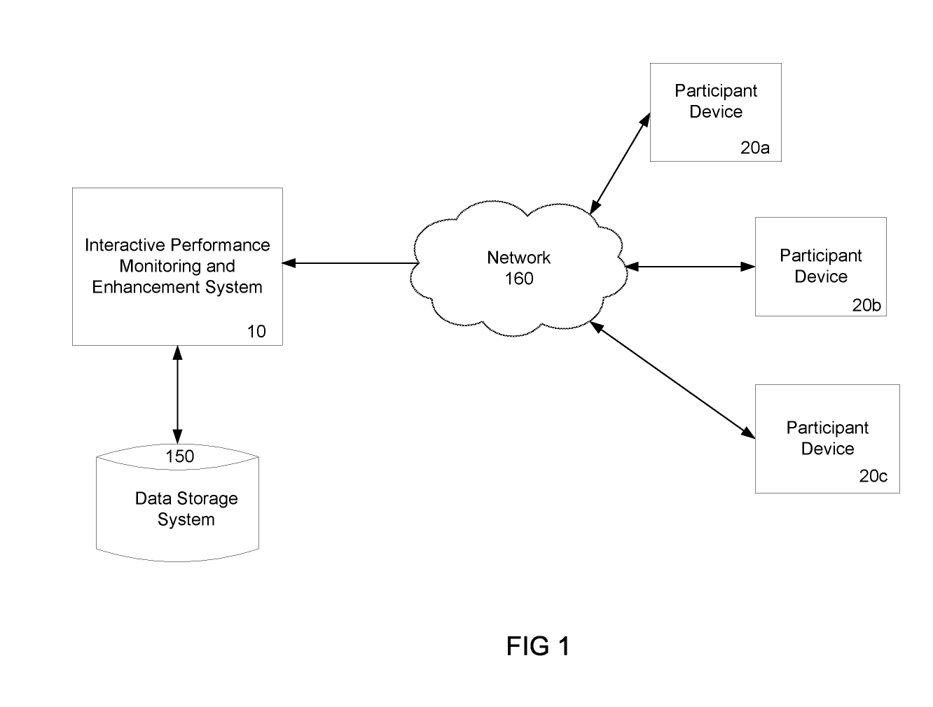

FIG. 1 depicts an operating environment for an interactive performance monitoring and enhancement system 10 in accordance with an embodiment of the invention. The interactive performance monitoring and enhancement system 10 is connected over a network 160 with multiple participant devices 20a-20c and a data storage system 150. The interactive system 10 may be a web or application server that includes a processor and memory (e.g., the storage system 150). The interactive system 10 may also be embodied in software executed by a processor on a server. Alternatively, the interactive system 10 may execute on a machine local to a user of the system 10 (e.g., on the participant device 20A-C). For example, the interactive system 10 may be or include a software application executing within a web browser (e.g., a JAVA® Applet) at the client devices 20A-20C.

The participant devices 20A-20C may be referenced herein as to “computer(s),” “machine(s)” and/or “device(s),” and may include, without limitation, a computer such as a general purpose computer that includes a processing unit, a system memory, and a system bus that couples various system components including the system memory and the processing unit. The general purpose computer may employ the processing unit to execute computer-executable program modules stored on one or more computer readable media forming the system memory. The program modules may include instructions, routines, programs, objects, components, data structures, etc., that perform particular tasks or implement particular abstract data types. The “computer(s),” “machine(s)” and/or “device(s),” may assume different configurations and still be consistent with the invention, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices. Thus, for example, a participant device may be a personal computer, a mobile device (e.g., mobile phone, smart phone, tablet), or even a car or appliance including a processing unit and system memory.

As described above, while depicted as a computer in FIG. 1, participant devices 20A-20C may be any device with at least a processor, including a laptop, tablet, mobile phone, and/or other mobile devices or computer systems. Thus, in one embodiment, a user may access the interactive system 10 with a mobile smartphone by utilizing a web browser, an application, or other access methods. Networks consistent with exemplary embodiments of the invention, including network 160, may be a wired or wireless local area network (LAN) or wide area network (WAN), a wireless personal area network (PAN), and other types of networks. When used in a LAN networking environment, computers (such as a computer executing the components or engines of the interactive performance monitoring and enhancement system 10, or the client device 20A-C) may be connected to the LAN through a network interface or adapter. When used in a WAN networking environment, computers typically include a modem or other communication mechanism. Modems may be internal or external, and may be connected to the system bus via a user-input interface, or other appropriate mechanism. Computers, such as the participant devices 20A-20C and a server running the engines and modules of the interactive system 10, may be connected over the Internet, an Intranet, an Extranet, an Ethernet, or any other network that facilitates communications. In addition, any number of transport protocols may be utilized, including, without limitation, the User Datagram Protocol (UDP), Transmission Control Protocol (TCP), Venturi Transport Protocol (VTP), Datagram Congestion Control Protocol (DCCP), Fiber Channel Protocol (FCP), Stream Control Transmission Protocol (SCTP), Reliable User Datagram Protocol (RUDP), and Resource ReSerVation Protocol (RSVP). For wireless communications, communications protocols may include Bluetooth, Zigbee, IrDa, or other suitable protocol. Furthermore, components of the systems described herein may communicate through a combination of wired or wireless paths.

In one exemplary embodiment, a system participant may interface with the client device 20A-20C via a user interface. The user may enter commands and information through the user interface, such as through input devices such as a keyboard, a touch-screen, and/or a pointing device—e.g., a mouse, trackball or touch pad. In one embodiment, the user interacts with the engines and modules of the interactive performance monitoring and enhancement system 10 using these and other input devices in conjunction with a graphical user interface (GUI) provided on the client device 20A-20C, or hosted on a server of the interactive system 10, and accessed by a terminal or internet browser local to the client device 20A-C. In one exemplary embodiment, the GUI is a web-portal on an organization's intra-net site.

The data storage system 150 may be or include data storage structure capable of storing large amounts of data. For example, the data storage areas may include HP 3PAR StoreServ® Storage systems. Those of ordinary skill in the art will appreciate that other computer storage systems for storing large amounts of data may be implemented and that data stored in the data storage areas may be managed and communicated with an Object-Relational Database Management System or other type of system.

Data storage system 150 may contain some or all of the data received, utilized, and processed by the engines of the interactive system 10 and may include more than one storage module located at a number of locations. In the preferred embodiment, the data storage system storage system 150 may store recognition and feedback data, employee data, organizational data, and other information and data necessary to perform the operations described herein. For some organizations, the data storage system 150 may store alumni employee data that may include award history, a printable report, and a list or visual representation of connections, i.e., but not limited to, recognition and feedback networks described herein.

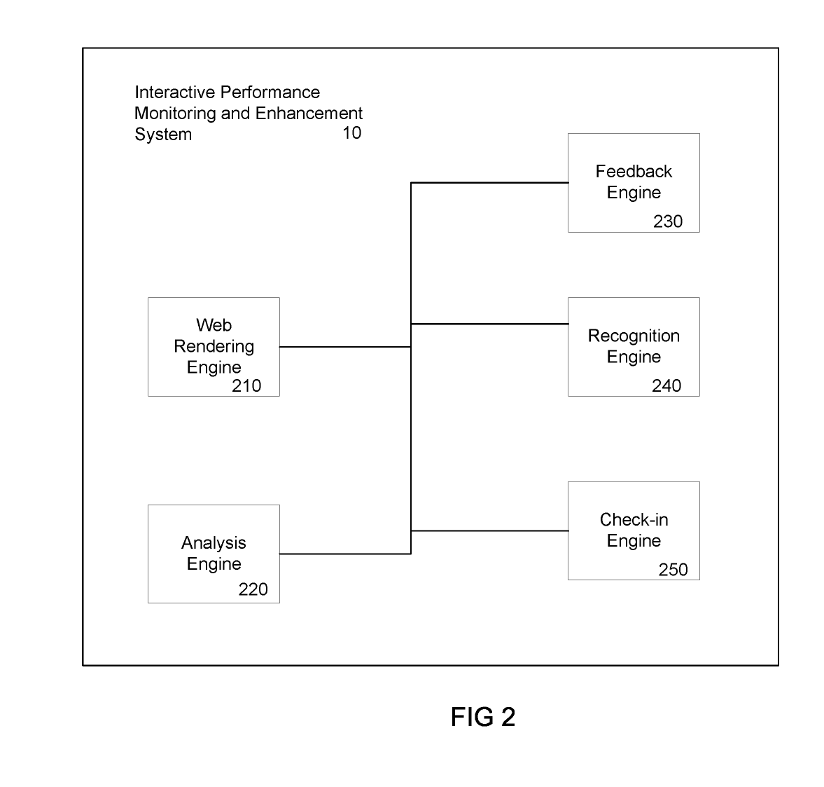

The interactive performance monitoring and enhancement system 10 is shown in greater detail in FIG. 2. As illustrated, the interactive performance monitoring and enhancement system 10 includes a web rendering engine 210, an analysis engine 220, a feedback engine 230, a recognition engine 240, and a check-in engine 250. Specifically, the web rendering engine 210 creates unique profile pages, which may be interfaces such as mobile interfaces, examples of which are depicted herein, for use by organizational participants. Through the unique profile pages created by the web rendering engine 210, participants are able to enter feedback that is processed by the feedback engine 230, recognitions that are processed by the recognition engine 240, and check-ins that are processed by the check-in engine 250. The analysis engine 220 operates on the collected feedback, recognitions, and check-ins to perform various analyses. The analyses may be captured by the web rendering engine 210 for ultimate display on the unique profile pages and in other system locations. For example, the analysis may include providing timelines documenting the combination of recognitions, check-ins, and feedback for each system participant. The analysis may further include connectedness analysis and graphing based on all types of interaction. The engines and their functions are described in greater detail below with respect to the remaining Figures.

Moreover, as used herein, references to “an engine”, “a module,” “modules”, “function”, and/or “algorithm” generally mean, but are not limited to, a software or hardware component that performs certain tasks. The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

Thus, a module may include, by way of example, components, such as software components, object-oriented software components, class libraries, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or be further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (PBX). In any of these cases, implementation may be achieved either by writing applications that are native to the chosen platform, or by interfacing the platform to one or more external application engines.

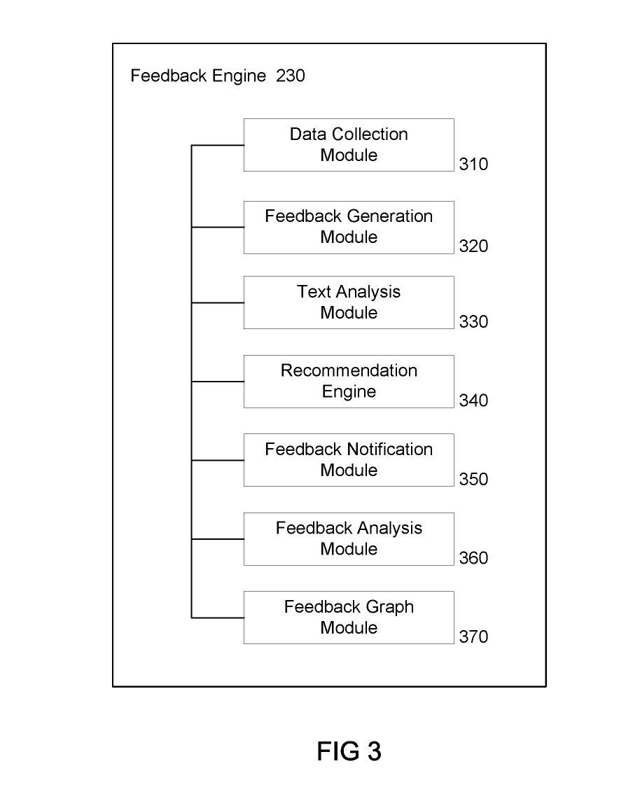

FIG. 3 depicts an embodiment of a feedback engine 230 of the interactive performance monitoring an enhancement system of the invention. The feedback engine 230 may include a data collection module 310, a feedback generation module 320, a text analysis module 330, a recommendation engine 340, a feedback notification module 350, a feedback analysis module 360, and a feedback graph module 370. The feedback engine 230 may be or utilize a web or application server that includes a processor and memory. The feedback engine 230 and its components may also be embodied in software executed by a processor on a server. Alternatively, the feedback engine 230 may execute on a machine local to a user of the performance monitoring and enhancement system 10 (e.g., on the client device 20A-20C). For example, the feedback engine 230 may be a software application executing within a web browser (e.g., a JAVA® Applet) at the client device 20A-20C.

The data collection module 310 collects data stored in the data storage system 150 and entered by participants and collected about participants throughout the system. The data may be collected in real time from various sources including participant profile pages and from the data storage system 150 depicted in FIG. 1. In addition to the recognition data, organizational data may be collected by the data collection module 310, which may include data describing the organization, its teams, and its employees. The organizational data, in one preferred embodiment, will include data describing the organizational structure, including the employment classification of each employee, the members and size of each team or division, the engagement level between divisions or teams; as well as the relationship between teams and between managers and employees, such as which employee reports to which manager and which employees work together, for example. Indeed, the organizational relationship data need not be limited to information that may be contained in an organizational chart, but may include various other organizational information that may be relevant in determining the connections between employees of the organization, such as the office or cubicle location, interests, projects or clients, length of employment, educational, social background, functional groups (e.g., unofficial teams), employment history (e.g., previous connections); performance rating, grade; social network connections; the recognition participation by employees and/or managers; and the reach and frequency of recognitions within (and outside of) teams and divisions. Various other organizational data may be collected in other embodiments of the invention.

The feedback generation module 320 may generate feedback based on participant input. In embodiments of the invention, participants can give, receive and request feedback from others. This capability allows a crowd-sourced approach to performance and development that includes not only recognition or feedback-worthy moments, but sometimes-appropriate more neutral suggestions or comments. Feedback may be requested by an employee from his/her colleagues and/or managers generally, or on a certain topic, initiative, priority, project, etc. As such, crowd-sourced feedback allows an employee to develop skills by receiving well-rounded feedback. In embodiments of the invention, feedback may be given over all known media connected over a network, i.e., computers, tablets, phones, etc. Feedback may be initiated using a feedback affordance on a home page, which opens a feedback slide out allowing for searches of participants by the recipient or the submitter. In embodiments of the invention, a participant may initiate feedback from the user profile page or interface, which may launch a feedback slide out with the user selected and the feedback entry. Participants are able to enter feedback through their unique profile pages as generated by the web rendering engine. Thus, in embodiments of the invention, a slide out panel may be provided on the unique profile page through which participants can be selected, allowing the profile page owner to select a target participant and begin entering feedback to the target participant. In embodiments of the invention, the unique profile page displays a list of potential target participants based on information gathered by the data collection module 310. For example, the potential list of target participants may be a list of all team members or a list compiled based on organizational connectedness.

The text analysis module 330 may operate based on detection of text input by the feedback generation module 320. The text analysis module 330 utilizes text analysis algorithms to analyze the actual content of feedback. The text analysis module 330 may derive information through information retrieval, lexical analysis, pattern recognition, tagging, information extraction, data mining techniques, visualization, and predictive analytics. The text analysis module 330 may utilize natural language processing in conjunction with the procedures identified above to achieve sentiment analysis and content analysis. For example, on a feedback interface, the text analysis module 330 may analyze the provided feedback text for positivity, emotion, and dismissive tone. The text analysis module 330 may perform a sentiment analysis along a spectrum of positivity to determine whether the feedback is negative, neutral, or positive. Further, the text analysis module 330 may perform a value-based analysis to determine if input text complies with company values stored in the data storage system 150. The data collection module 310 may retrieve company values from the data storage system 150 and the text analysis module 330 may perform a comparison of the input text with stored company values and/or goals.

The recommendation engine 340 evaluates the analysis of the text analysis module 330 to provide guidance and recommendations to the participant entering the text. For example, the recommendation engine 340 may receive the positivity analysis described above and suggest to the entering participant that the text is too negative and should be more constructive and less critical. Alternatively, the recommendation engine 340 may determine that the text is extremely positive and suggest that the feedback text be converted from feedback to a recognition moment as will be further discussed below. As a further option, the recommendation engine 340 may highlight company values in the input text or generate text suggesting incorporation of specific company values in the feedback.

The feedback notification module 350 may serve to notify receiving participants and other connected participants of received feedback. For example, after feedback has been completed by a system participant, the feedback generation module 320 can generate the feedback and the feedback notification module 350 can notify connected participants about the generated feedback. Participants may optionally be notified via email, text message, or other messaging software, of the presence of feedback, and optionally the identity of the sender of feedback. Skilled artisans would recognize the various configurable entries that may exist in the notification. Electronic notifications may be sent through the unique profile pages, through push notifications, such as pop-ups or text messages, or by email, for example. In embodiments of the invention, the electronic notifications are sent to the target participants and may also be sent to interested team members or connected participants. The feedback notification module 350 may generate notifications that include a selectable URL, which, when selected, will take the participants to the unique profile page within the interactive system to allow them to view the feedback even when the participant is not logged in to the interactive system 10.

The feedback analysis module 360 may serve to analyze generated feedback, both for individual participants and at a team level. The feedback analysis module 360 may further analyze the feedback at an organizational level. The analysis may serve to provide information to the feedback graph module 370. The feedback graph module 370 may serve to generate graphs illustrating feedback trends. The graphs can illustrate where feedback is given and received and which portions of an organization are not generating or receiving sufficient feedback. The feedback analysis and graphing can be stored in the data storage system 150 and can further be utilized by the analysis engine 220 of FIG. 2 in order to combine feedback analysis with other analyses such as recognition analyses and check-in analyses, which will be further described below.

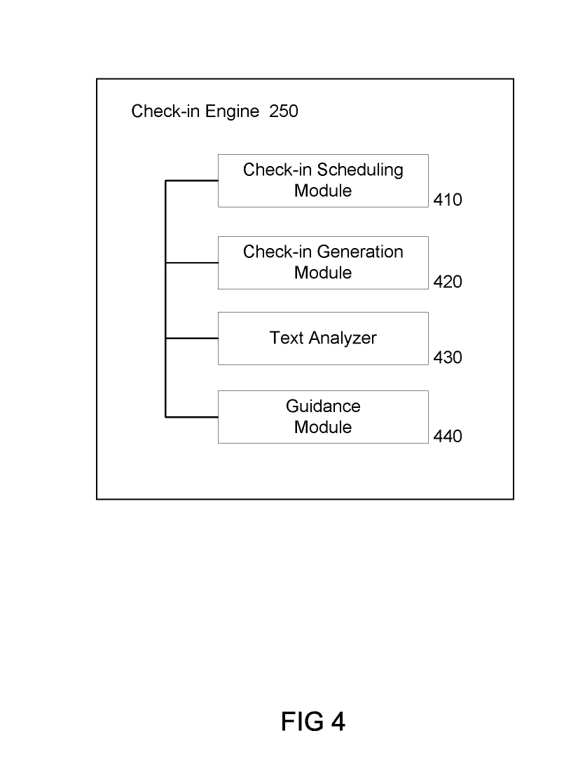

FIG. 4 depicts a check-in engine 250 of the interactive performance monitoring and enhancement system. The check-in engine 250 may include a check-in scheduling module 410, a check-in generation module 420, a text analyzer 430, and a guidance module 440. The check-in engine 250 may operate through the unique profile pages to allow participants the opportunity for informal “check-ins” that are tracked through the interactive performance enhancement and monitoring system. Although not shown, the check-in engine 250 may also include an analysis module for analyzing check-in trends. Alternatively, the check-in engine 250 may leverage another existing analysis module within the system.

The check-in engine 250 may be accessed on all known media connected over a network. For example, the system offers manager-employee check-ins on mobile and web site, allowing frequent, informal conversations to be lightly documented and tracked. In embodiments of the invention, a “check-in” allows for receiving feedback. For example, an employee seeking feedback on a project may “check-in” with his/her supervisor by entering an optional title and a short piece of text describing the check in. The check-in engine 250 rounds up new feedback and recognition as well as previous check-ins, feedback and recognition for possible discussion. Managers may add priorities or set reminders for check-ins. A priority also can be tied to a recognition or feedback moment. For example, an employee can request feedback on a specific priority and a manager may view all of the recognitions and feedback that a user may have received or given based upon one or more priorities.

Check-ins can incorporate priorities for employees, milestones, or other goals at which point a supervising participant can optionally provide feedback. In embodiments of the invention, a check-in may be converted into a feedback or recognition moment, optionally affiliated with awards as described herein. For example, a manager providing favorable feedback during the check-in may be prompted to convert the check-in into a feedback that can be published on the interactive recognition/feedback wall, as described herein. A manager providing favorable feedback during the check-in may also be prompted by the guidance module 440 to convert the check-in into a recognition or feedback moment that may also be published. The recognition or feedback may be affiliated with a potential award, and the sentiment analysis will also be invoked.

The check-in scheduling module 410 may operate to schedule check-ins between participants. The check-ins may be scheduled between participants working on a project together or between a manager and team members. The scheduling module 410 may allow participants to generate a schedule for check-ins and provide reminders to the participants upon the occurrence of a scheduled check-in.

The check-in generation module 420 may generate the check-in text similarly as set forth above with respect to the feedback text. A text analyzer 430 may also operate to evaluate entered text along the positivity spectrum and for compliance with company values. A guidance module 440 may also be provided to highlight company values in the entered text and to provide guidance to the entering participant. In embodiments of the invention, the guidance module 440 may operate to convert a check-in to feedback or recognition when the check-in analysis module algorithm finds that the positivity and company values displayed would be appropriate for conversion.

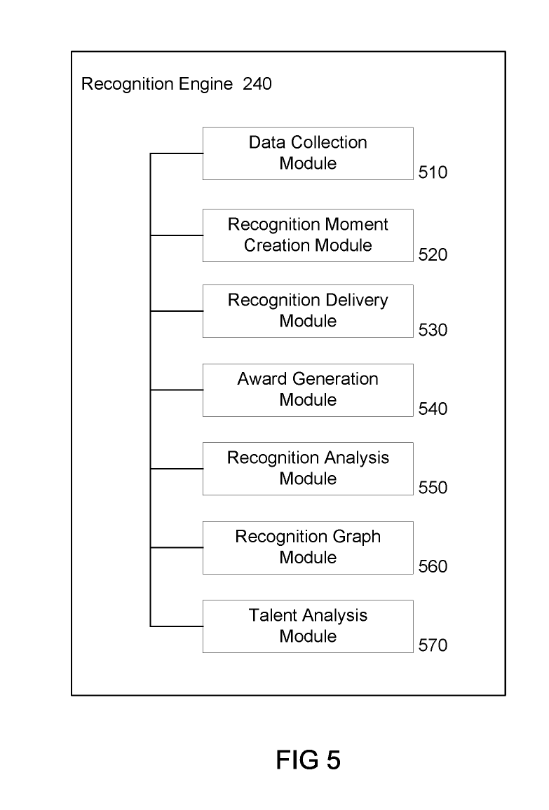

FIG. 5 depicts a recognition engine 240 of the interactive performance monitoring and enhancement system in accordance with an embodiment of the invention. The recognition engine 240 may include a data collection module 510, a moment creation module 520, a recognition delivery module 530, an award generation module 540, a recognition analysis module 550, a graph module 560, and a talent analysis module 570. A greater or smaller number of modules may be included.

The data collection module 510 may collect recognition data and organizational data, which may include data describing the organization, its teams, and its participants. The organizational data, in one preferred embodiment, will include data describing the organization's structure and other organizational data described above with respect to FIG. 3.

The recognition moment creation module 520 creates a recognition moment in response to input from a unique user profile page or in response to input made in any other manner to the interactive system 10. The recognition moment may be recognition for performance-related metrics of a target participant or may recognize a life event and in some embodiments may include an award for the target participant.

After optionally reviewing and approving the recognition moment, the recognition delivery module 530 may transmit the recognition moment to the recipient or target participant. In one exemplary embodiment, the interactive system may transmit the recognition moment via e-mail. In other exemplary embodiments, the notice may be transmitted to the recipient via a portal site, the recognition feed (below), over twitter feed, push notification, rss feed, text message, mobile application other similar transmission methods, and combinations thereof. In embodiments of the invention, the mobile application is functional across all operating systems, including, by way of non-limiting example, Apple operating systems, Android operating systems, and HTML 5. The mobile application may transmit information pertaining to, by way of non-limiting example, awards, nominations, approvals for allowing a post to be public on an employee's feed, redeeming awards, videos, eRewards, and service timelines. In embodiments of the invention, the mobile application may be configured to be in any language. In certain embodiments, recognition moments may be provided to a proxy of the recipient, such as the recipient's manager or a proxy that the recipient has designated, such as the recipient's family member, coworker or others. The message that is provided publicly may be restricted according to the preferences of the user or recipient or according to administrative settings; as such messages may contain confidential corporate information. In some cases, only the award title and reason may appear publically. In yet another embodiment, the recognition delivery module 530 may cause a card or letter to be printed and delivered to the recipient.

An award generation module 540 may operate to associate the recognition with an award. Thus, transmitting the recognition moment may also include funding an account associated with the recipient (e.g., with points or money). Thus, the recognition delivery module 530 may connect with one or more financial service systems via the network to cause the transfer or wiring of funds, the purchase of products, gift cards, merchandise and/or tickets, order rewards related services, crowdsourced funds, micropayments, virtual currency, and the performance of other actions related to the selected awards. The recognition delivery module 530 may receive, in response, a confirmation of the ordering of the award and may further provide the recipient and/or an administrator with the information as needed. By way of non-limiting example, products may be standard, enhanced, or distinguished presentation packs. Furthermore, products may be commemorative items such as, by way of non-limiting example, jewelry, plaques, trophies, and crystal.

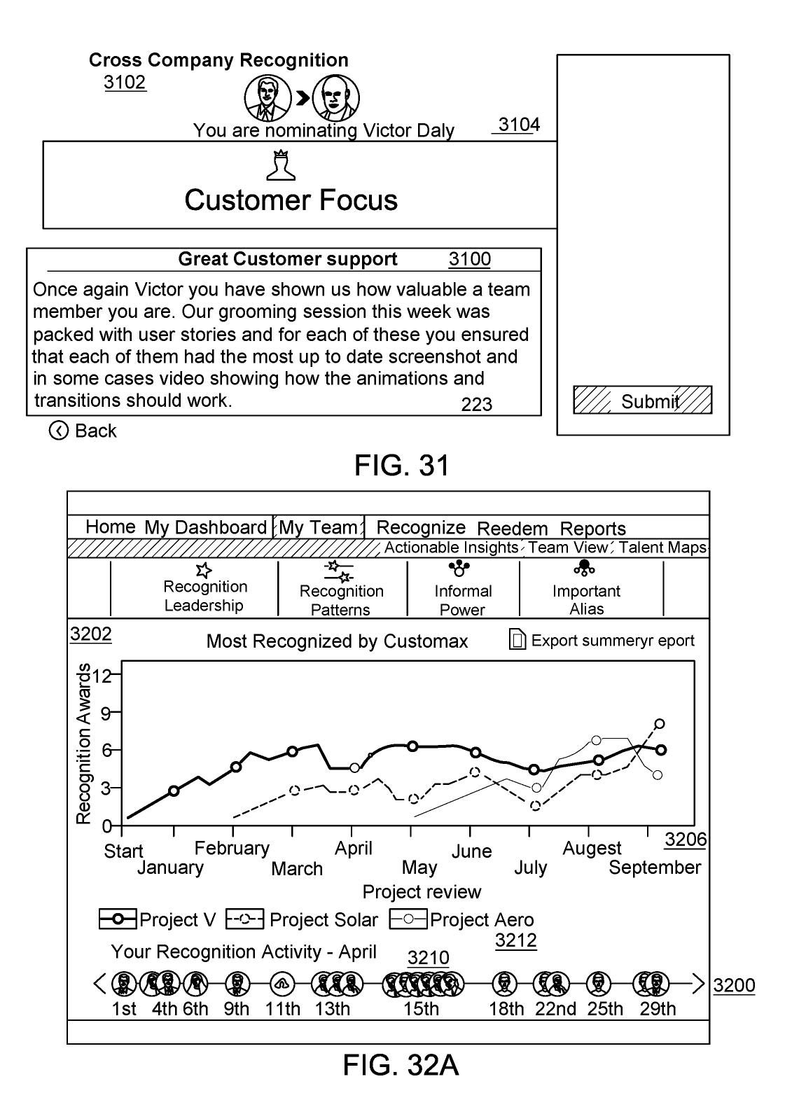

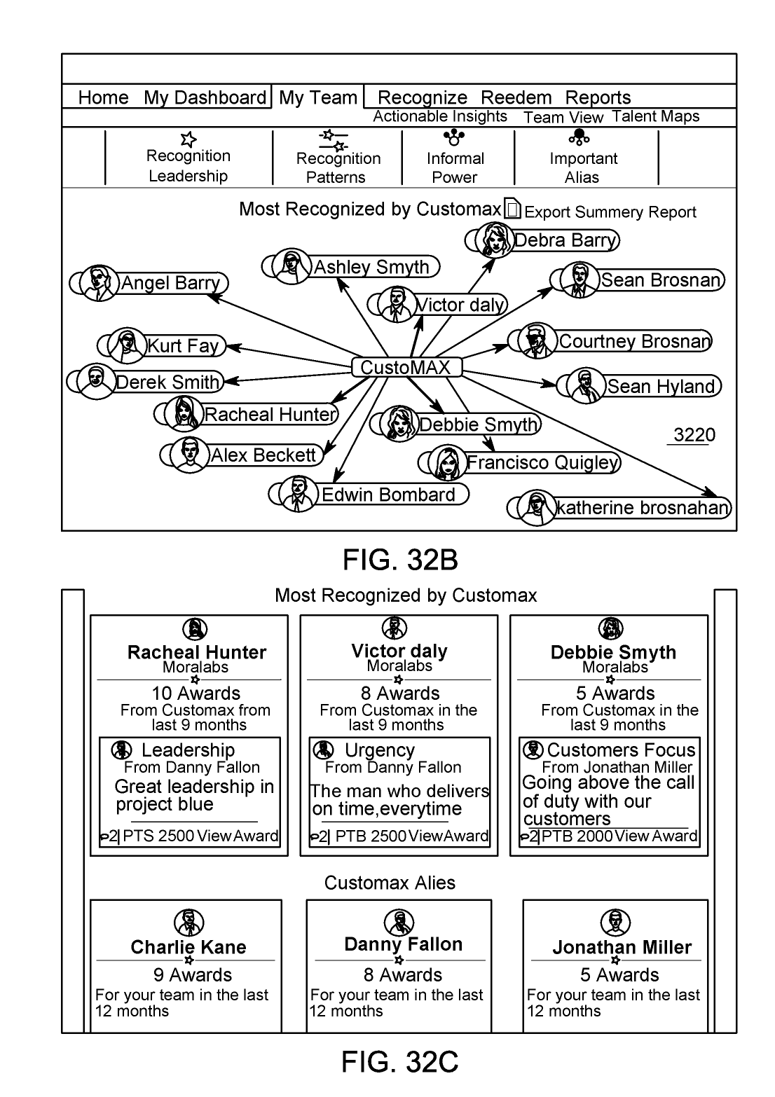

The recognition analysis module 550 may gather recognition data and analyze the recognition data to operate in conjunction with the recognition graphing module 560 and the web rendering engine to present graphs showing historical recognitions and recognition trends. In embodiments of the invention, recognition (and associated information, such as, for example, the frequency of recognition, the recognizer, the category of recognition, etc.) can be displayed across the company as illustrated, for example in FIGS. 31, 32A-C, and 37A-37D. In embodiments of the invention, the recognition is graphically displayed based on based on work circles.

A work circle graph may display for example, employees and alumni based on a list of connections. In embodiments of the invention, the list of connections may include details on how an alumni is connected, the contextual details of an alumni (i.e., “former peer,” “former manager,” etc.), and utilize work circles logic to determine which colleagues may be included. In an embodiment of the invention, a likely set of work circles may include nominees the alumni employee has sent awards to, nominators the alumni employee has received awards from, mutual recipients of group awards including the alumni employee, anyone who has congratulated the alumni employee, people who shared a direct manager with the alumni employee, former direct reports, former managers, individuals who have placed the alumni employee on their watch list, and individuals chosen by the alumni employee on their watch list.

The talent analysis module 570 may enable managers or administrators to assess and manage their direct and indirect reports. In a preferred embodiment, the talent analysis module 570 gives all managers and executives valuable recognition and feedback data to go beyond the performance review of employee performance, including data related to employee efforts that align or support corporate values and recognition data. Embodiments of the talent analysis module analyze and generate results based on recognition data. Other embodiments of the invention may comprise talent analysis modules that analyze and generate results based a combination of recognition, feedback, and check-in data. Embodiments of the talent analysis module 570 allow managers and administrators to define employees that are part of their team and view data of each direct or indirect report. In one embodiment, the talent analysis module 570, in conjunction with the web rendering engine, may automatically populate the team members for a manager by connecting to one or more computer systems of the company.

The talent analysis module 570 may automatically gather, analyze, and generate team member performance and recognition data and operate in conjunction with the web rendering engine to generate a plurality of user-interfaces to present the data to a manager in an easy to understand manner. For example, the talent analysis module 570 may generate the user interfaces by collecting and analyzing the data stored at the data storage system, which may include the recognition data collected previously and/or in real-time by the data collection module 510, the recognitions created by the recognition creation module 520, the comments and messages received related to recognition, and other information received in the interactive system, which may include information sourced internally and externally to an organization (e.g., social networks, HR databases, and others).

The participant data depicted may be illustrated in an easy to read manner, and may be in the form of infographics, historical data analysis graphs and other types of multimedia for easy understanding. A user may manipulate the data that is displayed by interacting with the user interface. The user may, for example, filter the data shown based on participant, company or recognition attributes. Participants may further cause one or more data analysis functions of the talent analysis module 570 to be executed, which may perform more in-depth data analysis using predictive algorithms. In one embodiment, the talent analysis module 570 dynamically generates a video of infographics customized for a team member, presenting all information selected by the manager for review. From such user interfaces generated by the web rendering engine and the talent analysis module 570, a user may receive modification and improvement suggestions from the talent analysis module 570.

Furthermore, the talent analysis module 570 may utilize one or more statistical analysis algorithms and predictive analytics techniques, such as neural network models and multiple linear regression, in order to generate reports describing important participant metrics. Such generated data may describe: the likelihood of an employee leaving the company; the performance potential of a company in the short and long run; the engagement of the employee with respect to his or her position, responsibility, team and the company; the actual or potential scope of influence within or outside of his or her team; employee connection score; succession candidacy; readiness for promotion; most inspirational employees; top performers; top culture promoter; top influencers, and other useful information.

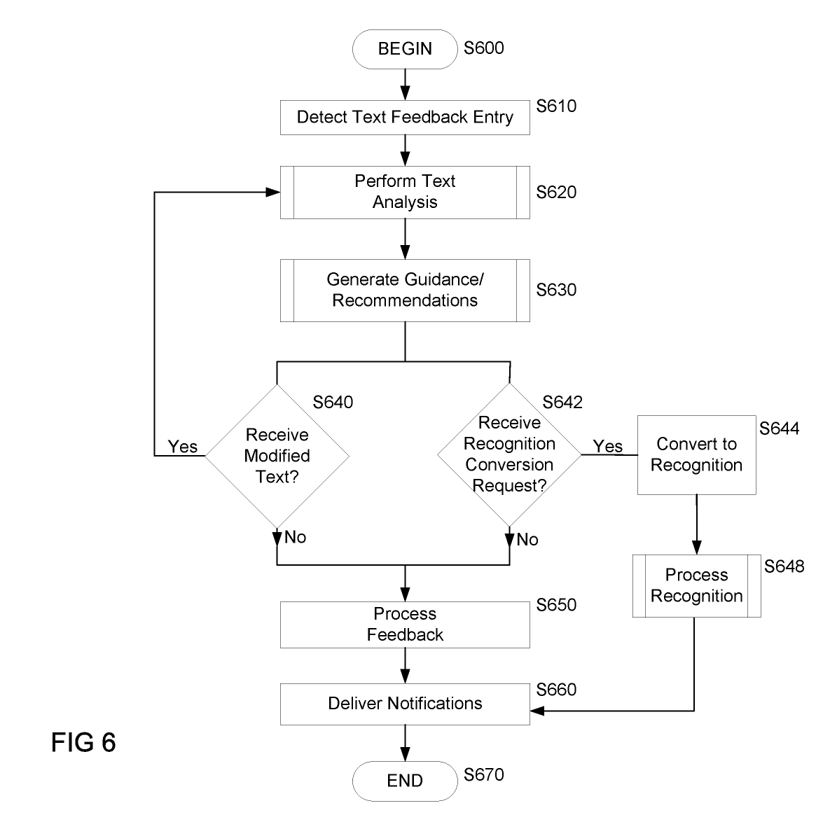

FIG. 6 is a flow chart illustrating a method for analyzing feedback in accordance with an embodiment of the invention. The method begins in S600 when feedback is entered by a system participant through a participant device, such as the devices 20A-20C described in connection with FIG. 1 above. In embodiments of the invention, the feedback is entered through a unique profile page corresponding to the participant entering the feedback. The feedback may be directed to another system participant who is the intended target participant. In S610, the interactive system detects the entered feedback.

Upon detection of the feedback during entry, the system performs text analysis in S620 using the text analysis module described above. The text analysis process of S620 may be accomplished through various methods as described above with respect to FIG. 3. One goal of the text analysis may include determining a degree of positivity of the entered text on a spectrum from negative, to neutral, to positive. Another goal of the text analysis may include comparing the entered text to stored company values to ensure that the entered text complies with and is in agreement with the stored values. The text analysis is preferably performed in real time upon text entry detection so that the system can utilize the recommendation module of the feedback engine to prepare recommendations prior to participant entry of the text. The interactive system may display the text analysis to the entering participant or alternatively, may keep the analysis hidden, for example, when the analysis reveals a neutral sentiment.

After performing the text analysis process in S620, the system is capable of providing guidance and recommendations in S630. In some cases, the guidance may relate to positivity and the system may recommend that the participant alter the input language in order to provide a more positive sentiment so that the feedback will be constructive rather than overly critical. In other cases, when the feedback ranks particularly high on the sentiment spectrum and is thus highly positive, the system may recommend conversion of the feedback to a recognition in order to recognize the target participant for her contribution. In other instances, the recommendation module may detect a conflict or lack of correspondence between the input language and stored company values. In such an instance, the recommendation module may cause language to be displayed that reflects company values as a suggestion to the participant submitting the feedback.

Thus, after generating recommendations, the system may determine if modified text has been received. If modified text has been received in S640, the system will return to S620 to analyze the newly input text and provide any additional guidance or recommendations at S630. This process continues until no more modifications are provided by the entering participant. Alternatively, if no modified text has been received and the user has submitted the text, the system processes the feedback in S650. Processing the feedback may include determining destinations and posting locations for the feedback. For example, in embodiments of the invention, the feedback may be visible to managers and/or other team members. Processing may also include recording and storing the feedback and recording metadata pertaining to the feedback, such as originator, target recipient, date, etc. for later use. A notification of the received feedback is delivered to the target participant in S660. The notification may be delivered electronically, for example by pop-up notification or text message. In embodiments of the invention, the target participant need not be logged into the interactive system in order to receive the notification or the feedback. For example, the interactive system may provide the target participant with a pop up notification with a URL on the electronic participant device. By selecting the URL, the receiving participants, who may include the target participant and other interconnected participants, may be directed to the text of the feedback in the interactive system. In some instances, the feedback may be provided privately such that only the target participant receives the feedback. In other participants, multiple individuals interconnected with the target participant may receive the feedback.

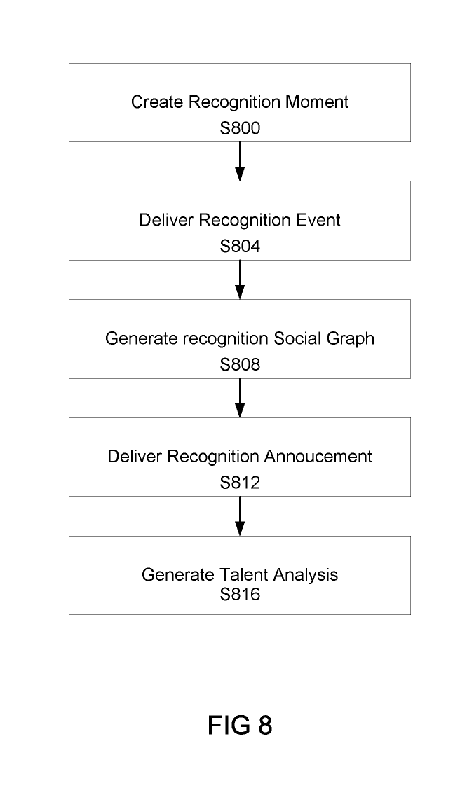

In some instances, when the recommendation module recommends at S630 that the participant convert the feedback to a recognition due to the high positivity content of the feedback, the participant may respond by submitting the request to convert. The interactive system detects the request at S642 and converts the feedback to recognition in S644 by passing the input feedback to the recognition engine and processing the recognition in S648. Recognition processing is further described below with reference to FIG. 8. The process ends in S670.

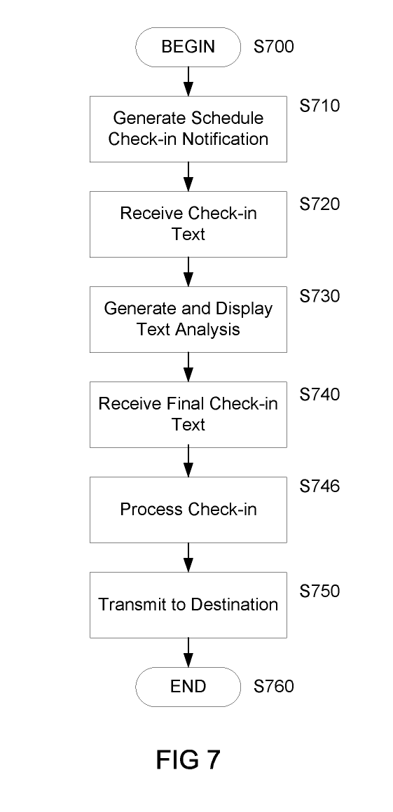

FIG. 7 is a flow chart illustrating a check-in method in accordance with an embodiment of the invention. The check-in method begins in S700 and optionally, the interactive system generates a scheduled check-in notification at S710. In embodiments of the invention, check-ins may be scheduled to ensure regular communication between participants such as employees and supervisors. However, in other embodiments, check-ins need not be scheduled and can be submitted at any time by system participants. The interactive system receives the check-in in SS720.

In S730, a textual analysis of the check-in may be conducted as discussed above in order to ensure that entered language is in accord with organizational values and goals and further to ensure that check-ins include constructive rather than critical language. Thus, the text analysis may evaluate language along the sentiment spectrum from negative to positive. The interactive system, through the web rendering engine, may further highlight language that supports organizational principles and values. Guidance may optionally be provided by the interactive system in an effort to refine check-in language. After generating and displaying text analysis, the interactive system may receive final check-in text in S740 and process the check-in in S746. Processing may simply include recording and storing the check-in and recording metadata pertaining to the check-in, such as originator, target recipient, date, etc. for later use. In S750 the interactive system transmits the check-in to its destination. Optionally, a check-in notification may be provided in the manner described above with respect to feedback notifications. For example, a target participant may receive a notification that he has received a check-in through text message, pop-up notification, email, etc. The actual text of the check-in or destination for the check-in may be, for example, a unique profile page corresponding to the target recipient of the check-in.

FIG. 8 depicts a flowchart of a method for providing recognition in accordance with an embodiment of the invention. In S800, the interactive system creates a recognition moment. As set forth above, the recognition moment is created in response to the input of recognition from a participant. The data collection module of the recognition engine collects the details associated with recognition and the creation module may create the moment. At S804, the recognition delivery module may deliver the moment to the recipient. As set forth above with respect to feedback, the interactive system may also provide recipients with a notification that the recognition has been entered into the interactive system. At S808, the graph module in conjunction with the analysis module may generate (or update) a recognition and feedback network graph for an organization based on organizational data, the details of the moment, and the details of other previous moments. At S812, based on the recognition network graph, the recognition delivery module may deliver announcements indicative of the moment to all or a sub-set of the nodes in the recognition network graph.

At S816, the talent analysis module may utilize the web rendering engine to provide users with one or more user interfaces that depict the recognition in a number of easy to understand and configurable manners. A talent analysis user interface may provide managers or others with the ability to not only define those who are members of the manager's team or group, but may also view the performance, influence, performance alignment, and other recognition and feedback data of each employee, each team and the organization as a whole. The talent analysis module may utilize at least portions of the generated recognition network graph in providing users with data related to recognition details, in view of the organizational data.

Thus, as set forth above, embodiments of the invention can collect, analyze, and deliver recognition, feedback, and check-ins. Embodiments of the invention may include separate engines directed to receiving, processing, delivering, and analyzing recognition, feedback, and check-ins. As set forth with respect to FIG. 2, the interactive system may provide an analysis engine 220 for collectively analyzing these activities throughout the system and a web rendering engine 210 may provide all relevant information and analyses through unique profile pages, which may be or include mobile interfaces, throughout the system.

Each of the engines may comprise one or more of the modules discussed herein. In such embodiments, the engines may utilize data and analysis collected by other engines within the system, e.g., the data collected by the recognition system may be retrieved and analyzed by the feedback system in performing analytical data analysis; and the data collected by the feedback system may be retrieved and analyzed by the recognition system in performing analytical data analysis. Further, any of the engines and processes described above may be modified to omit steps or components or include additional steps or components. The engines may utilize components from other engines. It will be appreciated by those of ordinary skill in the art that each recognition and feedback activity may be represented as a data-structure, data-type, or similar such arrangement, that is stored in volatile or non-volatile memory.

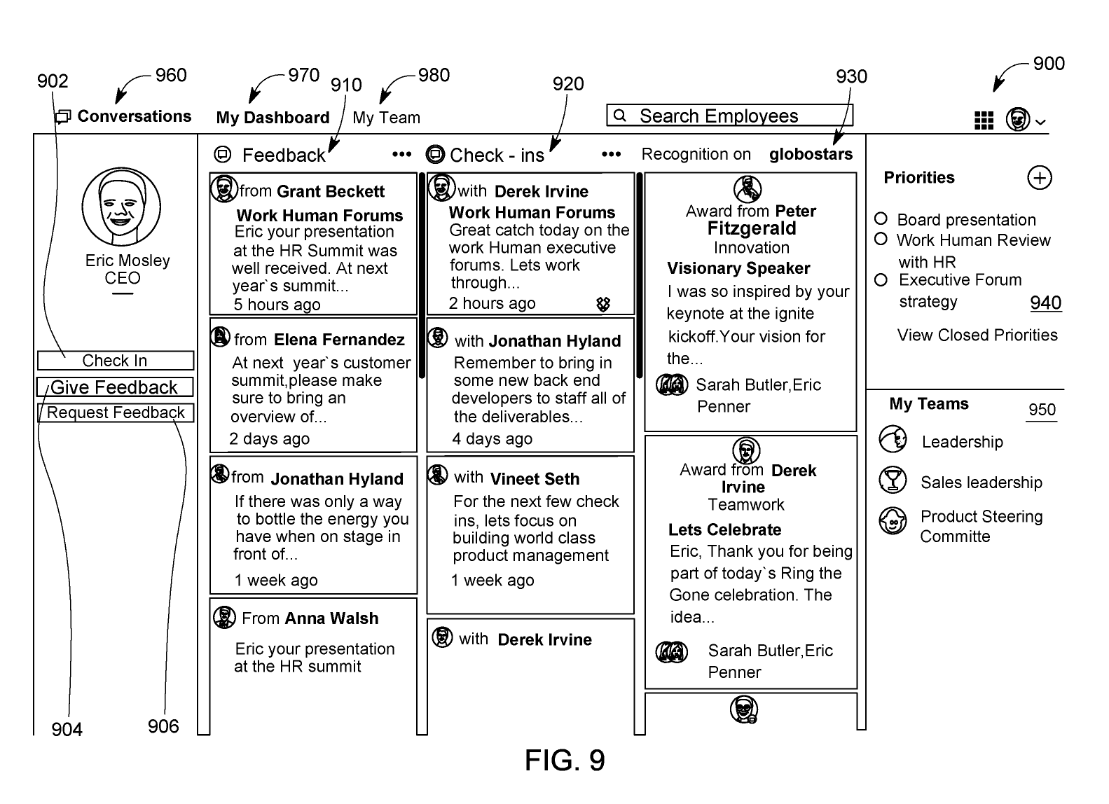

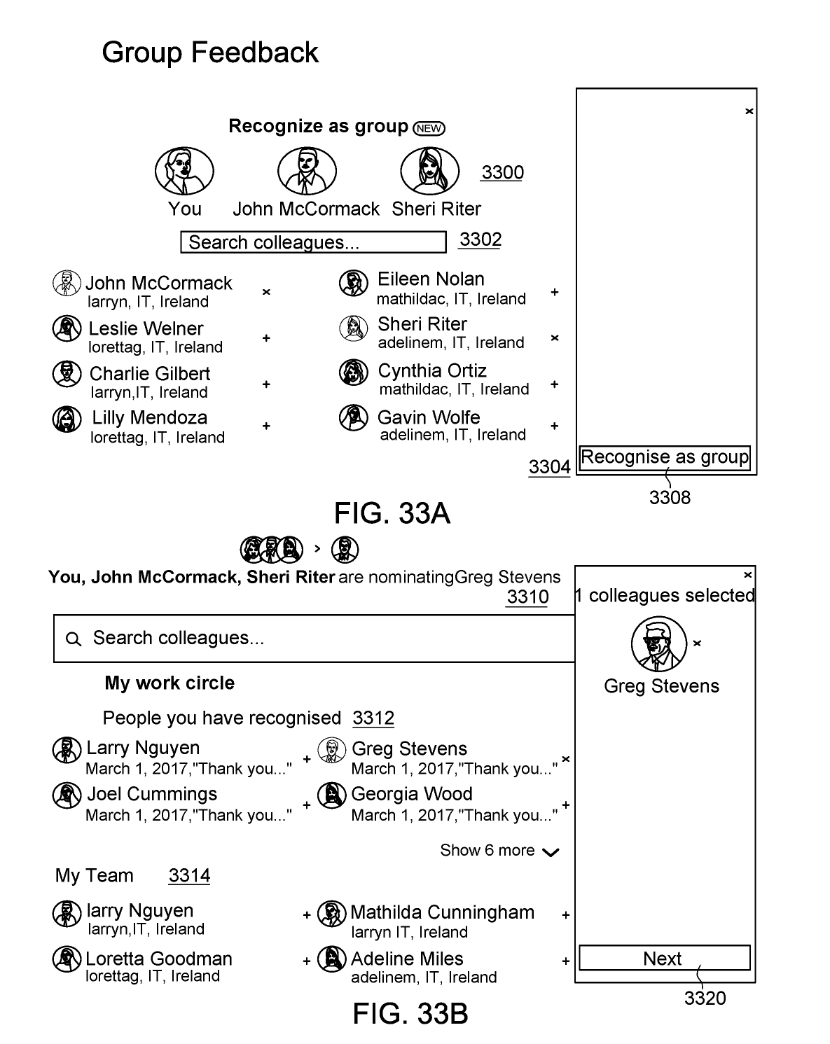

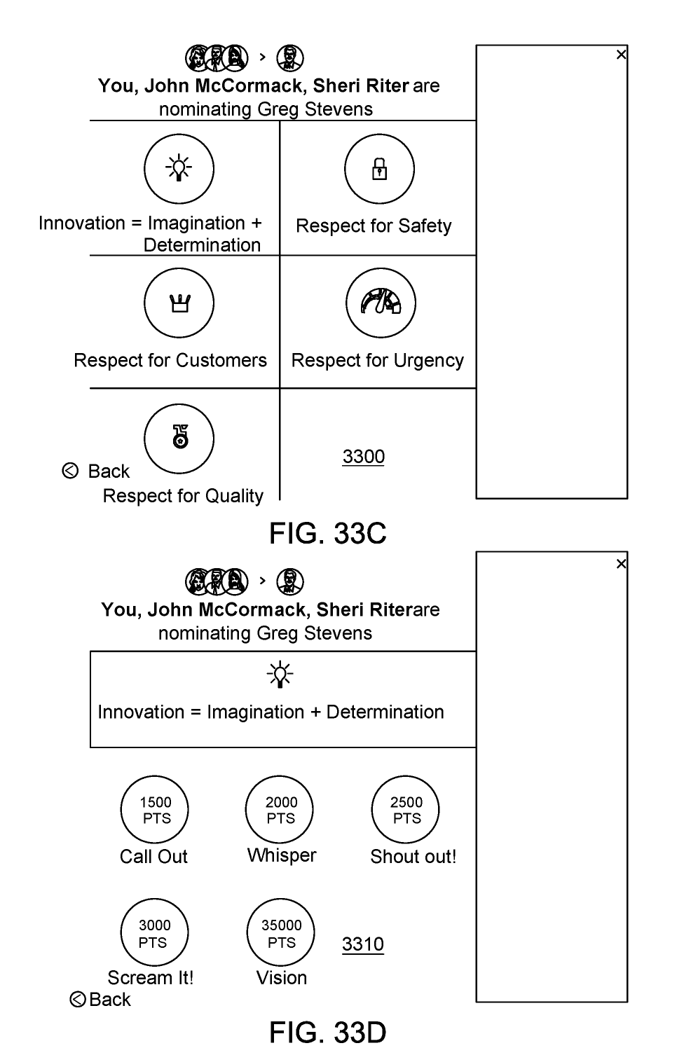

FIG. 9 depicts a user interface illustrating a profile page 900 in accordance with an embodiment of the invention. In embodiments of the invention, through the profile page 900, one or more participants, such as employees, a group, or a team of employees may provide recognition, feedback, or check-ins to another employee or team of employees. For example, an employee working with multiple individuals can submit feedback or a recognition moment on behalf of one or more of the individuals an employee is working with. As such, the giving of feedback and/or recognition moment can be from multiple people. (The process of group recognition is illustrated more clearly by user interfaces displayed below in FIGS. 33A-D.) In embodiments of the invention, a series of user interfaces may be provided for facilitating teamwork and enabling conversations between team members. The interfaces may be utilized for aligning team priorities, regulating and tracking collaboration, and celebrating and recognizing success. Check-ins can be utilized, for example, to document decisions, action items, or other discussions. Through the team interfaces, team members are enabled to track and manage priorities, request feedback on priorities, comment on priorities, or receive recognition. Team members are further enabled to create teams and manage team membership.

The illustrated profile page 900 includes a dashboard 970 identifying the profile page owner and providing feedback and check-in options. A check-in option 902 allows the owner of the profile page to check-in with other participants including team members. A give feedback option 904 provides the owner of the page with an opportunity to enter text feedback for a team member or other participants. A “Request Feedback” option 906 allows the owner of the page to request feedback from other system participants. When feedback is entered or given, the interactive system performs the processing substantially as shown in FIG. 6 as described above. A feedback column 910 shows feedback received by the owner of the profile page in reverse chronological order. A check-in column 920 shows check-ins between the owner of the profile page and other participants in reverse chronological order. A recognition column 930 shows recognitions received by the profile page owner in reverse chronological order. The profile page additionally provides a priorities section 940 that enables the profile page owner to view both open and closed priorities. Additionally, the profile page provides a team section 950 that allows for switching views between multiple teams when the page owner is affiliated with multiple teams. The columns for feedback, recognitions, and check-ins may be expanded so that a profile page viewer can view a feedback wall, a recognition wall, or a check-in wall.

Recognitions, feedback, and check-ins may be provided in real-time upon entry into the unique profile page or through other provided mechanisms and may be provided automatically through the interactive system. For example, a manager or colleague may provide feedback and/or recognize an employee and/or nominate them for an award, and in some embodiments of the invention, the recognition or feedback is automatically uploaded to the awardee and/or awarder's profiles. In other embodiments of the invention, one or more authorized individuals may view feedback and approve, decline, or edit it. The authorized individual(s) may highlight certain aspects of the feedback and add comments to the feedback, recognition, and/or award. The authorized individual(s) may increase or decrease any associated award, or convert feedback to a recognition moment. An authorized individual may also disagree with any feedback, recognition, or award, and not approve the advanced feedback, recognition, or award. Various approval channels may exist to both approve and disapprove any feedback, recognition, or award.

In embodiments of the invention, feedback received by a target participant can be reviewed and shared with the manager and/or other colleagues or third parties. In other embodiments, the manager receives the employee's feedback simultaneously with the employee. In embodiments of the invention, managers may see consolidated views of the feedback for one or more employees, or consolidated views of feedback for the whole team. A feedback or recognition may be tagged or associated with an employee, a team (ad hoc or formally assigned), an employee's priority, a project, an employee's strength attribute, or competency, or other categories, attributes or groups discussed herein.

In embodiments of the invention, managers may add comments, pictures, videos, or other media, or provide coaching advice on the feedback an employee received. In embodiments of the invention, the interactive system may encourage the feedback or check-in, by utilizing an e-mail, mobile alert, and/or operating system alerts based on schedule considerations programmed into the interactive system 10.

The interactive system 10 provides recipients with the opportunity to respond, for example by thanking the recognizer, or in turn, providing feedback to allow the recognizer to be recognized. The recipient can further pass on any award or recognition to person(s) outside of the organization in the form of for example, money, a physical object, or payment. The awards are converted to a monetary amount via an organization-driven value associated with each point, or lump sum of points. The value of the award points may be applied to the purchase, and the sender may have the option of paying any difference for a physical object, money, or payment. There are limitless options of vendors who may be affiliated with the company/organization to purchase the physical object or payment.

In embodiments of the invention, participants including employees can also give, receive and request feedback from others. This allows a crowd-sourced approach to performance and development that includes not only recognition or feedback-worthy moments, but sometimes-appropriate more neutral suggestions or comments. In embodiments of the invention, a user and/or manager can initiate a check in and enter an optional title and a short piece of text describing the check in. Employees are presumed to be checking in with their manager, and managers have a choice of direct reports when initiating a check in. Either or both employee and manager can create a check in. Historical check ins are shown at 920 for both employee and manager, along with recognition and feedback, all displayed most recent first in chronological order. In embodiments of the invention. The type of item (feedback, check in or recognition) is shown along with the date. In further embodiments of the invention, the employee and the manager can clearly see what activity is new since the last check in.

In embodiments of the invention, the feedback or recognition (or award) a recipient receives may automatically generate additional goals or priorities 940 participants, such as employees or teams. In embodiments of the invention, cascading goals may be set up such that feedback, recognitions or awards based on company values, priorities, or goals, for example, are stretched out over time to motivate performance. For example, if an employee at a law firm has goals such as (1) help another prepare for deposition, and (2) take a deposition, the second goal may be automatically affiliated with the employee who has completed the first goal of helping another prepare for a deposition. Skilled artisans would recognize the innumerable goals or priorities that may be created by an organization, as they are stored in an organizational database within the data storage system or assigned by an employee. As certain goals, priorities, or company values are met, as determined by the manager, colleague, or the interactive system, new goals, priorities or company values are set for the employee or team. In embodiments of the invention, the cascading goals may provide a basis for any incremental performance review (i.e. annual).

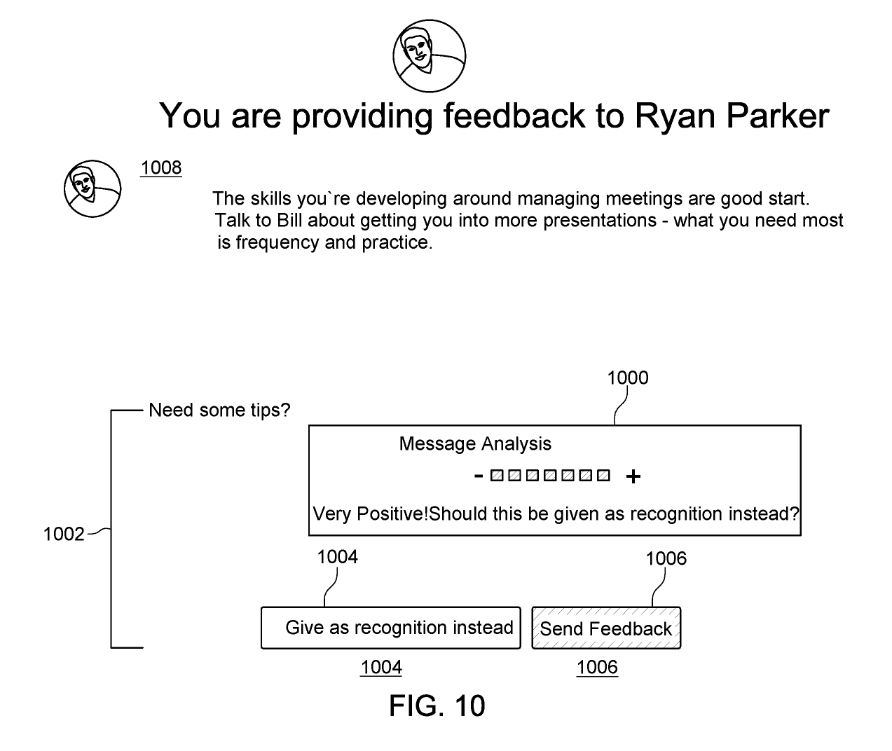

FIG. 10 illustrates a feedback interface including textual analysis in accordance with an embodiment of the invention. The feedback interface may be highly configurable to organizational needs. In the illustrated embodiment, the feedback interface includes a text box 1008 for entry, a tips section 1002, and a message analysis 1000. The feedback interface may further provide an option to send the entered feedback 1006 and an option 1004 to convert the text as recognition instead of feedback.

For example, in embodiments of the invention, any text in the recognition/feedback box 1008 may automatically highlight key words that appear in the organizational values, mission statement, or other company standard, as it appears in the organizational database. The highlights may appear on the recognition/feedback box 1002 on, for example, the recognition/feedback wall whereby the recognizee is able to see how the recognition or feedback intersects with, for example, the company values, mission statement, or other company standard, as it appears in the company database. In embodiments of the invention the recognition/feedback wall is integrated with the feedback and/or recognition and/or check-in, or other embodiment as described herein. The recognition wall provides a social performance review system whereby participants can view and review and interact with feedback and/or recognition moments. In alternate embodiments, the highlights can appear as the recognizer is drafting/writing the recognition/feedback. As explained above, as the participant is typing, the system may recommend language as it appears in the company values, mission statement, or other company standard, from the organizational database. In either case, these highlights may appear automatically or as authorized by an optional reviewer. Highlights appear on the feedback or recognition moment, thus allowing a manager to pause and thoughtfully think about what aspect of the employee performance should be emphasized. In embodiments of the invention, colleagues, employees, or third-parties may comment on, or otherwise interact with, the feedback, recognition, or award, on for example, a recognition wall. Including feedback from peers in colleagues in a positive and informal manner assists with productivity.

The participant, when providing the feedback at 1008, may optionally have the feedback vetted through an automatic (live) sentiment or textual analysis. Specifically, embodiments of the invention further facilitate the composition and delivery of feedback, check-ins, and recognition through real-time sentiment analysis of user-entered feedback and the use of collected and system-generated recognition and feedback data (e.g., recognition and feedback data and graphs discussed herein) and other important factors, including company values. For example, in FIG. 10, a participant is providing feedback to Ryan Parker and the message analysis 1000 renders the message to positive and thus provides the recommendation at 1004 that the feedback be converted to recognition. Alternatively, if the message is negative, the message analysis window 1000 may appear after the text analyzer analyzes the message to alert the participant if the wording is too negative. The sentiment analysis may be nuanced and, in embodiments of the invention, gives more weight to certain strategic concepts as they exist in the organizational database. For example, if the organization has emphasized the organizational values or missions in the organizational database, then the spectrum of the message analysis 1000 may be more positive (+) if the feedback includes any of that language. The feedback can fall on a spectrum, from, for example, constructive to recognition. In that regard, feedback is not required to fit neatly into any category, it can fall on a spectrum as defined by the organization. The interactive system sources the organizational database over a network and processes the data in the database, stored on a memory in the processing device, to analyze the language. While the sentiment analyses is shown at 1000, sentiment analysis can be hidden or displayed. If the analysis is hidden, the interactive system can nonetheless provide guidance without displaying the analysis.

The textual or sentiment analysis may optionally be based on a built in dictionary in the organization database and may be stored in the data storage system. Skilled artisans would recognize the various dictionaries or phrases that may be built into the database, including, for example, a lexicon of coaching words. Optionally, the sentiment analysis may be enhanced based on whether the message is forward looking (positive) or backward looking (negative). The sentiment analysis may additionally recognize company goals, team priorities, team goals, missions, or other metric(s) as they exist in the company database, and feedback to the recognizer in the message analysis window 1000 may appear.

In embodiments of the invention, the sentiment analysis leverages at least one textual analysis engine as described above. For example, when a user submits feedback, there is a real-time call to the text analysis engine. In the case of positive feedback, the textual analysis engine may recommend reclassification of feedback as recognition based on the positivity score. Similarly the textual analysis engine may be utilized to add additional celebratory language to a recognition moment. Additionally, the textual analysis engine may be employed to automatically create a recognition moment for an employee receiving one or more feedback messages with positivity scores. A company, boss, manager, or colleague can set the minimum limits for number of feedback messages and/or minimum positivity score for the automatic recognition moment. In embodiments of the invention, the textual analysis engine can learn through repeated processing the number of feedback messages required and/or the value of a positivity score to automatically generate a recognition moment.

In embodiments of the invention, the organizational database in the storage system may be updated. For example a user may elect to add certain words to the database as “positive”, “negative”, “neutral”, or within the spectrum of positive to negative. Additionally, the database may optionally process and analyze the various feedback and recognition moments being sent over the network from one or more colleagues/outsiders to other colleague(s) or outsiders to add additional words or phrases into the company database. Over time, as users increasingly utilize the system, the processing components of the recognition and feedback system can learn and adapt by adding language to the organizational database or altering the sentiment affiliated with certain language. The processors may add or remove words or phrases to the company database based on compiling and analyzing historical data, interactions with feedback/recognition moments, and any other format of feedback/recognition as described herein to add language to the company database, and in turn determine the levels of sentiment.

In at least one embodiment, the text analyzer may operate based in part on recognition and feedback data that has been collected by the feedback and recognition system, as well as feedback and recognition data from external systems (e.g., other feedback and recognition systems or a central database managed by a third-party). The system may automatically update its dictionary and database based upon the feedback and recognition that is received by employees and teams at the company and may automatically add or delete terms or phrases that align with the company's values or other attributes discussed herein, including the feedback and recognition moments collected and analyzed. The interactive system may automatically learn internally-used phrases and may determine such phrases as positive or negative and may consider such factors in providing users with suggestions. While separate engines, such as the feedback engine, recognition engine, and check-in engine may each provide a distinct textual analysis module, one or more engines may share a single textual analysis module may or multiple textual analysis modules.

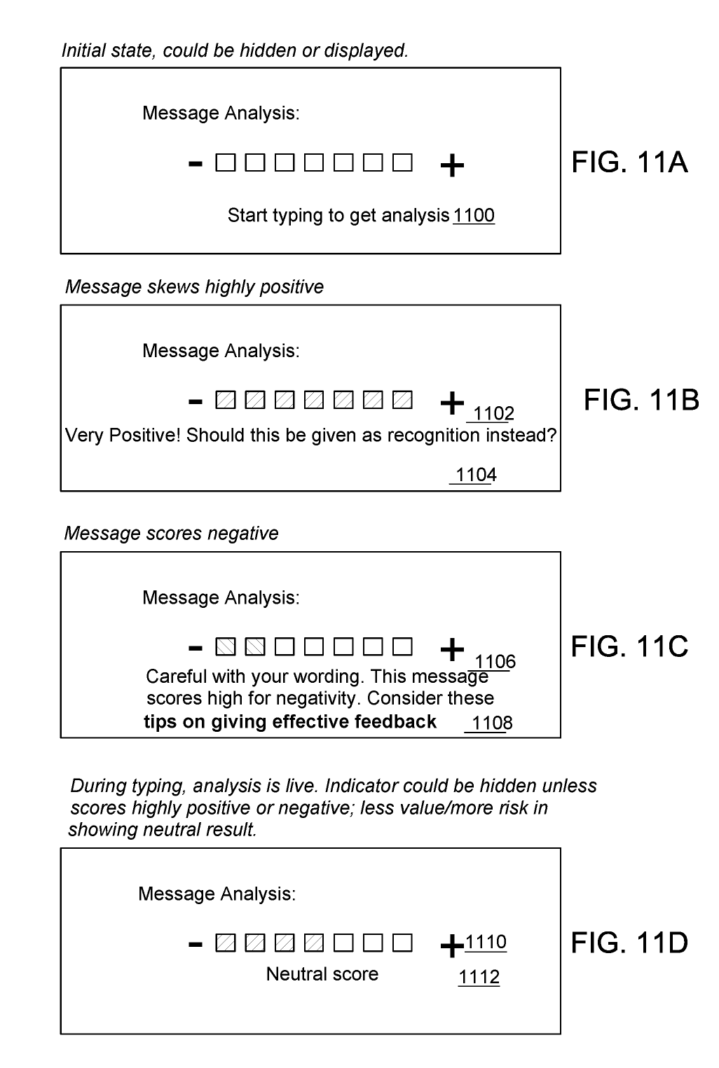

FIGS. 11A-11D illustrate a user interface for textual analysis of feedback in accordance with an embodiment of the invention. FIG. 11A displays the initial state of the message analysis. The system displays a message 1100 advising the participant to start typing in order to obtain an analysis. In the initial state of FIG. 11A, the system may show the positivity spectrum without any analysis. Alternatively, the spectrum may be entirely hidden. In FIG. 11B, the interactive system detects a positive sentiment as shown by the filled boxes 1102 and the statement 1104 that perhaps the feedback should be provided as recognition instead. FIG. 11C shows a negative message score at 1106 and further displays a message 1108 that the message scores high on negativity. A URL or other selectable informational access point may be embedded within the message, so that a participant can select the URL or access point to receive tips on giving effective feedback. FIG. 11D illustrates a neutral message analysis 1110 that receives a neutral score 1112. In this instance, the participant may proceed with the feedback as entered allow processing as described above with respect to FIG. 9. Furthermore, the neutral sentiment analysis may be hidden by the interactive system.

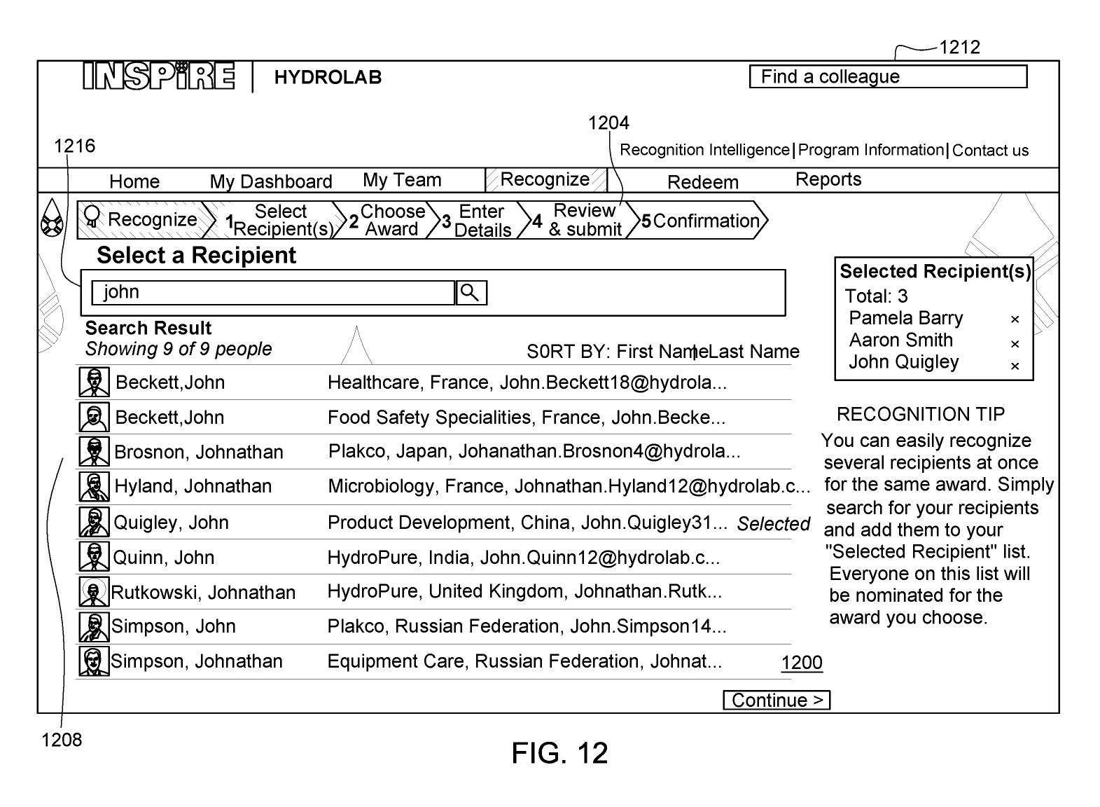

FIGS. 12 to 16 illustrate a series of user interfaces that may be presented to a user to assist the user in creating a recognition moment. As previously set forth, while certain foregoing examples may refer to the collection, analysis, and delivery of recognition activities, embodiments of the invention would also support the collection, analysis and delivery of feedback data and check-ins in similar fashion as described in the example therein. Similarly, while certain foregoing examples may refer to the collection, analysis, and delivery of feedback activities, embodiments of the invention would also support the collection, analysis and delivery of recognition data in similar fashion as described in the example therein. Thus, while the following example discusses the collection of recognition data to generate, e.g., a graph based upon recognition data, embodiments of the invention may support not only these features as they relate to recognition data, but also support such features with respect to feedback and check-in activities.

The data collection module may collect the recognition data input by the user through the user interfaces generated, with some or all of the data, in turn, being used to create various recognition moments. A user may be assisted in creating a recognition moment and may be presented with a user interface 1200 containing step indicator 1204, list of eligible recipients 1208, selection status 1212 and search function 1216, as depicted in FIG. 12. The step indicator 1204 may provide the user with the steps that have been taken and are to be taken in creating a recognition moment and may be replicated (with a corresponding highlighted step) as the user progresses (i.e., it may be replicated on user interface 1200-1600, as shown). The user may search for recipients via the search function 1216 by entering the name of the eligible recipient and may select the recipient via the list of eligible recipients 1208 that are found. In one embodiment, the list of eligible recipients 1208 may list all recipients eligible for a recognition moment at the organization. Eligible recipients may include all members of an organization, or some subset of that organization, including team members, department members, employees at a similar level of seniority, and any other sub-group within the organization. In one exemplary embodiment, the scope of eligible recipients may be a variable set by a system administrator. In another exemplary embodiment, the user may select groups of recipients to receive recognition. Further, embodiments may allow managers to search for employees based on attributes including number of recognitions, previous recognitions, years in the company, by location, by grade, by department, and other employee organization attributes of the employees, thereby giving every employee the opportunity to be recognized. While FIG. 12 relates to recognitions, a similar interface can be provided for submitting feedback. In embodiments of the invention, another menu tab labeled “feedback” and an additional menu tab labeled “check-in” can be provided.

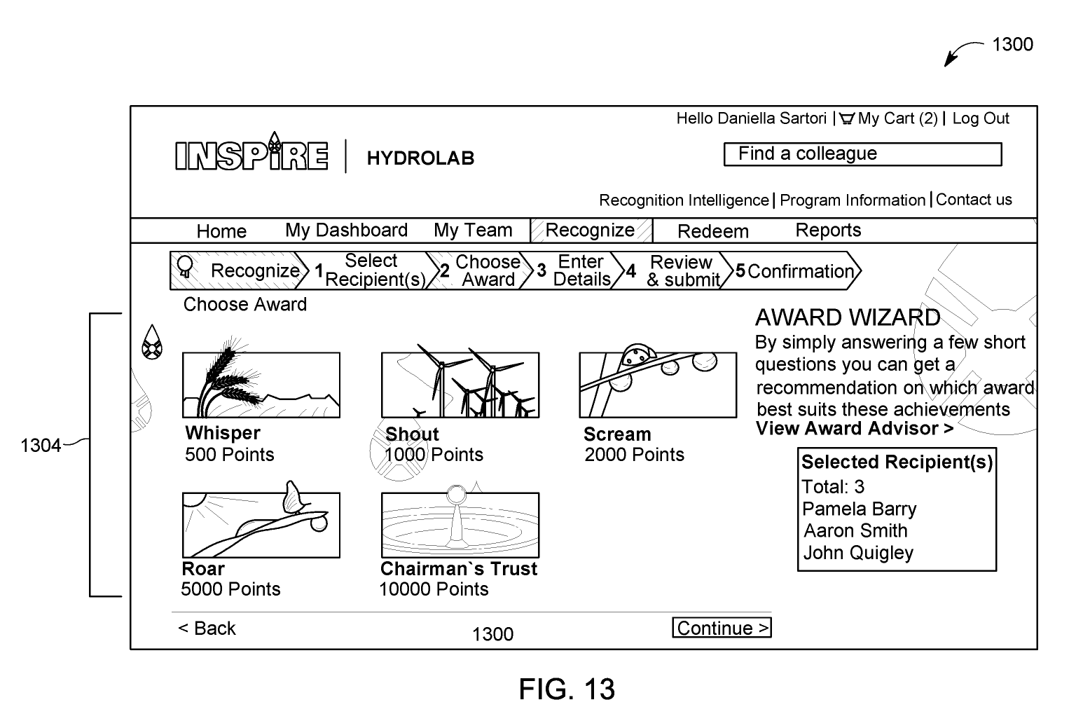

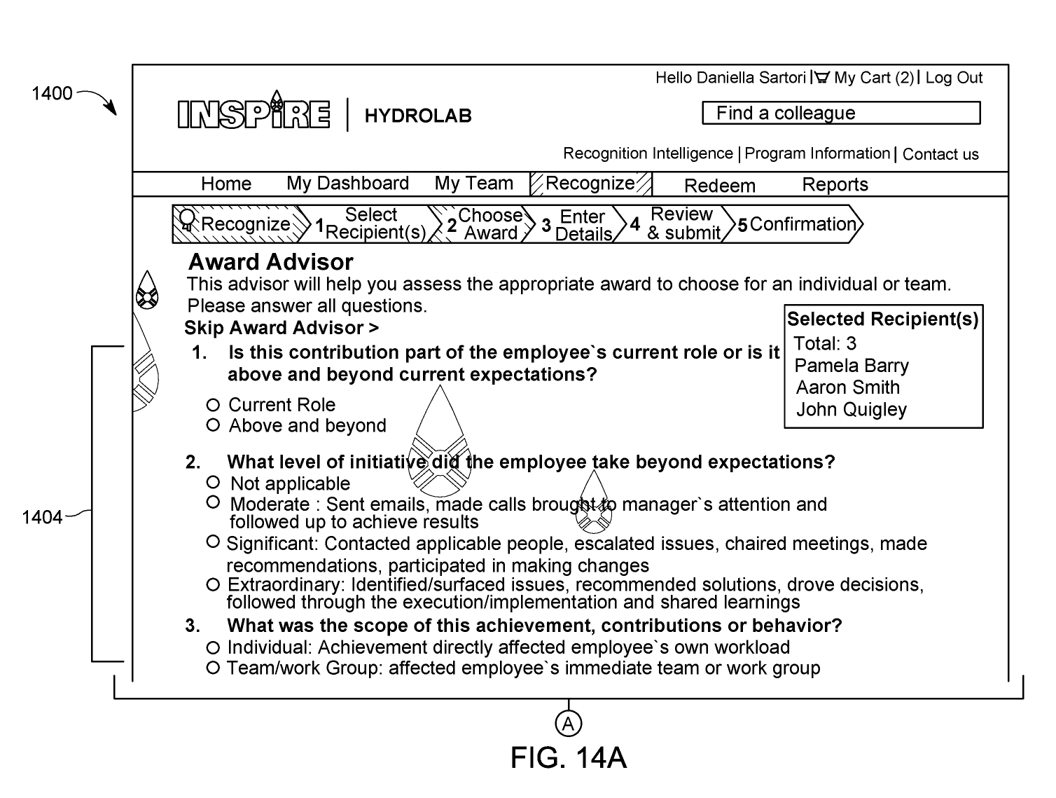

In addition to selecting recipients, the user may also select one or more awards from an award library 1304 via user interface 1300, as shown in FIG. 13. Awards may take many different forms, including monetary (e.g., $50), points, messages, title, relative ratings (e.g., “A+”), etc., and in each case, varying degrees or levels of recognition. Awards may also include access to redeem the economic value of an award including but not limited to merchandise, gift cards, tickets to events, access to company related, office related or team related perks. In embodiments of the invention, gift cards may be stored on the mobile application. In embodiments of the invention, gift cards include brands around the world. In embodiments, gift cards may be debit cards. In embodiments of the invention, debit cards may be delivered globally. In alternative embodiments of the invention, gift cards may be delivered physically or virtually. Thus, in these embodiments, the disclosed system may integrate with one or more third-party computer systems in order to automatically create and complete gift card (or other rewards) purchase orders. The system may utilize one or more Application Programming Interface (API) to connect and/or integrate with one or more third-party systems.

In embodiments of the invention, awards are crowdsourced. Crowdsourcing for recognitions is shown, for example, in FIGS. 33A-33C. For example, sponsors, managers/bosses, employees, or other colleagues may have an allocation amount that they can distribute to others within the company. Embodiments of the invention utilize a crowdsource system wherein funds are automatically collected from the sponsors, managers/bosses, employees, or other colleagues based on a recipient's feedback, recognition moment, check-in, performance review (at any increment), or other methods as described herein, and the amount allocated by each sender. Sponsors, managers/bosses, employees, or other colleagues may, when providing feedback or a recognition moment or during a check-in as described herein, may allocate part of their allowance to the recognizee. The employer may also associate certain recognition moments or feedback received with certain awards. For example, a person receiving feedback that has highlighted company values may receive 5000 award points. The crowdsource system allows for automatic distribution of funds in a manner that would induce improved performance and/or employee satisfaction. In embodiments of the invention, the funds may be received by the recipient in any form of virtual currency. The crowdsource system may additionally integrate micropayments into the crowdsource system. In embodiments of the invention, the recipient of an award may donate it to a charity of their choice, or a charity affiliated with the company.

In embodiments of the invention, the award may be enchanted. A physical object with transient phenomena to certain work anniversaries, for example, may be created and given to an employee. For example, a physical object (such as a photographic picture frame) that displays various recognition statements may be created recognizing 5 years of recognition moments. Another example is a beacon that sits on a desk and lights up for 24 hours when an employee receives an award. These enchanted awards promote the recognition program and boost employee morale because the physical object solidifies the award, and serves as a reminder for work done well. Skilled artisans would recognize the various types of enchanted awards and the various reasons to receive an enchanted award. Awards may also be 3-D printed to include a phrase or otherwise highlight a recognition moment. In an embodiment of the invention, the object can be a nameplate. In other embodiments of the invention, the enchanted object can be drawn to the award as depicted in the database and/or recognition wall. The enchanted object may be interactive. For example, a printed award may have a code or other computer readable medium that may be scanned by a company recognition or conversations application such that a user may input or scan code on the award and view the award, and/or interaction with the award, and interact with the award themselves. In embodiments of the invention, any and all physical award may be linked to an interactive award. In at least one embodiment, devices of employees within the vicinity of the enchanted object may automatically identify the enchanted objects. The employee's devices may automatically access the rewards page or the corresponding recognition.

Furthermore, the awards may be a single award, or the compilation of two or more awards. For example, a user may submit both a monetary award and a rating. In addition, awards may be selected to be delivered at a particular time or at one or more periods. Thus, an employee may receive awards and associated redemption for rewards monthly over a 12-month period. In one embodiment, a user may also modify awards to be provided at a later time.

In embodiments of the invention, rewards are global and may be automatically selected by one or more the systems disclosed here in to select a reward based on any number of factors, including, but not limited to: accounting for employee choices, locality of the employee, experiences of the employee, the meaning of the reward to an employee, and the efficiency of delivering the rewards. Various non-limiting examples of products include movie nights, television shows, luxury handbags, electronics, etc.

The interactive system may suggest awards via the analysis engine shown in FIG. 1 or other component of the interactive system, where the suggested award may fittingly correspond with the level of achievement. The suggested award may also be based on previous awards submitted by others. For example, a specific award level with a specified economic value may be suggested because it has been given numerous times for the same or similar recognition to other recipients. In one embodiment, the user may be asked to answer a brief set of best-practices questionnaires, whereupon the award may be automatically recommended to match the level of recognition to the degree of achievement being recognized. Thus, embodiments of the invention support company-wide consistency in the level of recognition, while preventing misuse. This further eliminates psychological barriers in adopting a recognition culture. Indeed, in at least one additional embodiment, the interactive system includes an award monitoring module that monitors the awards selected by all users to ensure that awards selected are appropriate. Upon the detection of award nominations that are possibly fraudulent or simply inappropriate, the award monitor module may automatically notify a supervisor or administrator for action. The monitor module may also reject the recognition nomination by the user or simply suggest to the user that the chosen award is not commensurate with the degree of achievement being recognized. As discussed, awards may optionally be based on converted recognition moments or feedback.

Certain awards may only be available for certain types of recognition. Awards and recognition may be categorized based on one or more levels, where the selection of a particular recognition allows for the selection of only awards from the same level or less. As one example, vacation or trip-related rewards may only be given to employees who have or are to be recognized for a top-level recognition, such as having worked for the company for 25+ years or were responsible for more than $1,000,000 in company sales.

In one embodiment, the interactive system supports the use of virtual recognition currency. Recipients may be provided with points as the economic value of the awards, with each point representing an amount in real-world currency. In one exemplary embodiment, users may be provided with points that are each worth $0.05. Further, selectable awards may include point awards that provide to recipients predetermined numbers or levels of points. For example, in one embodiment, available awards may include: Praise (1,000 points), Cheers (2,000 points), Sing (3,000 points), Shout (5,000 points), and Amplify (10,000 points). Employees may redeem the points to purchase various merchandise and other rewards, which may be managed by a third-party company that provides a catalog of available prizes and that manages the delivery of the prizes to employees as a service.

The awards that are available for selection may further be dependent on local standards of living. Thus, certain awards may be adjusted according to high (or low) costs of living based on where the recipient resides. Awards for employees in a New York City, N.Y. office of a company may be relatively greater in economic value (e.g., number of points) than awards available to employees in the Mumbai, India office, where the cost of living is much less. Thus, for example, the Shout award given to an employee in New York City may be worth 1,000 rather than 620 points in Mumbai, India.

The interactive system further supports the integration or connection with one or more internal and external computer systems in providing selectable awards. More specifically, the available awards may include awards that are configurable to be provided based on the data available at other systems. The interactive system may also connect to one or more external or internal systems to provide recipients with access to certain types of awards. For example, the interactive system may automatically connect with a ticket system to automatically place an order for a theatre tickets in response to a nominator providing the recipient with the recognition award. The interactive system may further connect to one or more financial institutions to complete financial-related transactions including those related to tax filings.

In one embodiment, awards may be configured to be dependent on the actions of employees. Recognizable actions may vary from very specific actions and/or goal attainment to career-long milestones. As an example, not meant to be limiting to the scope of the invention in any way, a recognition nominator may configure an award based on whether a recipient has: completed a report, performed a filing, completed a project with another team member, received a number of positive praise from company clients, managed a number of employees, worked with a particular number of employees at the company, performed volunteer or public relations services, met a sales or profits requirement, billed a number of hours in a year, or worked for the company for a number of years. A recognition nominator may be any person or entity that would like to nominate an employee within an organization for recognition, such as a manager, the HR committee, a fellow employee, an employee at another organization, and others.

In addition, the actions of the employee may be in the past or in the future. Thus, in one embodiment, in response to a user defining a particular user action (e.g., via user interface 1400), the interactive system may automatically connect with one or more internal or external systems to determine whether the user has met the requirements of the award. For example, the interactive system may connect with a task management system, database or file to determine whether a particular project task has been marked as completed within project parameters. Further, the interactive system may connect with employee HR records to check how long an employee has been with the company. Similarly, the interactive system may download internal or external financial results (e.g., SEC filings or internal business systems) to determine whether the company (or a division) has earned certain profits. As another example, the interactive system may connect with the internal email system to determine whether clients have praised the recipient and/or his or her work via emails. In one embodiment, the interactive system may send communication to a client, a supervisor of the recipient, or the recipient him or herself to determine (or simply verify) that the recipient has performed the particular task. Proof may be submitted and/or required. The interactive system may automatically provide to the user via user interface 1300 the status of the recipient's actions and whether the user has performed the defined actions such that an award should be given.

In addition to verifying that particular actions have been performed, interactive system may further be configured to monitor for future completion of such actions. Thus, the interactive system may automatically notify the user at a later time that the defined recipient has met the parameters defined by the user as rewardable (e.g., via email), whereupon the user may confirm that an award should be given. Suggested recognitions may be provided to the user along with other features of the invention, such as alongside the genius recognition feed discussed in other portions herein. Upon receiving notice, the user may connect with the interactive system to continue (or simply confirm) the creation of the recognition moment. In one embodiment, the recognition moment may be automatically created upon detection that the recipient has met the defined parameters.

Therefore, embodiments of the invention dynamically monitor relevant data and systems to create recognition moments instantly as they are completed, thereby allowing employees to be quickly and efficiently recognized for their hard work. Indeed, in one particular embodiment, embodiments of the interactive system further have the capabilities to dynamically detect the need to create recognition moments based on detected actions of employees through the monitoring of one or more internal or external systems even without a user having defined the parameters to monitor. For example, recognition moments may automatically be detected based on awards given, awards received, congratulations received, received or shared team awards. Awards may be tracked for each user, based on the user's connection with his or her manager, peers, direct reports, manager's manager, manager's peers, peers direct reports, indirect reports, peers' indirect reports, and so on.

Managers may be notified as soon as the interactive system detects that an employee has completed a project or has received praise from a client, for example. They may be notified via, a push notification on their mobile device, a popup notification on their computer, an email, a text message, or any other cognizable method of notification. The interactive system may also suggest awards based on previous awards, where the suggested award may fittingly correspond with the level of achievement. In one embodiment, other employees who are simply working with the recognized employee may be notified of the recognized actions and may be asked to provide additional details to more formally recognize the employee. The employees that are selected to be notified may be based on the actions that are detected to be rewardable (e.g., others on the project team associated with a rewardable task), based on hierarchy of the company (e.g., org chart), based on the relationship with the rewardable employee (e.g., via the recognition graph discussed below), or combination thereof.

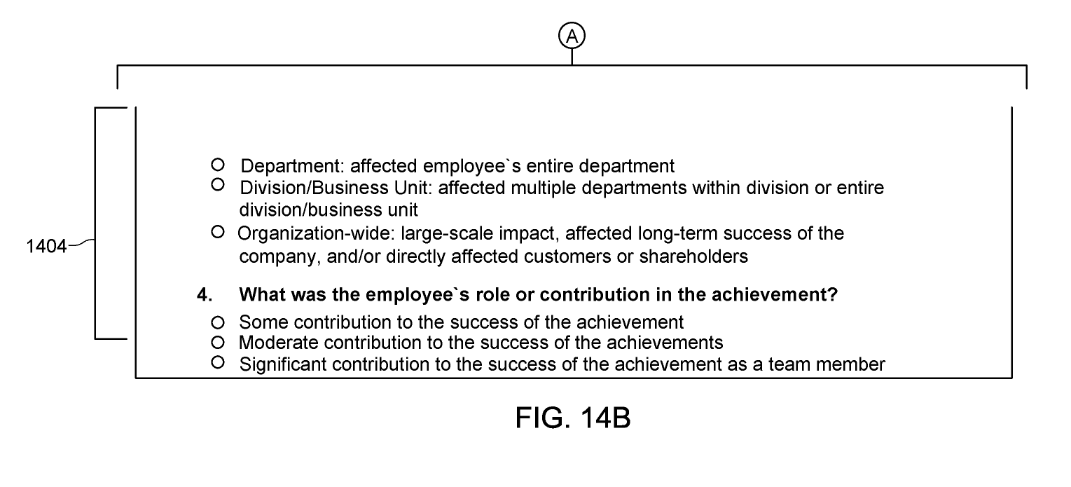

As illustrated in FIG. 14, in one exemplary embodiment, the user may also identify characteristics of the recognition moment associated with the award via user interface 1400. The characteristics may include the extent to which the recipient's accomplishments are connected to their role, the level of effort (e.g., perseverance, determination) exhibited by the recipient, and the scope or impact of the recipient's effort at an individual, team, division/department, company, and/or external level. As seen in FIG. 1400, the user may describe the characteristics of the recognition through a series of questionnaires 1404, which may include questions that users may answer by selecting different options describing certain aspects of the recognition. An administrator, supervisor, or others may define the series of questionnaires. Other types of questions may be utilized including questions for summary/text-based answers. In one embodiment, users may further upload multimedia, such as pictures, videos, audio or others. These characteristics may be incorporated into the recognition details.

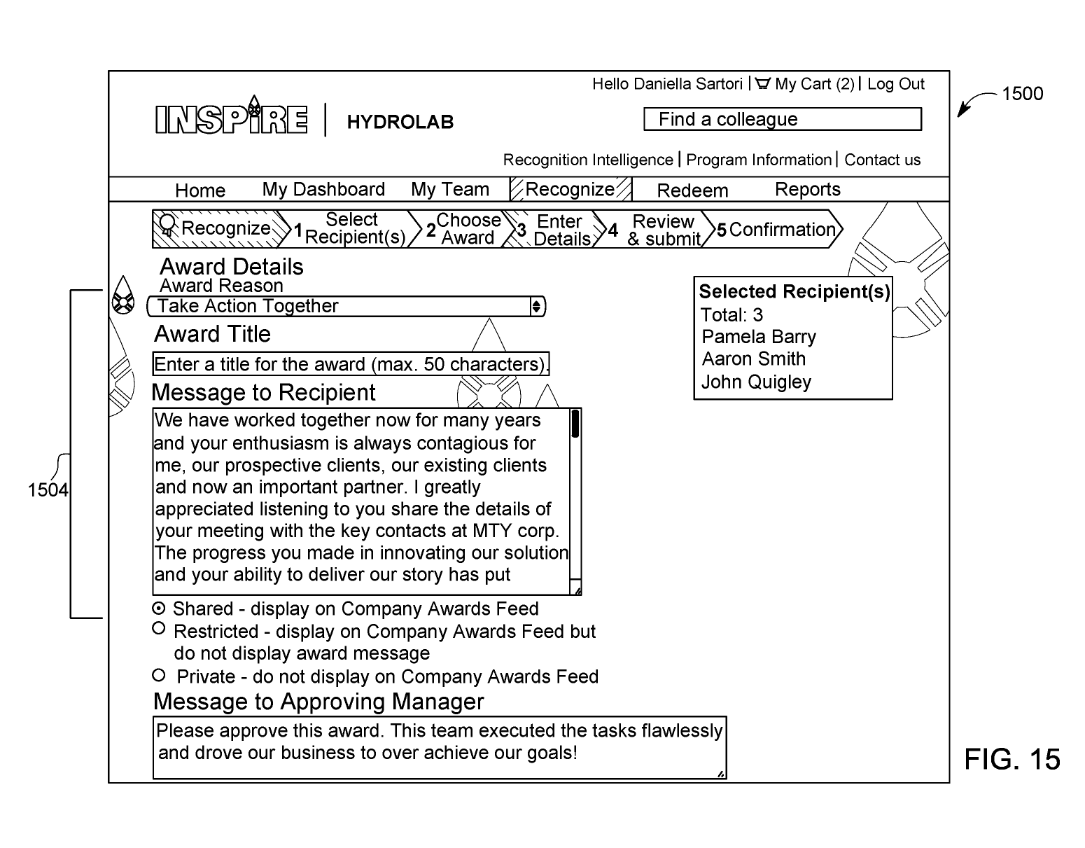

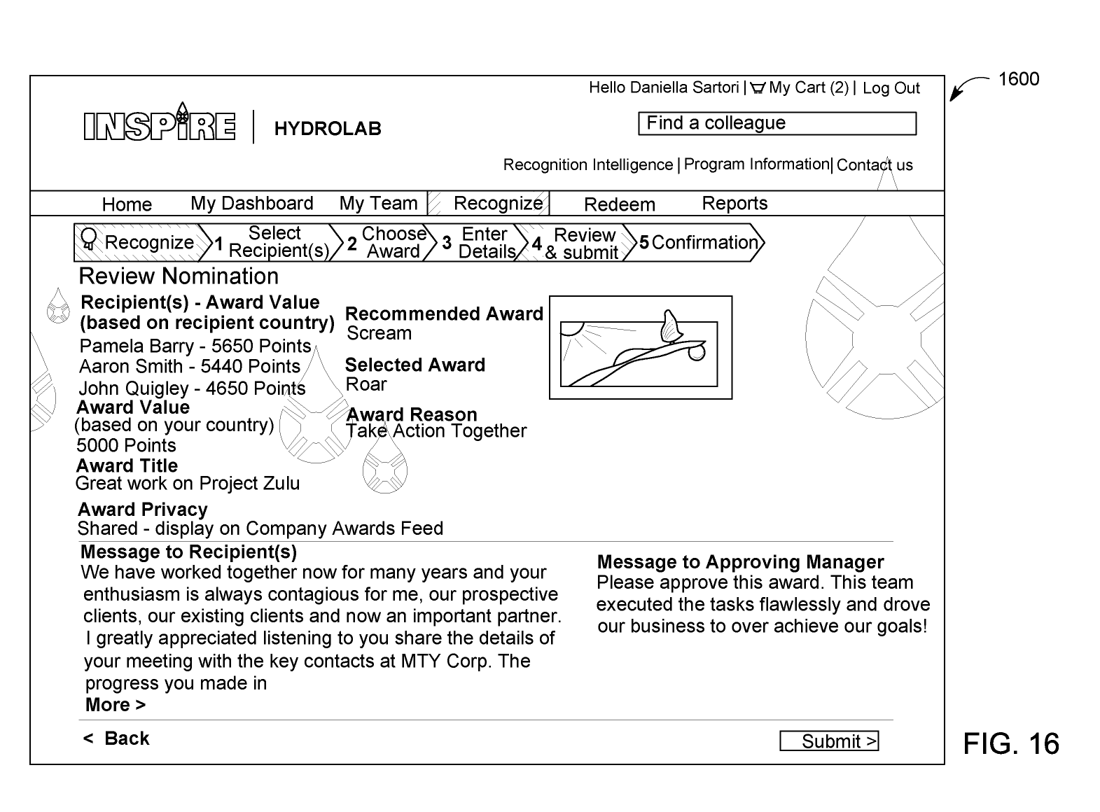

As illustrated in FIG. 15, in one exemplary embodiment, the user may identify an award reason or recognition category for the recognition moment. The recognition category may be selected from a list of pre-defined reasons or provided by the user. An administrator of the employee recognition program may submit and maintain the pre-defined recognition categories. In some exemplary embodiments, the pre-defined recognition categories for the recognition moment are, or are correlated to, specific cultural characteristics of the organization to which the user and recipient belong and which is managing the recognition program. In one exemplary embodiment, the pre-defined recognition categories include operational excellence, manager excellence, collaboration, innovation, business transformation, client satisfaction, teamwork, problem solving, and combinations thereof. Recognition categories may be based on dictionary definitions, company values, goals, and/or priorities, for example.

Also, as illustrated in FIG. 15, in addition to identifying a reason, a user may also incorporate a message in the recognition moment via message input contained in input area 1504. In one exemplary embodiment, the data collection module of the recognition engine can mine the message for certain key words and/or semantic analysis indicative of the recognition moment. For example, the data collection module may mine the message for key words or semantic tones related to operational excellence, manager excellence, collaboration, innovation, business transformation, client satisfaction, teamwork, problem solving, and combinations thereof. The data storage area 150, in one embodiment, may contain one or more databases of key words that may be searched for in a message. The interactive system may manage these databases and, in one embodiment, may automatically update these databases from time to time (or on command) by connecting to one or more network sources (e.g., a web site on the Internet) via network 160. These databases may also be updated or modified by an administrator.

In one embodiment, recognition data may be collected in bulk, such as through the processing of one or more recognition bulk files that contain data describing each recognition individually and collectively. Furthermore, in at least one embodiment, the data collection module may receive recognition data from one or more internal or external systems. For example, recognitions may be communicated to the recognition system by another employee at another company. Thus, it should be apparent that while the examples described herein may describe the actions being taken with respect to a manager or user of a particular company, that in other embodiments, various other systems, internally and externally, may be configured to operate together to provide the same or similar functions described herein.

In addition to the above-listed recognition data, additional recognition data may be collected in various embodiments of the invention, including: data related to the reasons for the recognition; data related to the significance of each award (e.g., recognition level, category, ranking or importance); sphere of influence data; connection strength between nominator and nominee; validation data (e.g., number and structure of congratulations received from employees for recognition); composition of the recognition message (e.g., keywords, length); approval data (e.g., award was approved by HR committee); and recognition distribution data (e.g., value of award versus average or normalized distribution of awards; variance from nominator's average nomination or rate of nomination, and conformity to average award economic value, frequency, and reaction). Various other recognition details data may be collected in other embodiments of the invention.

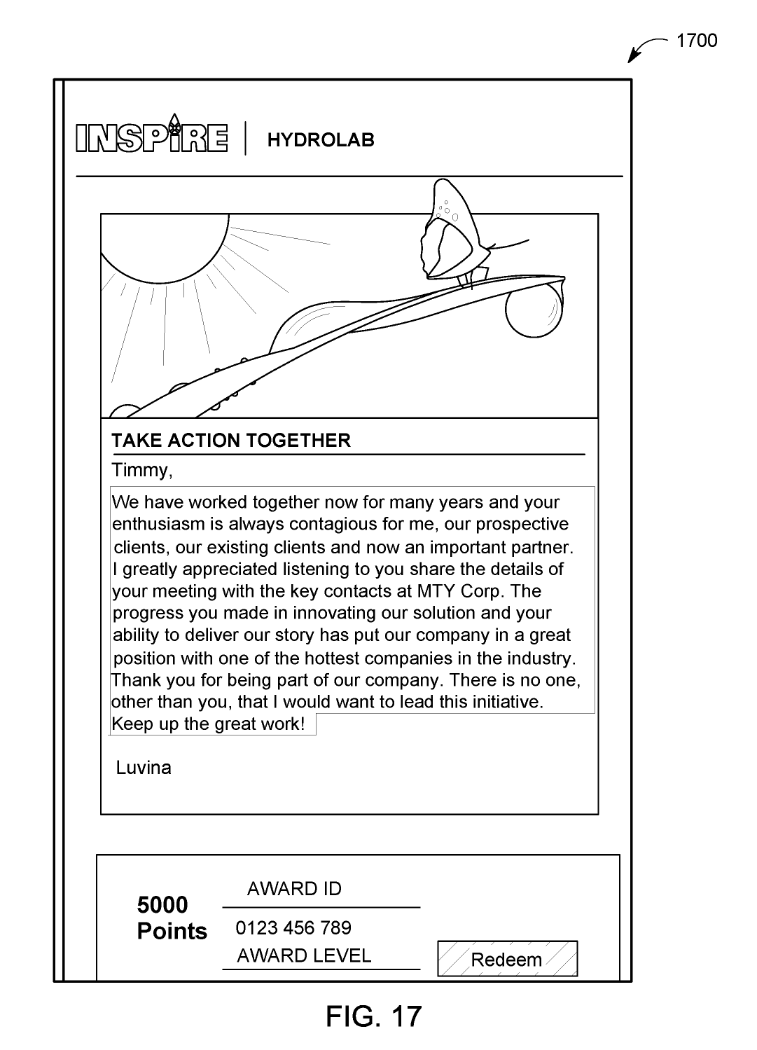

After the recognition data collection module 510 finishes collecting the above noted recognition data, the recognition moment creation module 520 may generate the recognition moment. As illustrated in FIG. 16, the user may optionally review the details of the recognition moment, the user interface 1600 displaying to the user the user's selected recipients, award, award value, award reason, award title, message to recipient, message to approving manager, and other information. In one embodiment, the user may further be provided with a view of the updated recognition map if the user were to enter his or entry. The displayed recognition map may highlight the effect the user's recognition submission would have on the recognition map. The user may be asked to submit the nomination and finalize his or her entry.

In one embodiment of the invention, recognition moments that are collected by the recognition data collection module 510 must be approved before the recipient is provided the award and is recognized. Thus, in at least one embodiment, a supervisor or administrator may receive a notification that the recognition data collection module 510 has collected a recognition nomination. The interactive system may further generate one or more user interfaces from which an administrator or supervisor may access a list of all pending recognition nominations, allowing for the easy review and approval of the nominations quickly and efficiently. The approver may further review where the nomination is in the approval workflow (where nominations require one or more approvals), and may approve recognition requests that have been escalated to the approver. The notification may contain some or all of the details of the recognition data that the user reviewed and entered using user interfaces 1200, 1300, 1400, 1500, and 1600. The administrator or manager may confirm the recognition, edit the details of the recognition (including the reward), and communicate with the award nominator regarding the reward. The approver can also add words of congratulations during the nomination process, thereby fortifying the meaning of the award in the eyes of the recipient. In one embodiment, any changes made by an administrator or manager may be transmitted to the nominator for approval or simply as a form of notification that changes have been made.

In one embodiment of the invention, the number and level of approvals required might be dependent on the award that is to be provided to the user. The larger or more valuable the award, the more levels of approval may be required. For example, where 1,000 points are to be awarded, only 1 level of supervisory approval may be required, whereas the award of 10,000 points may require 2 or more levels of supervisory approval. As described herein, points may optionally be crowdsourced from colleagues or bosses/managers at an organization.

FIG. 17 illustrates a user interface for transmitting recognition in accordance with an embodiment of the invention. As illustrated in FIG. 17, after optionally reviewing and approving the recognition moment, the recognition delivery module 530 may transmit the recognition moment to the recipient. In one exemplary embodiment, the system may transmit the recognition moment via e-mail. In other exemplary embodiments, the notice may be transmitted to the recipient via a portal site, the recognition feed (below), over twitter feed, push notification, rss feed, text message, mobile application other similar transmission methods, and combinations thereof. In embodiments of the invention, the mobile application is functional across all operating systems, including, by way of non-limiting example, Apple operating systems, Android operating systems, and HTML 5. While FIG. 17 pertains to recognitions, feedback and check-ins may be delivered in a similar manner.

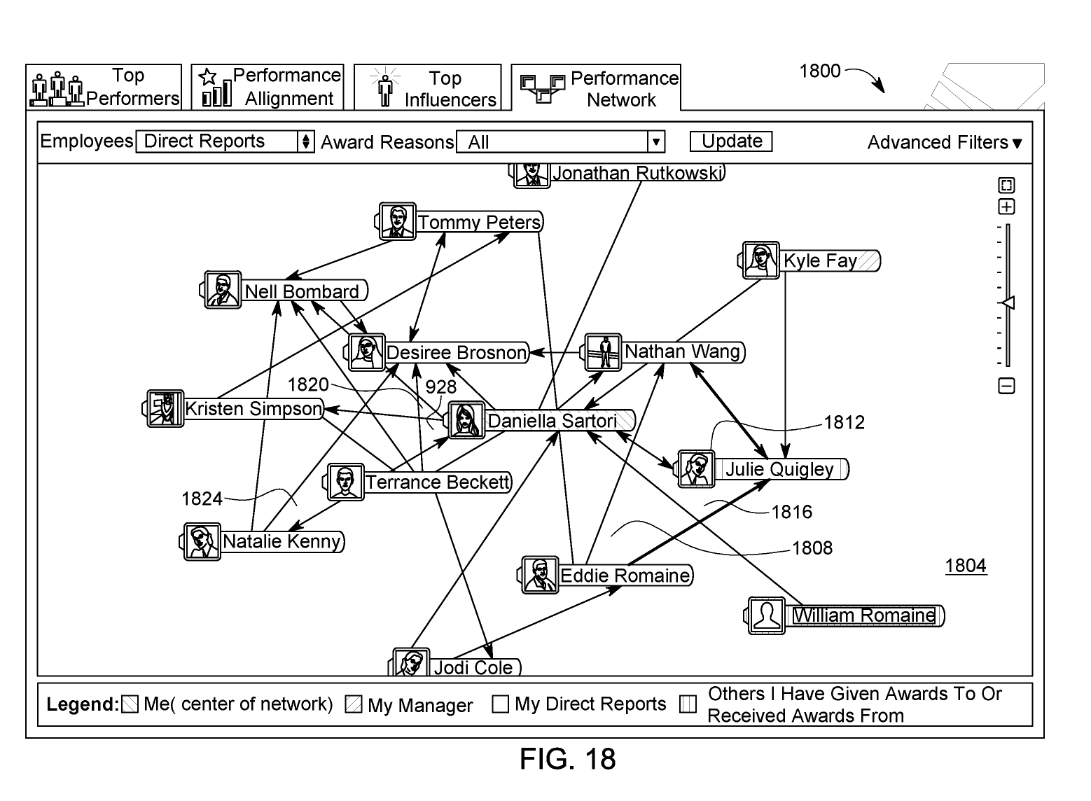

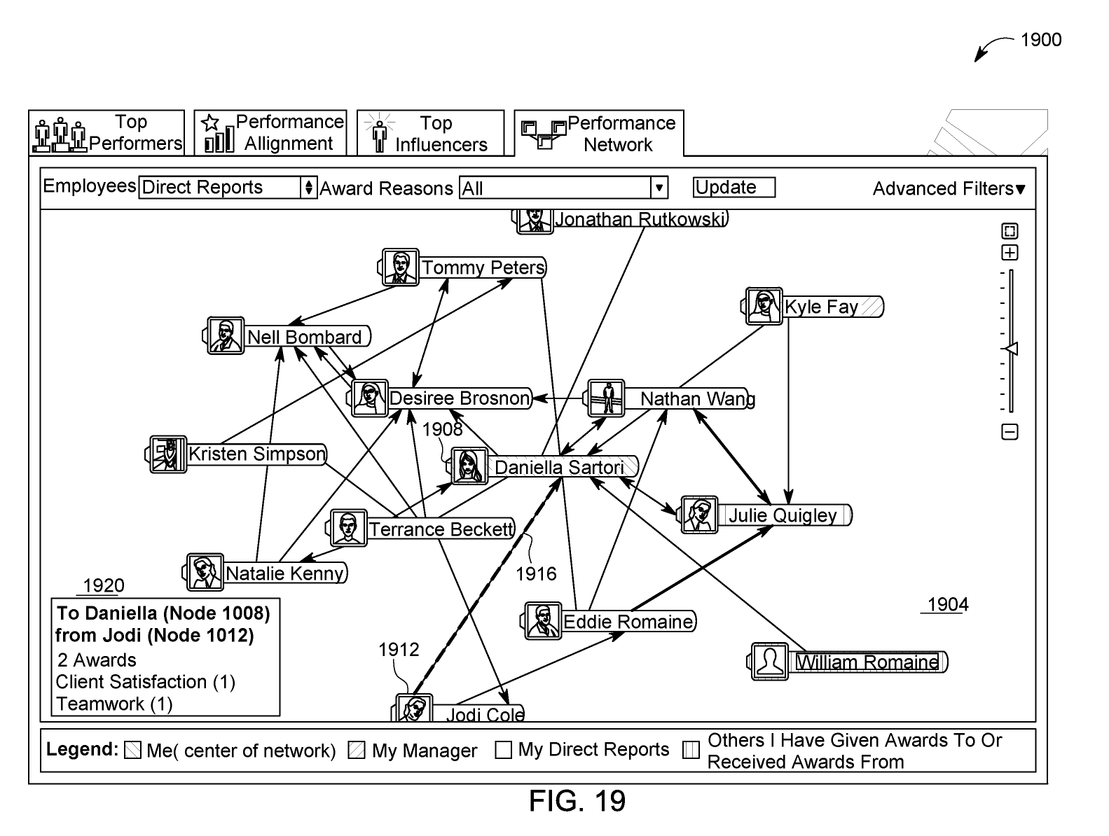

FIGS. 18 and 19 depict recognition network graphs in accordance with embodiments of the invention. These graphs are provided based on recognitions; the interactive system is capable of producing similar graphs based on feedback and check-ins. The recognition data associated with each moment and the organizational data may be collected, stored in the data storage system, and further be utilized to generate one or more network graphs, such as the network graph 1804 displayed as part of user interface 1800 shown in FIG. 18. The network graph 1804 is a directed graph that illustrates the connections within an organization, comprising of nodes and links. The network graph 1804 visually graphs the relationships between individuals and their colleagues; relationships between individuals and teams (formal or cross-functional ad-hoc teams); and relationships between teams. The nodes of the network graph 1804 may represent individuals, teams, divisions, departments, and any other entity capable of some level of interaction with another entity. The links, which may be depicted as graphical lines, edges, arcs, other graphical objects, represent the connections between the nodes, which may be connections, organizational connections, and combinations thereof. The directional component of the links may represent the node that originated a recognition or feedback moment, and the node that received the moment. In one embodiment, the directional component may also represent the reporting connection from one employee to his or her supervising employee, or vice versa.

The recognition graph module 560 generates the recognition network graph 1804 based on the recognition data comprising the recognition moments in combination with organizational data. The various nodes that comprise the recognition network graph 1804 are determined from the organization data and from the recognition moments. The links are then added based on the recognition data associated with the recognition moments and optionally according to organization data (org data). In one exemplary embodiment the links that are based only on organization data may be a different color or different form (e.g., solid versus dashed) than the links associated with recognition moments. Because the recognition moments may be created in real-time, the recognition network graphs may also be created in real-time. Organizational data stored by the data storage system includes relationships between employees (e.g., an employee's manager), relationship between one or more employees and one or more teams (organizational or ad-hoc), relationship between teams, employee relationships to various organizational hierarchies (e.g., hierarchy of departments or hierarchy of geographical locations), and other organizational data collected by the data collection module 510, such as those described herein.

Nodes on the recognition network graph may be determined based on the union of an participant's organizational attributes (e.g., his/her manager, participants for whom he/she is their manager, and/or other shared participant attributes such as organization department or geographic location), as well as those other participants with whom a participant has had a recognition moment of giving a recognition moment to or receiving a recognition moment from. The recognition graph module 560 may also generate the recognition network graph 1804 in FIG. 18 by leveraging interactive software and web-based software such as Flash and/or HTML. As illustrated in FIG. 19, connection details may be associated with each link between two nodes. The connection details may include the identity of the person who created the recognition moment, and the identity of the recipient of the award; the number of awards from the first node to the second node; the categories of reasons for the recognition moments; the number of recognition moments associated with each category, and other information.

The thickness of the links may increase or decrease based on a number of factors, alone or in combination, including: the number of recognition moments between two nodes, the number of different categories of recognition moments, and the quality of the recognition moments. Thus, node 1808 and node 1812 may be associated with one another with 5 recognition moments. The relationship may, therefore, be represented by thick link 1816. In contrast, node 1820 and node 1824 may only have one recognition moment associated between themselves, and so be represented by the thin link 1828. In addition, quality of a recognition moment may be based on a number of factors, including the relative importance of the category of a recognition moment to an organization. In at least one embodiment, along with the thickness of the links, the shape, pattern, color, or other display characteristics of each link may also be dependent on the recognition data.

These factors are understood to relate to the “strength” of the recognition connection between two nodes (i.e., members of an organization). In other exemplary embodiments, the thickness may be based on the correlation between the creator's recognition moments and formal employee performance scores of the recipient of the recognition moment (i.e., that employee's awards are a strong predictor of the employee's performance). By depicting the number of recognitions between each employee of a team or organization, managers and administrators may recognize important and influential employees of the organization, such as those who contribute the most to the company and those who are well regarded by his or her colleagues.

Link thickness may also be based on attributes relating to the award participants have received and given, such as the number of awards received or given; the reason for the award; significance of the award; reward status; organizational relationship; sphere of influence and connection strength of the person who gave the award; additional validation of the award in the form of congratulations from other employees; length and content of the award message; conformity to average award economic value, frequency, and reaction; variance to giver's norms; approval or disapproval of awards submitted; and value distribution of awards, and others.

Link thickness may also depend on the participant's team, manager and division, including the size of team and division; engagement level of the division or team; recognition participation of the manager; and reach and frequency of recognition within the team and division. In at least one embodiment, link thickness may relate to a participant's relationship to one or more teams and/or members in those teams, including the recognition or feedback the participant has received or given with respect to those members of that team or the team itself. For instance, if a participant has received feedback or recognition from a team, the link thickness between the participant and members of that team may be strengthened as a result.

In another embodiment, the thickness of the link may depend on objective data about the participant, such as the participant's division, level, gender, age, diversity, performance rating, employee history, grade and grade history, and functional group. Furthermore, link thickness may take into consideration the recognition activities of each employee, including the participant's participation in recognition programs; the number of connections through recognition, including strength, organizational relationship; ratio of recognition given to recognition received; recognition compared to peers; recognition given by manager and how that compares to organizationally close managers.

In one embodiment, the thickness of the links may be further increased by feedback received as a result of recognitions. In one embodiment of the invention, after a recognition moment has been delivered and/or announced, other system participants may show their appreciation for the participant's achievement or action by congratulating the participant. A participant may provide feedback with respect to the recognition moment through a number of available methods. For instance, a participant may press a “congratulations” button next to the recognition moment on one or more user interfaces, such as those described herein.

In one exemplary embodiment the recognition graph module may utilize “scores” associated with the recognition moments to determine the thickness of the links. Each award associated with a recognition moment may be converted to a score. For monetary and point award forms, the conversion of the award to a score may be a ratio conversion such as a 1-to-1 conversion, 1-to-2 conversion, 2-to-1 conversion, or variations thereof. For other recognition forms, a conversion table assigning score values to the award may be adjusted based on the varying degrees or levels of recognition. For example, a message thanking an employee for working hard may be worth 50 points, and then adjusted by a multiplier based on extent of the user's gratitude. In addition, the characteristics associated with the recognition moment described herein may also be used to further adjust the score associated with the recognition moment and may each have an associated value or weighing factor that may be used to adjust a score associated with the recognition moment. As one example, not meant to be limiting, one or more recognition data categories described herein may be utilized to calculate a score associated with a recognition moment with each having differing score weighting factors that may affect the recognition scores.

By way of non-limiting example, awards and congratulations and the recentness of receiving or giving those awards or congratulations may be considered. Thus, a single award from 5 years ago should not be given as much importance as an award from last week. Embodiments may collect the plethora of data from these recognition and feedback activities and from various other sources to provide users with insight into the employee's impact on the organization. Managers may then have access to various user interfaces that provide the real-time data and analytics results, providing managers with insight into how the employee is impacting the company at that very moment in time. For instance, in one embodiment, using the collected data, the system generates recognition and feedback network graphs that represent the recognition connections throughout the organization. The system further utilizes recognition and feedback network graphs to transmit announcements throughout the organization, which in turn promotes a positive organization climate and enhances the values of the organization.

Further, the scores associated with recognition moments may depreciate over time to reflect the risk of a weakening recognition connection between two individuals over time. In one embodiment, the scores may further be dependent upon the organizational relationship of the nominator to the recipient. Scores may also be dependent on the absolute level or status of the nominator. For instance, a score may be higher when the president of the company recognizes an employee or when a direct manager recognizes his or her direct subordinate. Various other methods of scoring based on the relationships of the nominator and recipients may be utilized as a means to promote corporate values and goals. Furthermore, scores may be dependent on the sphere of influence of the nominator and the conformity of the award to the norms. Thus, in one instance, a score may be higher because one particular recognition is for an achievement rarely achieved or for a recognition rarely recognized.

In another embodiment, the size, color or other display characteristics of the nodes representing each participant may be dependent on some or all of the factors described above with regard to link thickness as well as other factors or attributes described herein, such as the number of recognition moments the employee has received, the scores, recognition activities, the absolute level or status of the nominator, the sphere of influence of a nominator, and the conformity of the awards to the norms, and others. Through these features, managers may quickly and easily recognize influential or important participants in the system or employees of or the organization.

While the input data described above may be utilized to generate one or more recognition network graphs, including determining node links and nodes, such data, including any combination thereof, may also be utilized by any of the modules or engines described herein in operation and in order provide users (e.g., managers) with access to a wide range of data describing the employee's impact, performance and potential. For instance, such data may be utilized in one or more statistical analysis algorithms and predictive analytics techniques, such as neural network models and multiple linear regression, in order to assess talent and predict results and effects.

In one exemplary embodiment the recognition, recognition network graphs may be filtered to only show nodes connected to a user because of recognition moments associated with a particular recognition detail. For example, the recognition network graph may only show nodes connected to another node where there exists at least one recognition moment associated with Innovation as the award reasons (or in the body of the award message).

In one exemplary embodiment, each detail itself may be connected to other details as part of a tree structure. For example, as shown in FIG. 19, selecting a “Teamwork(2)” recognition category of the connection details may display the details of two “Teamwork” related recognition moments between “Daniella” and “Jodi.” The link 1916 between node 1912 (representing Jodi) and node 1908 (representing Daniella) may be highlighted for the user and connection detail 1920 may be displayed on user interface 1000 and/or as part of recognition map 1904.

In one embodiment, users interacting with the recognition network graph 1904 may select other nodes and re-center the depicted graph. For example, the recognition network graph 1904 in FIG. 19 is centered on Daniella (i.e., node 1908), but a user/viewer may re-center the graph on Jodi (i.e., node 1912), in which case, node 1912 would appear at the center of the graph instead of Daniella (node 1908). By centering the graph on node 1912, the system recalculates and displays the appropriate nodes and the links based on node 1912's organizational data and recognition moments.

In one embodiment of a recognition network graph, the nodes within the graphs are positioned in a manner similar to that of a traditional organization chart (“org chart”). Thus, nodes may be positioned in accordance with the organizational hierarchy within the organization wherein nodes representing higher level officers may be positioned near the top of the chart and may be connected to nodes representing the officers' direct reporting managers. The nodes of the managers may be positioned below the nodes of the officers. Further, nodes representing lower-level employees may be connected and be positioned below the managers' nodes. Thus, in certain embodiments of these org-oriented recognition network graphs, a recognition network graph may be depicted as to illustrate the organizational hierarchy of the organization in a top-down manner. In one preferred embodiment, at an initial step, the recognition graph module may generate the org-oriented recognition network graph to contain a graphical link for each organizational reporting connection (e.g., a link for each supervisory responsibility/report). By default, the graphical links may not contain any arrows or may be in a default color, pattern or shape to represent the organizational connections. Then, the recognition graph module may alter or regenerate the recognition network graph to contain the recognition moments between the employees of the organization. The graphical links representing these recognition moments may be of different colors, shape, or pattern, or may have arrows indicating the directions of the recognition nominations. As described with respect to other embodiments of recognition graphs, various filters, selectable view options, and navigation tools may allow a user to customize the scope of data being visualized within the graph. It should be appreciated that various other methods of depicting org relationships may be generated by the recognition graph module.

Thus, a user viewing the recognition network graph may not only determine the organizational relationship between the plurality of participants, but may also receive a visualization of the recognitions within the organization. Furthermore, embodiments of such network graphs allow for the immediate understanding of recognition moments with respect to the organizational structure. A user may quickly understand the sources of recognitions and those being nominated, such as whether enough recognitions are being provided from supervising employees to their reporting employees, whether certain managers have a good relationship with their direct report, whether employees of the same level are team players by recognizing others at their same levels, whether officers are recognizing their managers and so on. Therefore, a user may quickly gather whether various levels of employees or participants are effectively utilizing the recognition system and to take corrective actions accordingly.

A user may rotate, pan, zoom, and otherwise navigate the recognition network graph 1904 and select each node and links for more information. In one embodiment, the recognition network graph may contain a range of viewing levels, with the top level depicting a high-level view of the recognition map and with the lowest level depicting a low-level view of the recognition map, and with each level representing another level in the corporate hierarchy. For example, at the highest level, a single node may represent one single company. Links between such nodes may illustrate the recognition strength between companies. At the second level, nodes may represent branches of companies, with the level below that including nodes that represent teams within the company branches. As with the highest level, the links at the second and third level may represent recognitions between branches and recognition between teams, accordingly. Finally, the lowest level may include nodes that represent employees, as described above. In one embodiment, the recognition network graph may also show links of employees from numerous teams, and even those from other branches and companies as well.

The graph 1904 may also be filtered based on any number of definable attributes, such as based on time range, award level, award reasons, teams, divisions, types of awards, nominators and recipients, and others. Thus, as seen in FIG. 19, a user may only choose to view the recognitions of Danielle and other employees where the award was for “Good Teamwork” or for “Met a Substantial Deadline.”

In one exemplary embodiment, a user may identify another member of the organization for whom they want to identify a pathway based on recognition and organizational data. The recognition pathway is the path from the user to the identified individual over several nodes according to the recognition data and the organization data. Thus, the path represents the degrees of separation from one employee to another specified employee (or member of the organization) through other connected employees based on both organizational relationships and/or connections via recognition moments.

While the recognition network graph described here is disclosed to be made up of a plurality of nodes connected by links on a two dimensional graph, embodiments of the invention further includes recognition network graphs that are made up of different types of nodes, connectors, and/or other elements that are graphed on a graph two, three or more dimensions. Furthermore, nodes need not be connected by any graphical connectors at all. Additionally, the recognition network graph may be integrated with other graphs disclosed or mentioned herein.

The graphing module can further provide work circle graphs. Work circles may be broken down into three dimensions: recognition activity, feedback activity, organization activity, and user activity. A work circle may comprise a buildup of people who have given awards to each other. Thus, in one embodiment, a generated work circle graph depicts all of the activities associated between the employees of the organization, with each employee being represented by a node. Each node of the graph is connected to other nodes based on activities associated with the two corresponding employee. The graph allows a user to select a particular employee on the graph and view the user's work circle, i.e., the connections the employee has with other employees or teams in the organization.

The following example describes embodiments that support the generation of work circles using at least recognition data. Other embodiments of the invention further support the generation of work circles using a combination of recognition and feedback data or feedback data alone.

By way of non-limiting example, employees in a recognition activity work circle may include individuals who have given an employee an award, individuals who an employee has given an award to, individuals who have congratulated an employee, individuals who an employee has congratulated, and those employees who have shared a team award. A work circle may be expanded by professional relationships. By way of non-limiting example, employees in an organizational work circle may include an employee's manager(s), an employee's peer(s), an employee's direct report(s), an employee's manager's manager(s), an employee's manager's peer(s), an employee's peers' direct report(s), an employee's indirect report(s), an employee's peer's direct report(s). Lastly, a work circle may include any person(s) that an employee chooses (i.e. user activity).

In embodiments of the invention, a user's work circles may be influenced by the type and frequency of activity, connection weight (also referred to as connection strength), as well as proximity of the user with other users (i.e., direct versus indirect connections), and all of the other attributes and data described in this disclosure. Awards and congratulations and the recentness of receiving or giving those awards or congratulations may be considered.

A user's feed, recognition graph, digest and other information presented may be influenced by the data associated with the work circle, including each employee's work circle. For instance, the order and composition of a user's feed and digest may be based on events, recognition, congratulations, etc. of the employees that are closest to the user in his or her work circle. Furthermore, when a user celebrates a work anniversary, the users that are invited to the user's celebration or is notified or the user's work anniversary may be based the structure of the user's work circles. As the user celebrates his or her 5 or 10 year anniversary, more coworkers in the user's work circles may be notified and/or invited to the user's work anniversary celebration. Thus, as the number of years of the anniversary increases, the number of people being notified and/or invited may expand to cover more indirect connections.

The recognition and feedback network graph and other analytical displays aid managers in determining employees who are critical to the prior and future success of their business initiatives even when those employees are not within their traditional organizational hierarchies or span of control. The recognition and feedback network graph may highlight connections between employees that are not self-evident within traditional organization charts nor found in other talent management systems. The recognition and feedback network graph may also depict how business objectives have been achieved via both formal and informal employee connections.

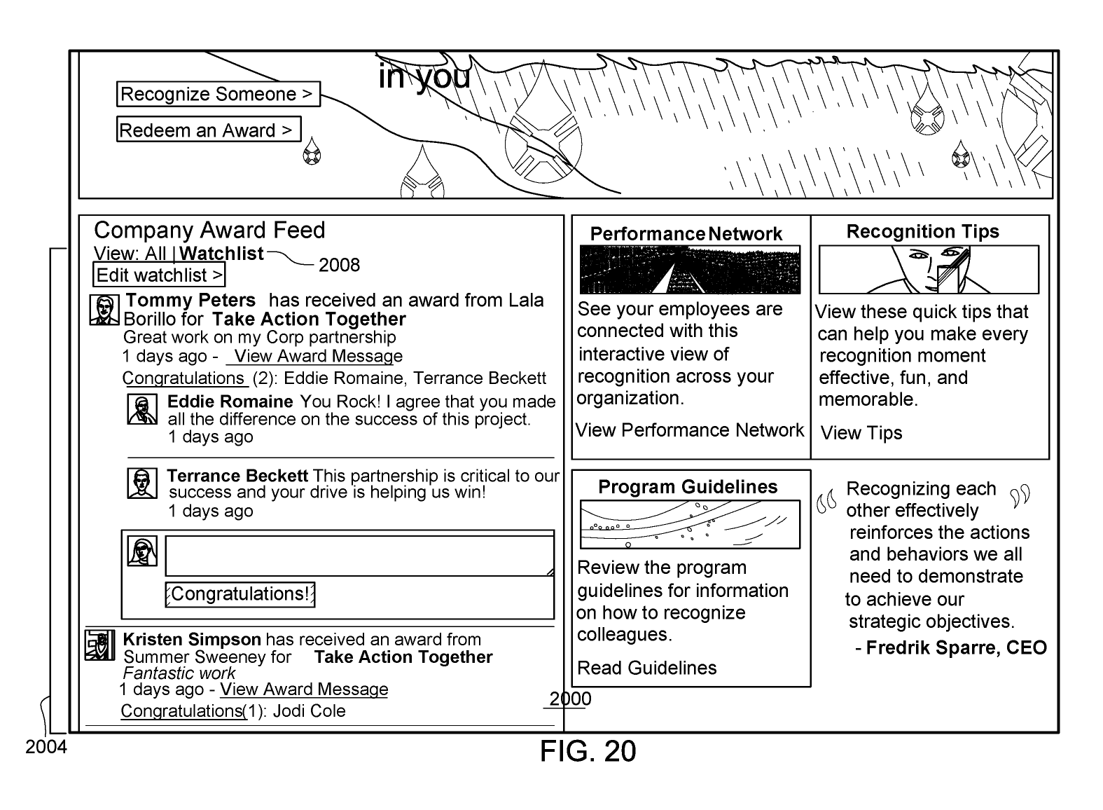

FIG. 20 illustrates a user interface containing an award and recognition feed in accordance with an embodiment of the invention. In one embodiment, a participant may also (or in the alternative) provide a comment in response to the recognition moment. For instance, FIG. 20 depicts a user interface wherein, in response to recognition on a participant's award feed, the participant may send a message to the recognition recipient with a congratulatory message. Thus, in a particular embodiment, the more congratulatory messages received, the thickness of the links between the recipient and the person congratulating (e.g., Terrance of FIG. 20) may be increased (or created). In one embodiment, the thickness of the link between the award nominator and the recipient (e.g., Tommy and Lala of FIG. 20) may also be thickened as a result of these congratulatory messages.

Thus, in addition to the e-mail delivery illustrated in FIG. 17, the delivery module may deliver a recognition or notice over a recognition and feedback feed, such as the feed illustrated in FIG. 20. In one exemplary embodiment, the feed is a recognition feed managed as part of a web or intranet site associated with employee recognition. In another embodiment, the recognition feed may be managed by one or more computer systems and/or server systems including server systems, computers, mobile phones, tablets, other mobile devices, and other types of systems well known in the art. By providing the feed within an intranet, sensitive corporate information may be protected and detailed recognition information may be provided to the employees of the company. In certain instances, privacy options may also be enabled to hide parts or all details of a recognition instance. Thus, embodiments of the invention may further create a culture of appreciation by delivering a continuous stream of the latest recognition and feedback activity at a company, allowing employees to see real, concrete examples of behavior that embody company corporate values, for example. While the displayed feed is a recognition feed, feedback and check-in feeds may also be provided. Alternatively, the feeds can be combined in any logical manner.

The recognition feed 2004 may be syndicated via technologies as RSS and Activity Streams to be displayed on web or corporate intranet portals, corporate social media technologies associated with employee information beyond recognition (e.g., an employee internal portal), and/or general social media pages (such as social media pages managed by Facebook®), Twitter®, mobile readers, and combinations thereof). The recognition feed 2004 may include the name of the recipient of a recognition moment, comments and congratulations, and a comment box for submitting comments and congratulations. Congratulations from an employee on another employee's recognition awards create an additional recognition moment between those two employees which is leveraged to create the nodes on the recognition network graph. Optionally, the recognition feed 20004 may provide various recognition details including the name of the creator of the recognition moment, the reason/recognition category, a reference to a client or account, and combinations thereof. Those of ordinary skill in the art will recognize that other details could be added than those expressly identified above. In at least one embodiment, the recognition feed may further integrate data and features from available talent management software and systems.

The recognition feed 2004 may receive notices of recognition moments from all members of an organization or a subset of the members of the organization identified in a watch list 2008. In one exemplary embodiment, the recognition feed 2004 is implemented as a publish/subscribe messaging system. In one exemplary embodiment, a user may filter the recognition feed 2004 by adding and removing people to and from the watch list. The recognition feed 2004 is interactive, and may be reacted to with comments or gestures as described herein.

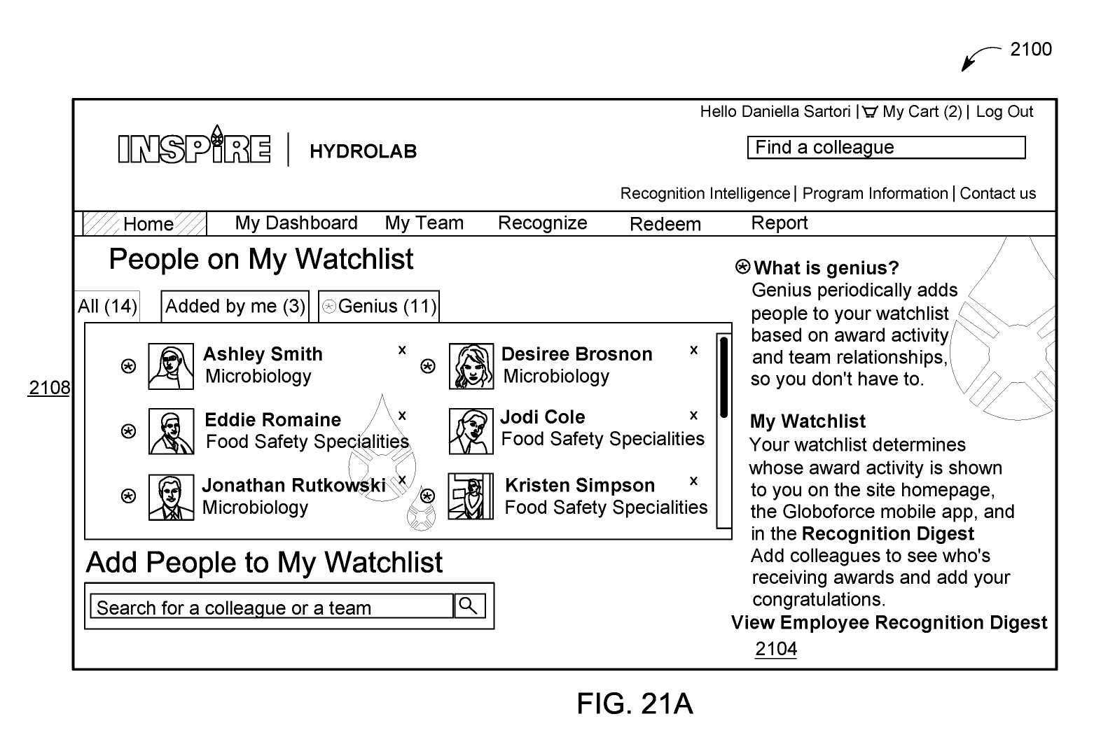

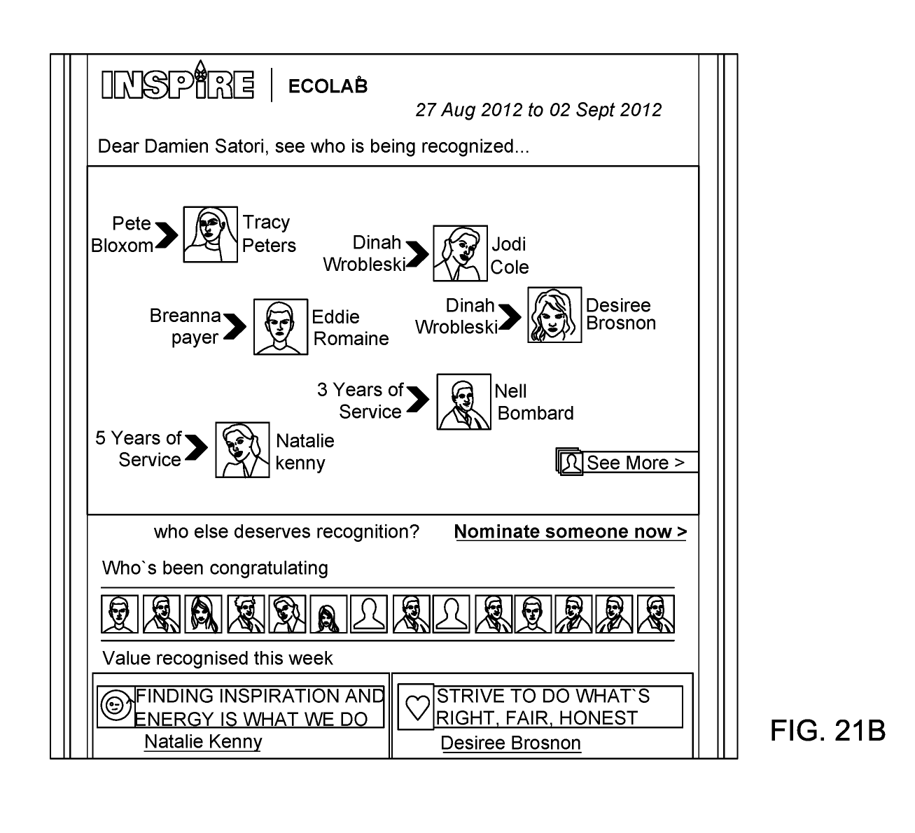

In another exemplary embodiment, feeds may be automatically generated according to the watch list 2008 by an algorithm, such as the genius algorithm 2104 shown in FIG. 21A. The genius algorithm 2104 may add people to the watch list 2008 based on direct and/or indirect reporting relationships or shared management levels and other shared organizational data between employees, recognition moments (and the recognition data that comprises those moments), congratulations, and combinations thereof. The genius algorithm 1204 may update the members listed in each user watch list daily, weekly, monthly, or on command, and may be updated based on the new award activity and organizational relationships. For example, one genius watch list may include a manager's direct reports on his or her watch list 2008. The watch list 2008 may further contain coworkers who share the same manager as well as anyone to whom the manager has ever given awards. Thus, the genius algorithm 2104 may automatically manage the watch list 2008 in accordance with any number of organizational data. In one embodiment, the genius algorithm 2104 may automatically manage the watch list 2008 to include each of the employee's organizational relationships and/or based on the structure of the organization.

In embodiments of the invention, one or more engines of the invention may generate a recognition feed that provides important events for people who are most relevant to a particular employee based on collected and generated data described herein. An employee without any awards or congratulations may be provided with a recognition feed generated based on organizational activity work circles and organizational structure, as described herein. By way of non-limiting example, the recognition feed may provide recognition activities of employees identified by a relationship of 1 watch list expansion, employees identified by a relationship of 2 watch list expansion, a user identified by a relationship of 4 watch list expansion, a user identified by a relationship of 5 watch list expansions, a user identified by a relationship of 6 watch list expansions, a user identified by a relationship of 7 watch list expansions, a user identified by a relationship of 9 watch list expansions, a user identified by a relationship of 12 watch list expansions, and a user identified by a relationship of 13 watch list expansions. As an employee accrues recognition activity, the recognition feed may include information based on the recognition and organizational activity. Distant organizational relationships may become less prominent in the digest. Furthermore, the type and frequency of activity may be considered. Thus, based on the number of awards, the types of awards, the types and number of congratulations, and other data described herein, a recognition activity (or other activity) may be displayed higher on the digest email.

The order of the watch list 2008 may also be based on connection scores (referred herein generally as “scores), which measures the strength of the connection between users. Thus, the order of activities presented in the recognition feed may be based on the strength of the connection between the viewing user or user receiving the email and the users associated with the award item, including the recipient, nominator, congratulations and other data described herein. As one example, a connection between Eddie and Noel would be based on a score which combines: organizational closeness (they are peers); whether either of them have explicitly selected the other to their ‘watch list’; recognition activity (awards given and received, mutually received team awards; congratulations given and received); and department and location.

The recognition feed may depict an exemplary video recognition for the recognition feed 2004. The video for the video recognition may be taken by anyone in an employees work circle, as described herein. A person of ordinary skill in the art would recognize that there are very few, if any, limitations on the format and content of a video for video recognition of an employee. The video for the video recognition may be taken with or without family members, inside or outside the place of business, and of any length. The video recognition modules may be incorporated in the genius algorithm between the recognition moments in the watch list described herein.

FIGS. 21A and 21B illustrate a user interface containing a user watch list 2108 and an employee recognition digest 2110 in accordance with embodiments of the invention. When utilizing recognition moments to add people to the watch list 2108, the genius algorithm 2104 may rely on recognition graphs, such as the recognition graph 1904. In particular, the genius algorithm 2104 may add those people for whom a user has created recognition moments for, and those people who created recognition moments for the user. In one exemplary embodiment, the genius algorithm 2104 may consider the strength of the connection between two users (e.g., as illustrated by the thickness of the link connecting two nodes in the social network) when determining whether to add someone to a watch list. Thus, in FIG. 21A, the application of the genius algorithm 2104 results in the addition of Ashley Smith, Eddie Romaine and others to the watch list 2108. In one embodiment, the genius algorithm 1204 suggests to the user people that should be on the user's watch list.

The genius algorithm 2104 may also utilize data available at internal and external computer systems related to the user. In one embodiment, the employee recognition system may connect to email or other messaging systems to determine with whom the user communicates the most and the least, in order to form the recognition watch list 2108 accordingly. Similarly, the genius algorithm 2104 may access one or more org charts or floor plans to filter the user's watch list 2108 to others on the user's team or who sits near the user. The genius algorithm 2104 may cause the access and downloading of information from internal or external social networks to detect coworkers who are also friends or associated with the user's social network accounts. Further, the genius algorithm 2104 may detect similar interests or attributes between coworkers and the user via one or more social networks. Those of ordinary skill in the art will recognize that the genius algorithm 2104 may utilize additional factors in determining whether to add someone to the genius watch list. Data from any number of internal or external systems may be collected and utilized by the genius algorithm and other features of the invention to provide managers and users with insight into recognition data.

In one exemplary embodiment, adding and removing feeds is accomplished by filtering out unselected or unwanted feeds. In addition to (or in lieu of) sending the recognition feed 2004 via RSS, the recognition delivery module may send the recognition feed (or a snapshot thereof) via an e-mail as depicted in 21B. Users may directly congratulate colleagues from such emails.

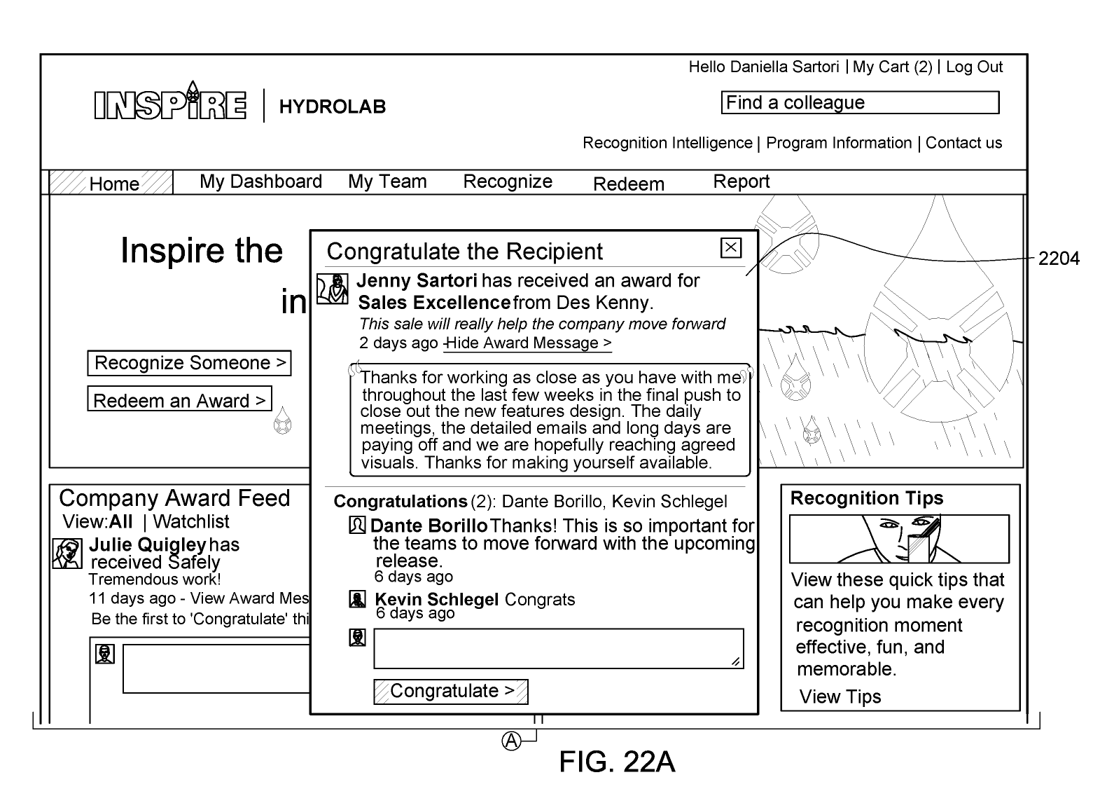

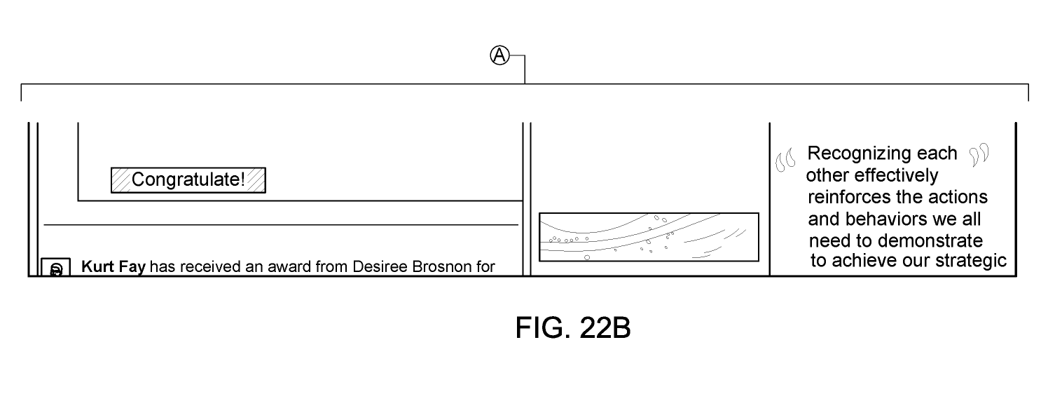

FIG. 22 depicts a user interface for delivering a recognition and feedback announcements in accordance with an embodiment of the invention. In this instance, the recognition delivery module 530 may deliver the recognition announcement via a dialog box 2204, prompting a user to send congratulations.

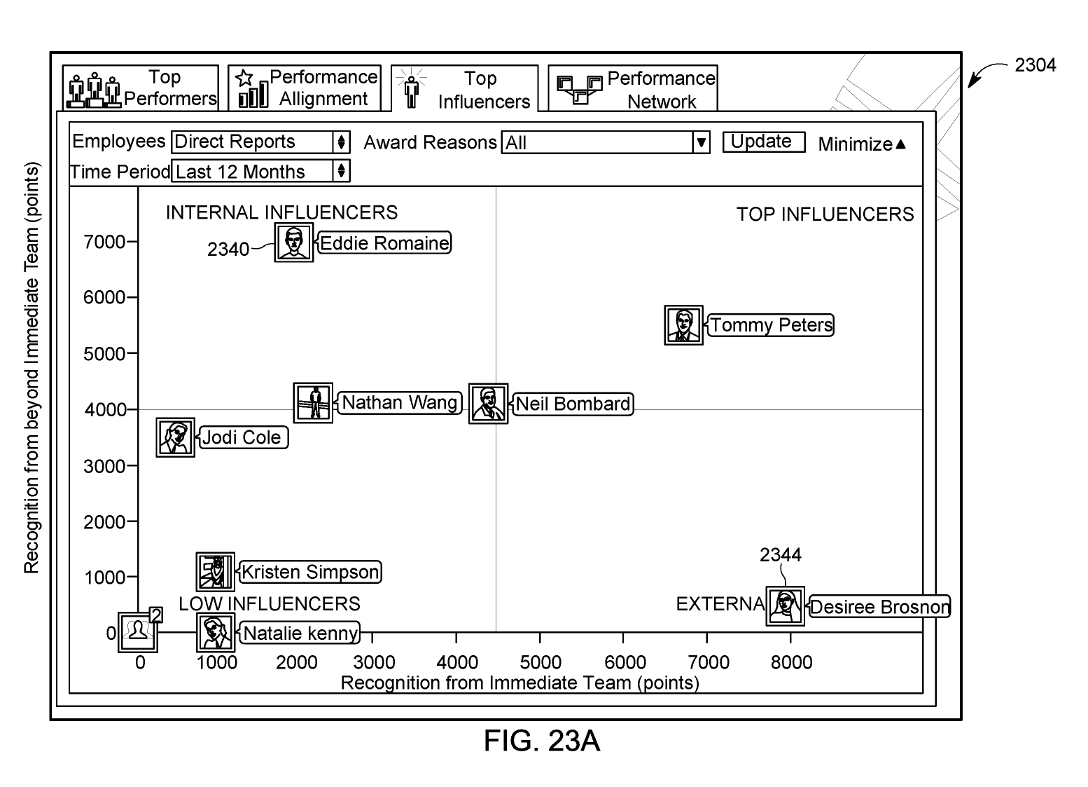

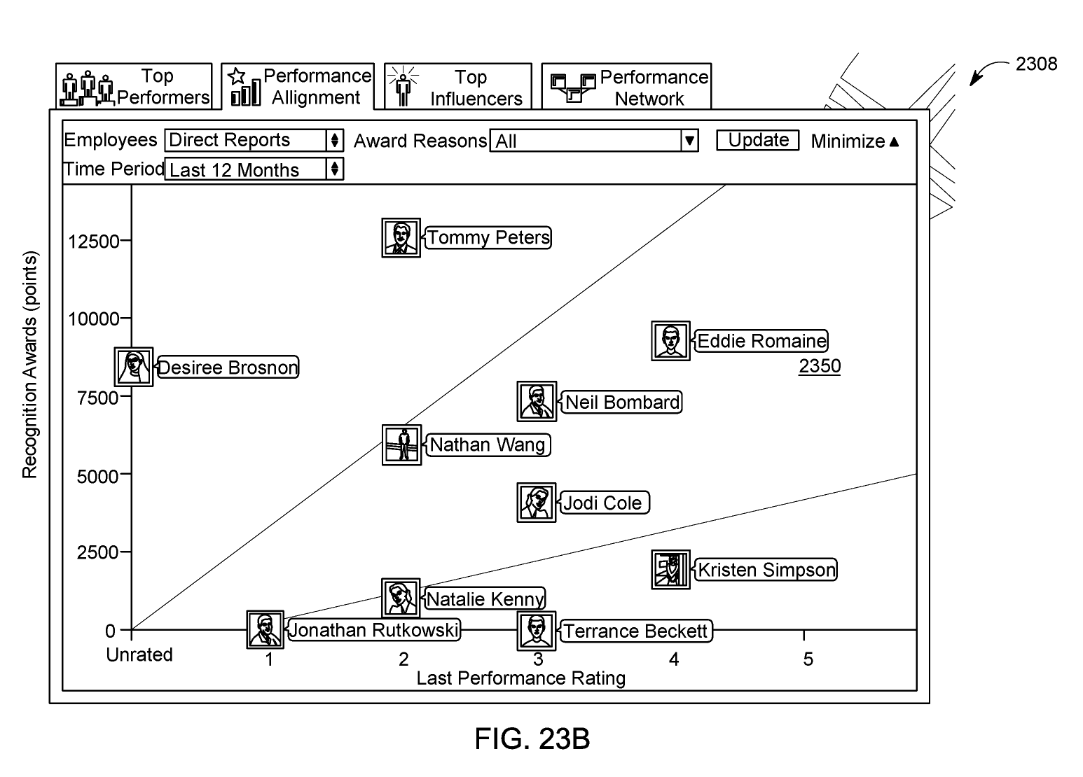

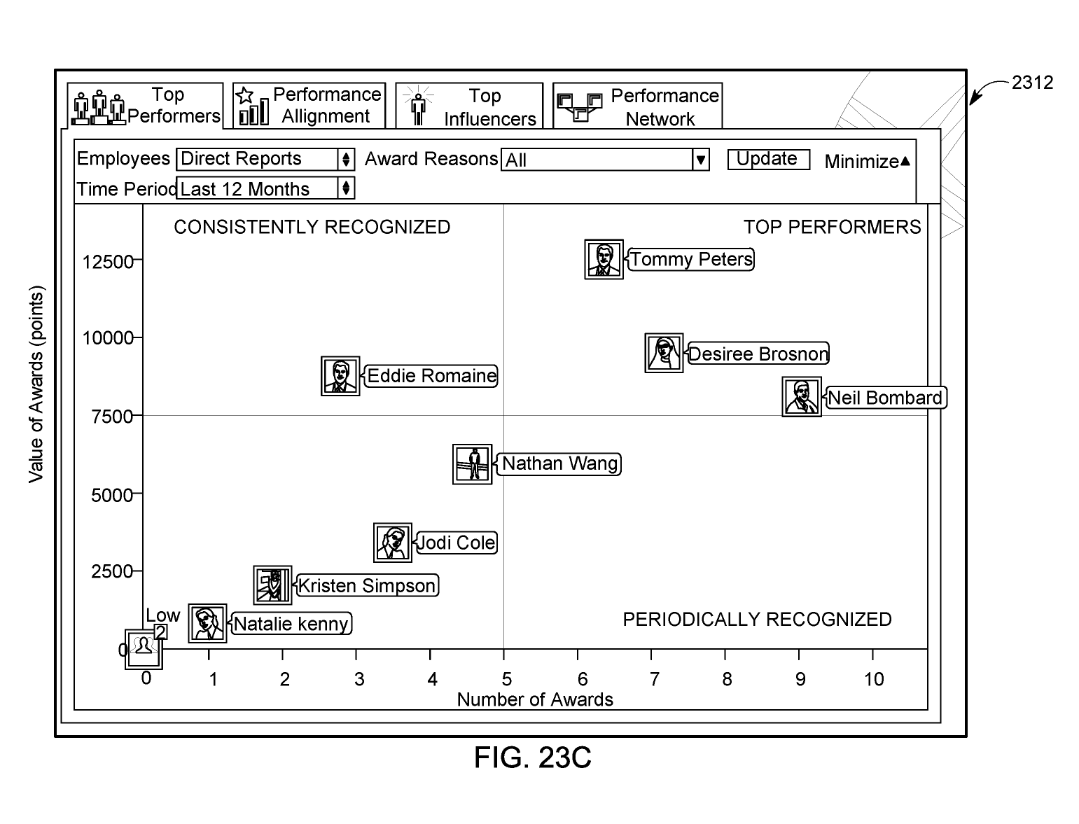

FIGS. 23A, 23B and 23C depict additional recognition and awards graphs in accordance with embodiments of the invention. The graph module 560 may generate an influence graph 2304 of FIG. 23A, a depiction of the relative “influence” of individuals of organization, based on the recognition and feedback they receive within and without their “group.” Each individual's network graph, which includes an aggregation of the details associated with recognition and feedback moments provided to that user, may be used as a proxy to determine the individual's relative influence. The influence graph 2304 may be generated based on two or more recognition or feedback details including, the amount of moments, the source of the recognition or feedback, the performance rating associated with the recognition or feedback, last performance rating and other recognition or feedback data that may be collected by the data collection module 510. The sources of the recognition or feedback (i.e., the creators of the recognition or feedback moments) may be in two groups: internal to the individual's group (e.g., department), or external to the individual's group. The influence graph may further depict influence of individuals in one or more teams, or influence of teams in the organizations.

In one embodiment, an individual's location (i.e., coordinates) within the influence graph 2304 may be determined according to the number of moments from each source. For example, Eddie (node 2340) may have received more recognition or feedback moments from those external to the group than Desiree (node 2344); but Desiree may have received more recognition moments from those within the group. The performance rating may be color coded, thereby allowing a user of the influence graph to perform a relative comparison between influence and performance quality. Employee attributes, other than performance ratings, may be selected for color coding, for example, flight risk, departure impact, potential and high performance. In at least one embodiment of the invention, recognitions or feedback may also be received external to that of the company including by clients, by employees of partner companies, and others. In such embodiments, employee external recognition as depicted in influence/performance graph 2304 may include recognitions received from such external sources as well.

The graph module 560 may also generate a performance alignment graph 2308, as depicted in FIG. 23B, that provides to managers information of how employee performance ratings align with recognitions or feedback received by each employee. Thus, a performance alignment graph, in one axis, may graph the performance rating of the employee, as determined from his or her performance reviews (e.g., last bi-annual or annual performance review). Each employee performance rating may be determined according to a predetermined and/or normalized performance review rating. Where there are employees across countries or teams, data may also be normalized accordingly so as to improve the quality of comparisons. In addition, the performance alignment graph may include a second axis that graphs employee quality of recognitions. Accordingly, the performance alignment graph may illustrate employees with the greatest alignment between their performance rating and the recognition or feedback received via the interactive system. As illustrated in FIG. 23B, nodes that appear in an area 2350, appearing from the bottom left corner to the top right corner of the graph, may be considered to be aligned. That is, employees that are within this area 2350 contain performance ratings that are aligned with the recognition or feedback received from the system. Employees outside of the area 2350, thus, may have gotten a better performance rating relative to his or her recognitions, and vice versa. Managers, for example may analyze such misaligned employee performance reviews, feedback, recognitions to further improve performance reviews, recognitions, feedback, and/or other aspects of the company. In at least one embodiment, the performance alignment graph depicts the performance rating of one or more members of a team or a whole team. The performance alignment graph may illustrate teams the greatest alignment between their performance rating and the recognition or feedback received via the interactive.

In one embodiment, the graph module 560 may generate one or more performance graphs that depict the top performers of a manager's team, set of teams, or of the company. A performance graph may also depict the top teams at the company. The performance graphs may provide to managers details of the employee performance within the organization. For instance, the graphs may display the performance with respect to each employee. As another example, shown in FIG. 23C, a generated performance graph 2312 may contain two axes: one axis reflecting the number of recognition and feedback awards each employee has received and another axis representing the total award value of the recognitions (e.g., total number of points received) that each employee has received. Thus, managers may easily recognize top employees who have received the greatest total recognition and feedback values (e.g., as measured by economic value) as well as the total number of recognitions, and conversely, those who are performing poorly by receiving few awards and/or minimal quality of recognitions or feedback. At the same time, the performance graph may allow managers to quickly and easily recognize employees who may receive a lot of recognition and awards but not many quality recognitions/feedback, and vice versa. This may allow the manager to figure out issues that the employee or team may be having with the employee and/or identify other issues.

The recognition graph module may utilize the recognition data collected and/or network graphs to generate various other graphs, including graphs that describe top performers, top influences, performance alignment, and other relevant information. In an embodiment of the invention, the graph module generates a geographical view, wherein recognition and feedback for an employee is displayed at the location of receipt. This recognition and feedback may be displayed in real time, or at a time of the employee or employer's choosing. Furthermore, the recognition and feedback may be displayed geographically for any period of time.

It should be understood that the graphs generated by the graphing module might contain different sets of data (e.g., different categorization of what is considered internal or external) or additional categories of data (e.g., a category for internal to team, external to team, and external to the company). A manager or administrator may define the axis of a graph to be generated along with the nodes that are included within the graphs (e.g., the employees shown on the influence graph, award reasons, etc.). Indeed, more than two categories of data may be utilized to generate multi-dimensional graphs. For example, three categories of data may be utilized to generate a three-dimensional influence graph. The user may rotate, pan, zoom, and otherwise navigate the graphs and select each employee for more information. Furthermore, the nodes and other components of the graph may correspond to the employee and recognition/feedback data. For example, just as with the nodes of the network graph, the shape, size and color of the nodes in these graphs may also correspond to employee and recognition/feedback data. In addition, just as with the network graphs generated by the graph module, the shape, size, pattern or other visual parameters of the components of these graphs may be customized and/or changed in accordance with various recognition, feedback and/or organizational data.

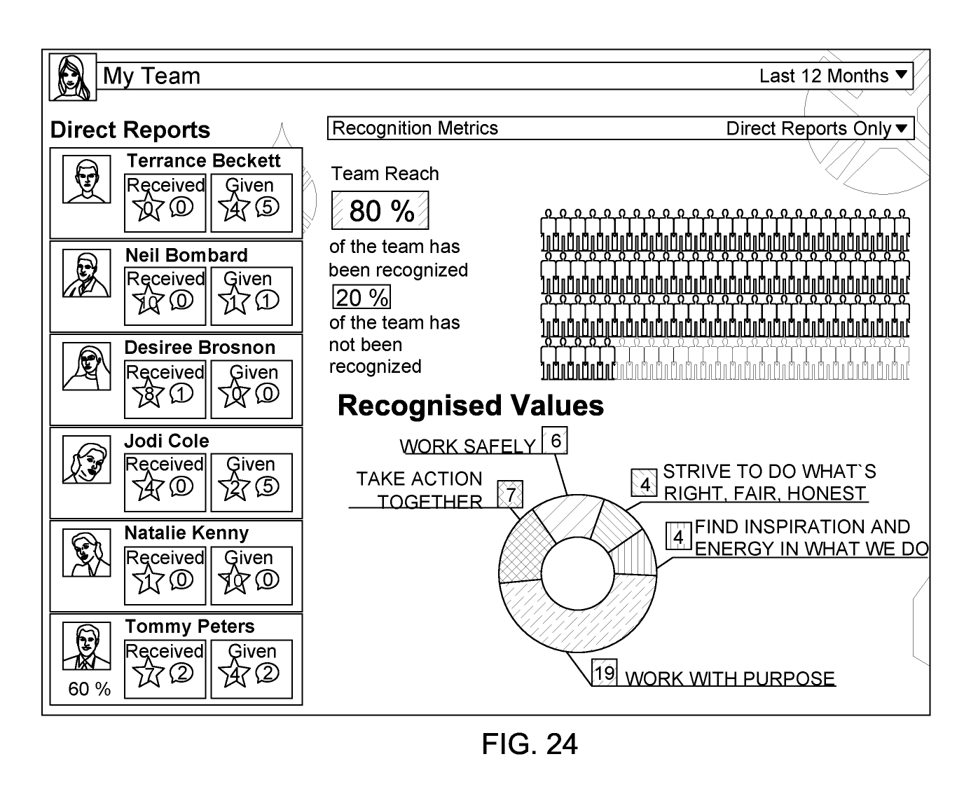

FIG. 24 depicts a user interface for providing users with data of employee recognition and feedback metrics using infographics and other tools in accordance with an embodiment of the invention. In one preferred embodiment of the invention, the talent analysis module further causes the generation of one or more monthly, quarterly, or annual reports that visually identify top performance, assess the adoption of corporate values, track critical cross-department interaction to determine collaboration effectiveness, identify trends, examine reach within key talent groups such as those employees with high potentials, flight risks, succession candidates, and other information. Such reports may be delivered to managers, executives, shareholders and others and enable recipients to recognize valuable employees and teams while identifying shortcomings and other aspects of the company. Just as with information available to team managers describe above, data may be depicted in easy to understand color infographics and/or other forms of multimedia, such as that depicted in FIG. 24.

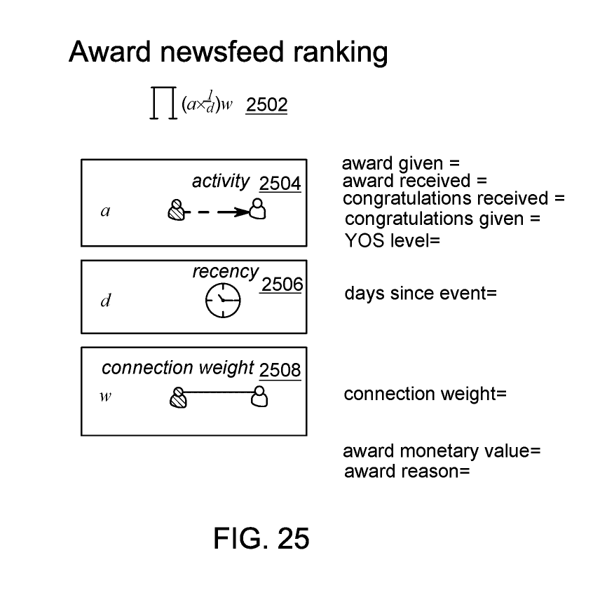

FIG. 25 provides an exemplary schematic and equation for ranking an award or recognition for positioning in a newsfeed, such as that shown in FIG. 20, in accordance with an embodiment of the invention. Award ranking in the newsfeed may be based on the equation Π (a*1/d)*w. The equation relates the concepts of activity 2504, recency 2506, and connection weight 2508, where the variable “a” may be a numerical digit that represents the value of award given, award received, congratulations received, congratulations given, and/or years of service level for a particular participant; the variable “d” may be a numerical value for days since the activity, “a” occurred; and the variable “w” is a numerical value for connection weight, the monetary value awarded, and/or the award reason. Thus, through the use of this algorithm, the system ensures that participants receive the most relevant and impactful information in their newsfeeds.

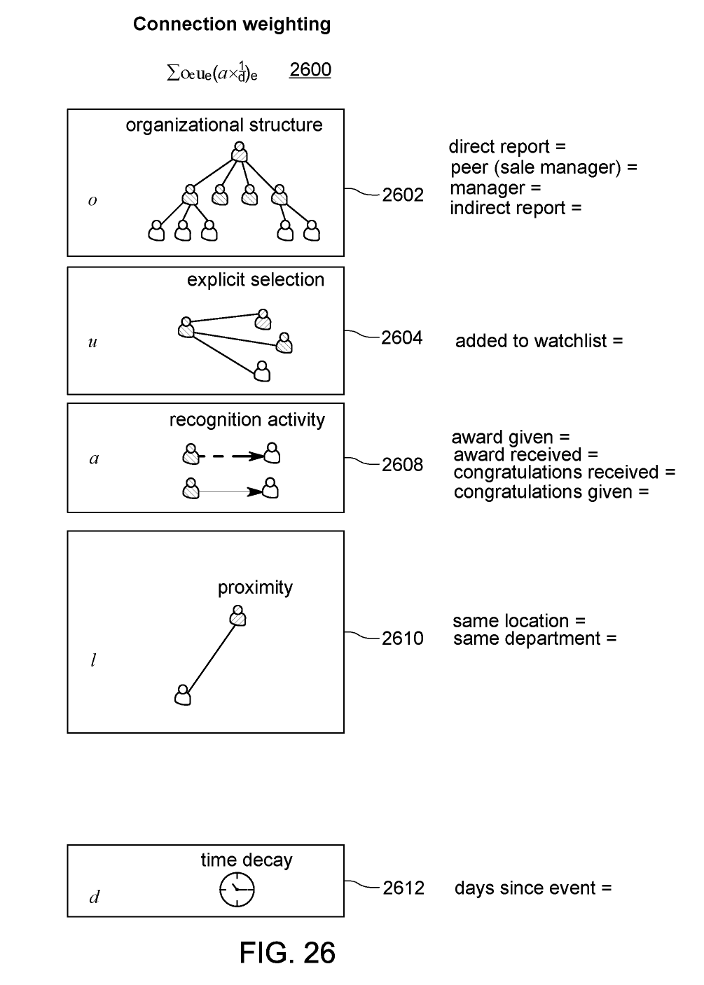

FIG. 26 provides an exemplary schematic and equation for calculating the connection weight in accordance with an embodiment of the invention. The connection weight may be based on the equation Σ oₑ*uₑ (a*1/d)ₑ, where the variable “o” represents organizational structure and may be calculated by direct reports, peers (that have the same manager), managers, or indirect reports at the time of the event “e”; the variable “u” represents the explicit selection and may be calculated by the time at which the event was added to the watch list; the variable “a” may be a numerical digit for awards given, award received, congratulations received, congratulations given, or years of service level for a particular participant; and the variable “d” may be a numerical digit for days since the activity, “a,” occurred. Connection weight may be based on a number of other factors, including the relative distance from the user to employee's manager(s), an employee's peer(s), an employee's direct report(s), an employee's manager's manager(s), an employee's manager's peer(s), an employee's peers' direct report(s), an employee's indirect report(s), an employee's peer's direct report(s). Lastly, a work circle may include any person(s) that an employee chooses (i.e. user activity). The calculation of the weight, as described herein, may be utilized by the other modules disclosed herein, including in generating the recognition moments, generating the recognition, influence, performance alignment, and performance graphs, performing talent analysis, generating the work circles, generating alumni connections, and generating actionable insights.

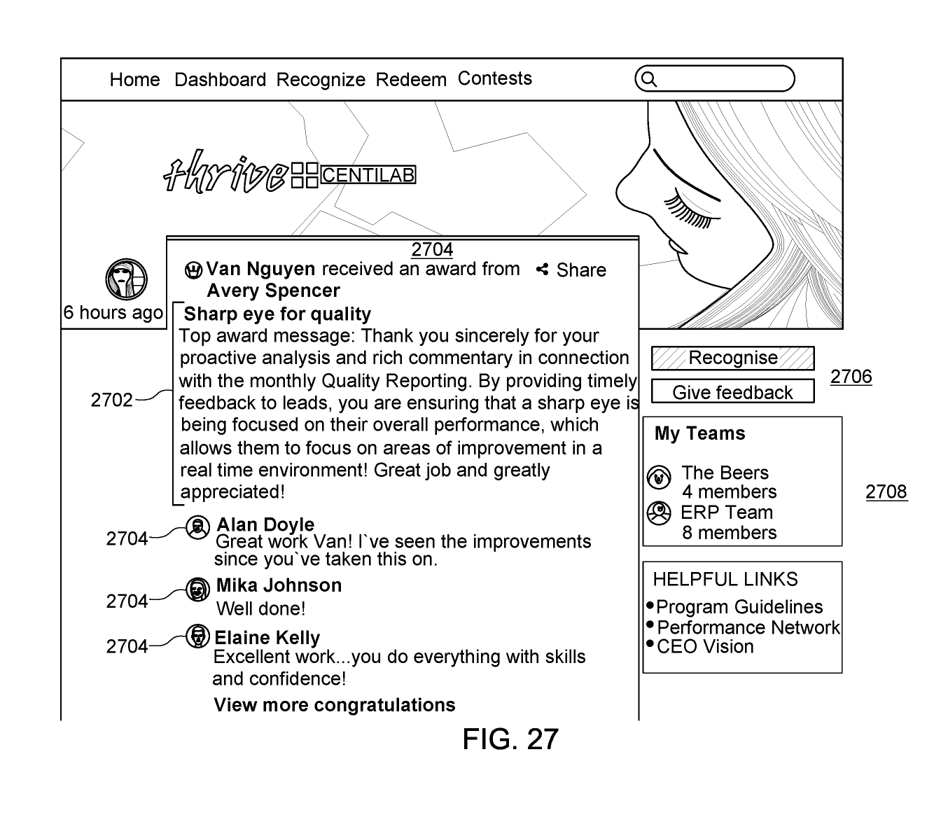

FIG. 27 is an exemplary interface for a recognition and feedback interface in accordance with an embodiment of the invention. In embodiments of the invention, a user (for example an employer) may utilize the recognition feature of the interactive system to generate an award 2700 including an award message 2702. Additional team members or other participants who are connected with Van are able to see the award and make comments on the award.

The skilled artisan would be aware of various methods by which the system software/website may be accessed, and that system also allows a unified approach including social feedback, recognition and support for check-ins, or feedback given. The feedback system may fully supports practices such as coaching, feedback, development, and evolving performance management with crowd sourced recognition which is emphasized and focused by the manager's voice. Exemplary information, such as the person and/or team awarded, monetary value, company value, etc. may be displayed on the conversation regarding the feedback. For example, Avery Spencer received an award 2700, as displayed in the conversation box 2702, by Van Nguyen for “Sharp eye for quality.” Video feedback, images, stickers, tags, or files may also be uploaded in the conversation box 2702.

Embodiments of the invention are particularly useful to acclimate a new hire into the culture of the company by utilizing software that connects colleagues. Colleagues are able to view photos of each other, see each other's activity and view company values through the interactive system. As illustrated, participants receiving the recognition are able to post comments at 2704. The interface allows selection of feedback input or recognition input at 2706 and further allows team selection at 2708.

As described herein, recognition or feedback for a user may be displayed publicly within the company wherein colleagues and others may be able to comment or otherwise interact with a recognition or award given to an employee or team on for example, the wall as described herein. The interactive system includes many opportunities for participant interaction and may further promote interaction in the form of digital gestures (i.e. figuratively “liking” the recognition). In embodiments of the invention, recognition may also be publicly displayed outside of the organization. For example, the recognition or feedback may be integrated with a social media platform. Recognition may also be in the alternate, whereby the third-party application recognition moments may be pulled and integrated with the company recognition system. In embodiments of the invention, the company's Human Resources department can utilize an engagement dashboard to see how teams they support are doing, the reasons employees are being recognized, and determine other metrics as associated with the recognition system.

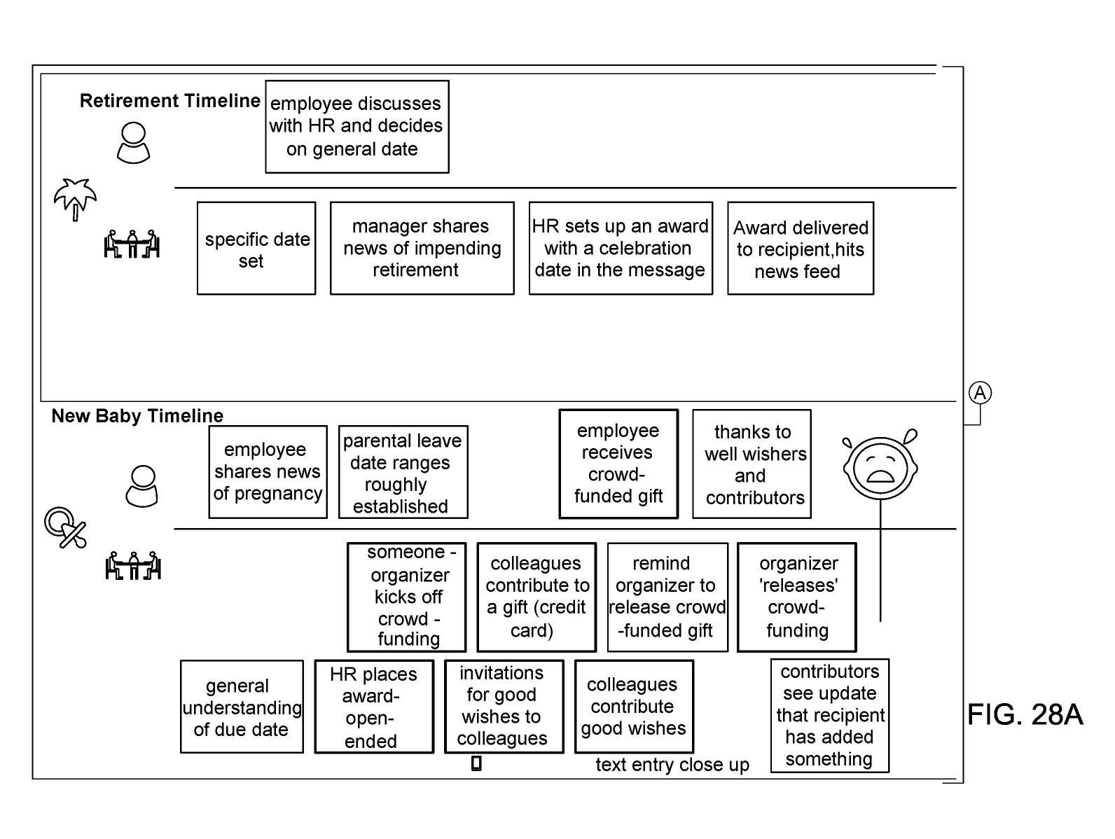

FIG. 28 is an exemplary schematic for recognition of a life event in accordance with an embodiment of the invention. In embodiments of the invention, the company acknowledges non-work aspects of its employees' lives. FIG. 28 illustrates a retirement timeline 2800 and a new baby timeline 2810. Life events are uploaded into a life event system or may be integrated into the recognition engine, and can include, for example, a new baby, marriage, retirement, promotion, new house, birthday, marathon, graduation, etc. Skilled artisans would recognize the various life events that may be uploaded into the life event system. An employee may share his/her life event, or a colleague may share an employee's life event. Awards for certain life events may be crowdfunded as described herein. Employees and/or colleagues may continually update the life event, and alternatively alter the privacy of the life event. Notifications, as described herein, for all congratulations and updates are sent to the recipient or the congratulator, respectively. In one embodiment, the graph module 560 may generate a performance graph that displays a year in review. This interactive map displays data over time, and can identify, for example, the name, location, reason for award, participants, messages, awards, photos, video messages, thanks, timelines, life events, and insights. Insights could include the number of awards received, number of congratulations received, reasons for favorable feedback, people that have joined a program in a year, the number of life events for an individual or team, etc. Skilled artisans would recognize the many metrics that may be captured and displayed via the map.

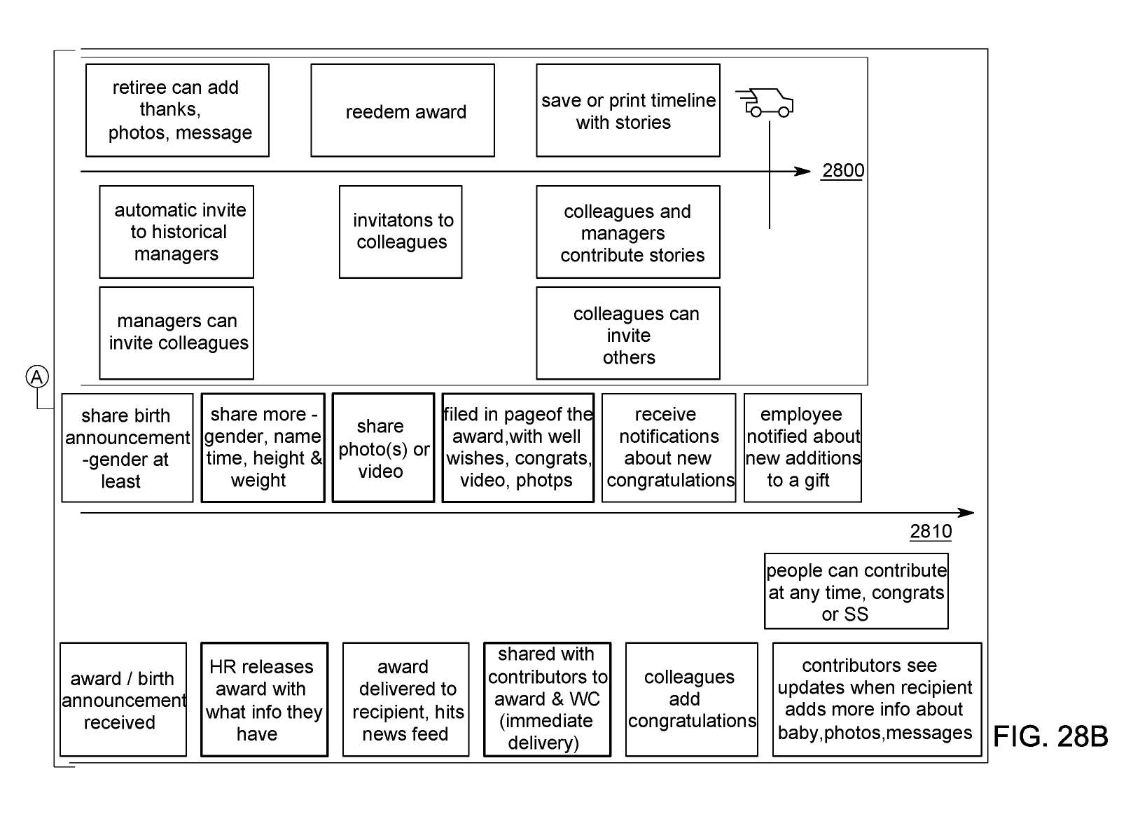

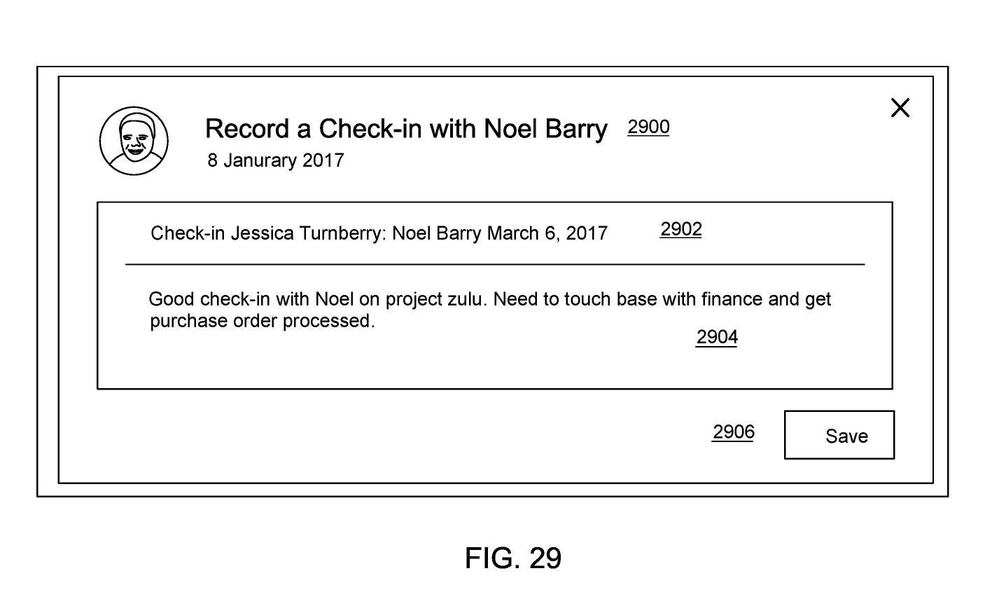

FIG. 29 illustrates a check-in interface in accordance with an embodiment of the invention. The illustrated check-in interface provides an opportunity to record a check-in a2900 and records a data and the participants at 2902 and comments at 2904. The participant can save the check-in at 2906. As described above, rather than employ single annual assessments, employers can endeavor to engage in a series of check-ins and conversations where managers coach employees and assist in goal-setting. In embodiments of the invention, a “check-in” allows for receiving feedback. As illustrated, an employee seeking feedback on a project may “check-in” with his/her supervisor by entering an optional title and a short piece of text describing the check in. The check-in system rounds up new feedback and recognition as well as previous check-ins, feedback and recognition for possible discussion.

In embodiments of the invention, a user and/or manager can initiate a check in and enter an optional title and a short piece of text describing the check in. Employees are presumed to be checking in with their manager, and managers have a choice of direct reports when initiating a check in. Either or both employee and manager can create a check in. Historical check ins are shown for both employee and manager, along with recognition and feedback, all displayed most recent first in chronological order. In embodiments of the invention. The type of item (feedback, check in or recognition) is shown along with the date. In further embodiments of the invention, the employee and the manager can clearly see what activity is new since the last check in. Check-ins can incorporate priorities for employees, milestones, or other goals at which point a supervising user can optionally provide feedback. In embodiments of the invention, a check-in may be converted into a feedback or recognition moment, optionally affiliated with awards as described herein. For example, a manager providing favorable feedback during the check-in may be prompted to convert the check-in into a feedback that can be published on the interactive recognition/feedback wall, as described herein. A manager providing favorable feedback during the check-in may also be prompted to convert the check-in into a recognition or feedback moment that may also be published. The recognition or feedback may be affiliated with a potential award, and the sentiment analysis will also be invoked

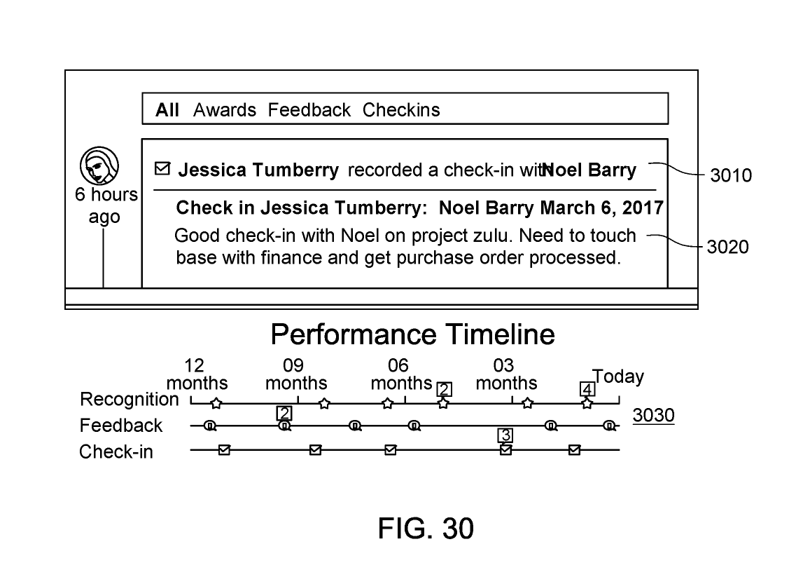

FIG. 30 illustrates a check-in record and a performance timeline in accordance with an embodiment of the invention. A record of the check-in is shown at 3010 and action items are shown at 3020. The interface further shows a performance timeline 3030 which shows a historical view of recognition, feedbacks, and check-ins for an individual over time. In embodiments of the invention, profile page owners are able to select items on the performance timeline 3030 to drill down and view additional details.

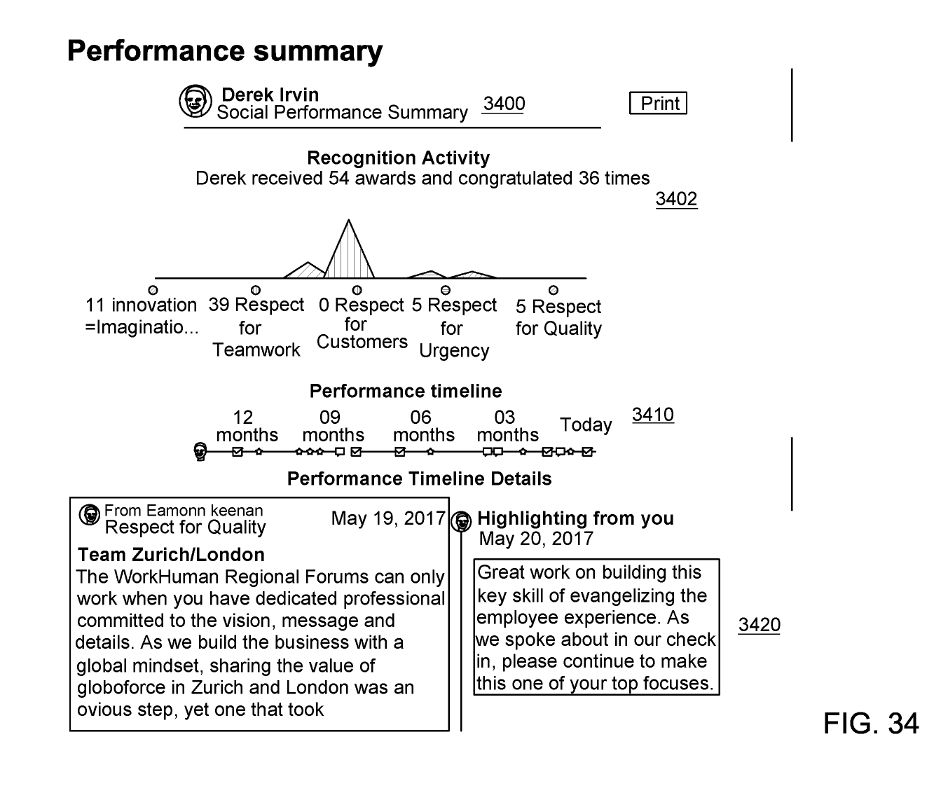

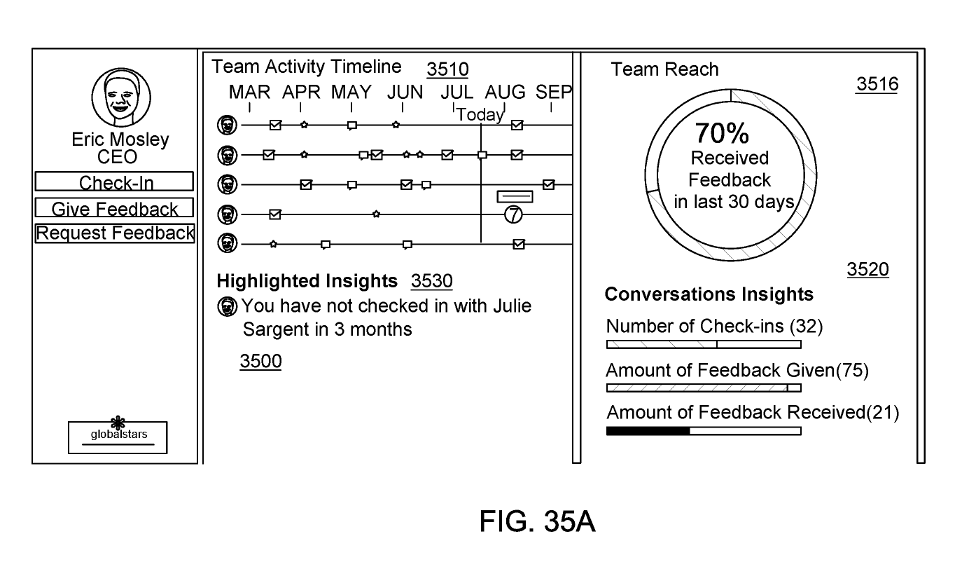

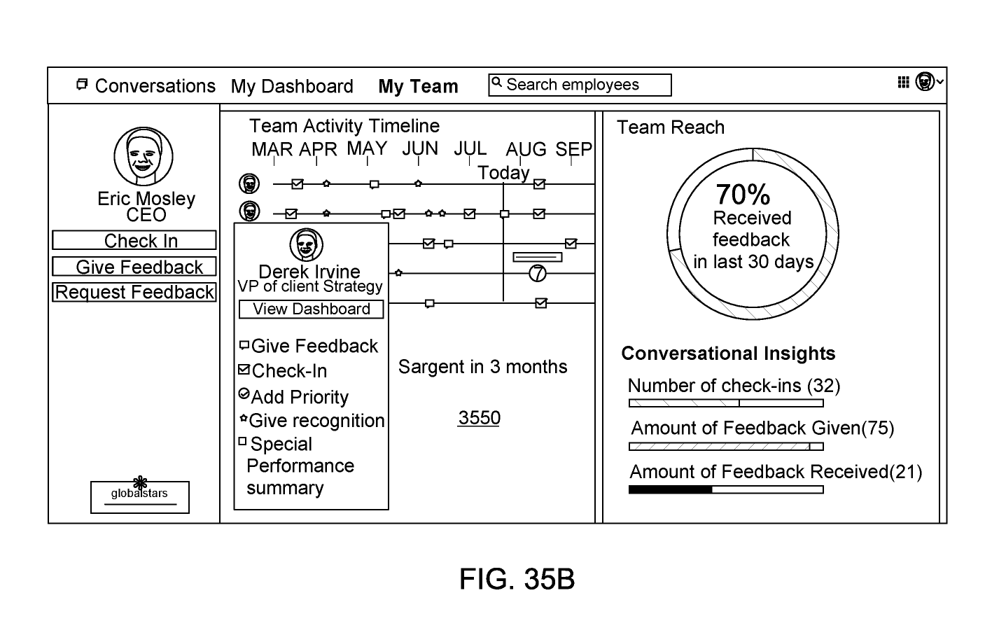

In an embodiment of the invention, the interactive system, through the analysis engine and the web rendering engine allows participants, including both management and employees to view, interact with, compile, and analyze data from gathered or collected related to recognition and/or feedback. For instance, as illustrated in FIGS. 34 and 35 A-C, an individual participant can view his own recognitions (FIG. 34) and a manager may view all of the recognition activities for a particular employee and view a timeline related to such activities (FIGS. 35 A and B).

FIG. 31 illustrates cross company recognition 3100 in accordance with an embodiment of the invention. The recognition may highlight a company value, in this case “customer focus” at 3104 and depict the recognizer and recognize or target participant at 3102. As further illustrated in FIGS. 32A-32C, recognitions may also be submitted by customers and the system is capable of performing an analysis and formulating a graph 3200 to show customer recognitions along y axis 3202 over time represented along x-axis 3206. Participants recognized over time may be photographically illustrated at 3210. Icons 3212 placed on the graph 3200 may be displayed in various colors or formats to represent different projects that generated the recognition. FIG. 32B illustrates a network graph 3220 illustrating participants on a specific team as recognized by customers. FIG. 32C is a further depiction 3230 showing specific customer recognitions as well as recognizing customers.

FIGS. 33A-33D illustrate group recognition in accordance with an embodiment of the invention. As shown in FIG. 33A, a group of individuals 3300 can elect to recognize an individual participant as a group at 3308. A search field 3302 enables searching of available nominees 3304. FIG. 33B shows the nomination of Greg Stevens at 3310. Historical data including participants previously recognized may be shown at 3312 and the entire time may be shown at 3314. The nominee is shown at 3318. To proceed with the nominations, the group is able to select the next button 3320. FIGS. 33C and 33D illustrate the recognition for adherence to specific values at 3300 and the potential points acquired at 3310.

FIG. 34 illustrates a user interface 3400 showing performance metrics in accordance with an embodiment of the invention. Specifically, the interface 3400 shows a social performance summary including recognition activity 3402. The recognition activity 3402 is illustrated graphically by organization value and the number of recognitions for the participant for each illustrated value is shown. A performance timeline 3410 shows recognitions over time and may include selectable icons enabling the participant to view the specific recognitions 3420.

FIGS. 35A and 35B illustrate manager profile pages or interfaces accessible from the profile page in accordance with an embodiment of the invention. The manager may view an interface 3500 including a timeline 3510 showing when the employee received or provided recognition or feedback and the details regarding such actions. As part of this interface, the manager may view all of the recognition and feedback from and/or to each member of a particular team and identify a team's reach, which may provide the percentage of employees from one or more teams that received feedback in a given time period at 3516. The manager may further review various data regarding the team's recognition and feedback moments, including the number of check-ins, the amount of feedback given and the amount received, internally and externally to the team. In one embodiment, a manager or employees may further view whether a feedback or recognition is tagged or associated with an employee, a team (ad hoc or formally assigned), an employee's priority, a project, an employee's strength attribute, or competency, or other types of categories, attributes, or groups discussed herein. The manager may select icons on the timeline to drill down and view additional interfaces showing specific feedback, recognitions, check-ins or other performance parameters.

In embodiments of the invention, managers may view each employee's history of recognition, nominations placed, congratulations expressed, and other information. Furthermore, managers may view the breakdown of each employee's recognition, including the recognitions based on types, nominators, levels of recognitions, awards, strengths, frequency, and other information. Additionally, each employee's recognition may be compared with that of other employees. Thus, managers may be presented with how each employee's recognition compares to other employees on his or her team, others with similar stature, others within the company, and others in the world across all companies. Managers may easily recognize whether an employee is being recognized more than other employees on his/her team or are receiving less quality recognition than others in the company (e.g., as compared to others that are paid the same or with the company for the same number of years).

Managers may also review automatically generated data regarding whether particular teams are receiving and exchanging recognitions more than other teams in the company and identify, for example, the amount of recognition that team is receiving over other team members, e.g., over the average number of recognition received per team in the organization. Examples of data viewable include awards year-to-date, awards across time, awards by group and level, awards by reason, awards by geography, awards by organization, and awards between geographies and organizations. Managers may filter and customize recognition reports based on date, country, approver, nominator, recipient and various other data attributes.

In at least one embodiment, an employee's recognition data may be compared to his/her performance reports generated by the company in the ordinary course (annually, bi-annually, quarterly and so on). Thus, managers may view the underlying data of an employee's performance alignment as compared to other employees, just as the manager may view an employee's performance alignment graph.

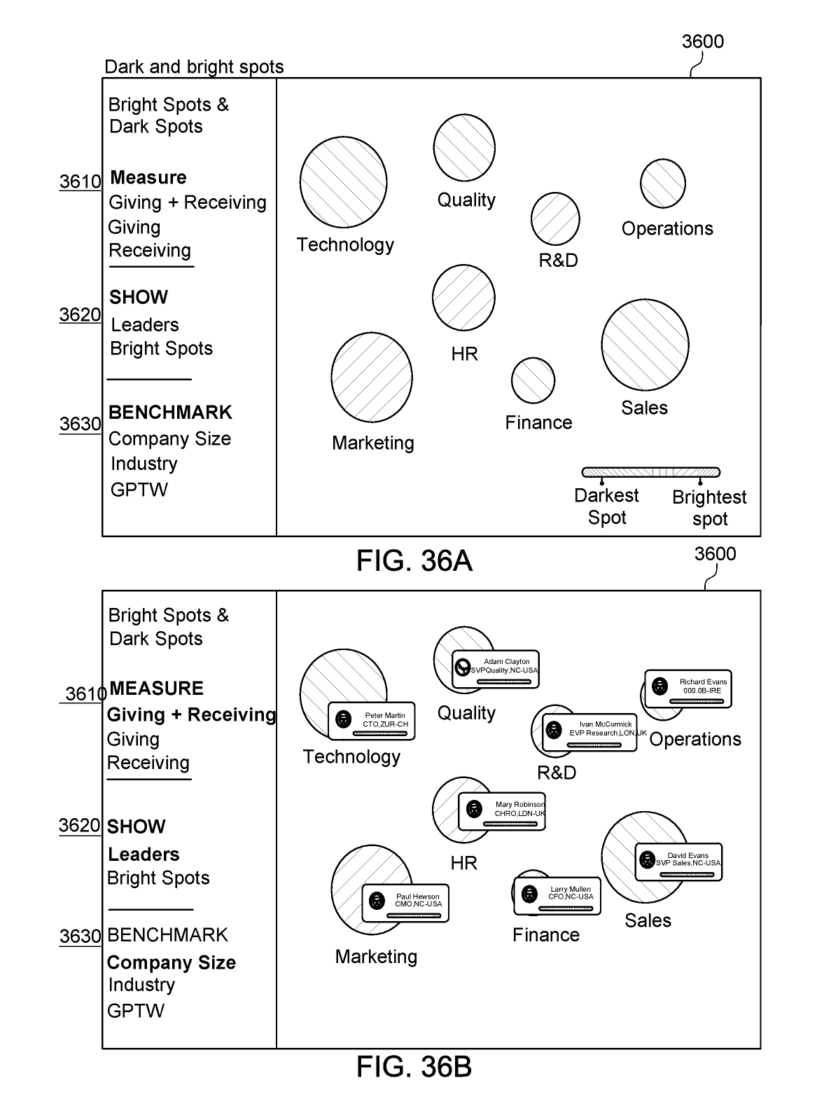

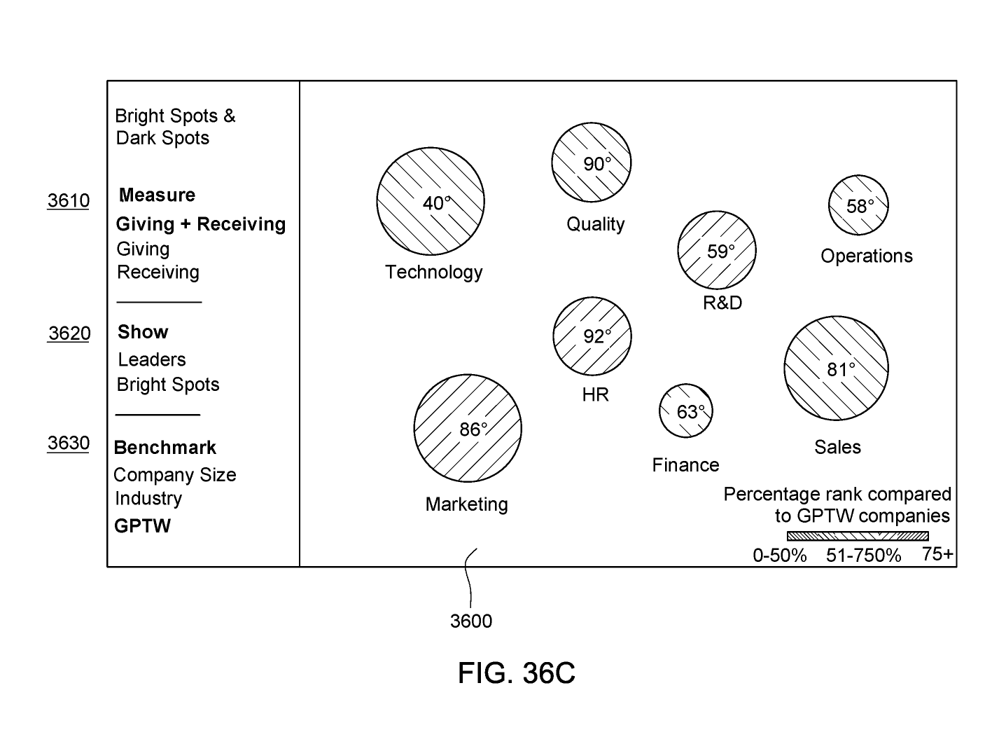

FIGS. 36A-C illustrate the impact of cultural energizers integrated into the interactive systems. In embodiments of the invention, the company value may be company culture. For example, the company culture can include the values of the work environment, the method by which people work (i.e. relaxed, etc.), or expectations of the employee. As such, employees may be recognized for driving the culture of the company. For instance, a company valuing frequent feedback may reward a broad, frequent, feedback giver (recognizer), whose feedback is based in part on company values, for example. Skilled artisans would recognize the various company values and criteria for meeting those values. In another example, a company valuing a collegial work environment may reward individual(s) who work well in teams. In embodiments of the invention, an employer may be able to quickly ascertain which teams, groups, individuals, or company divisions are better at providing recognition.

Accordingly, FIGS. 36A-C provide an interface 3600 showing dark spots and bright spots. The dark spots and bright spots can quickly help a company ascertain a metric by which to determine who is providing feedback within particular sectors of the organization, and the quality of the feedback as described herein. In embodiments of the invention, the circles can expand or retract, in addition to light or darken, as defined by the company. Skilled artisans would recognize the various ways by which to customize the spots. Selectable measures 3610 measure important values such as giving and receiving. Viewing options 3620 allow a user to select a view and a benchmark selection 3630 allows users to select a benchmark. FIG. 36B shows the measure of giving and receiving and provides leaders within the bright and dark spots. FIG. 36C illustrates the achievement of benchmarks by sector

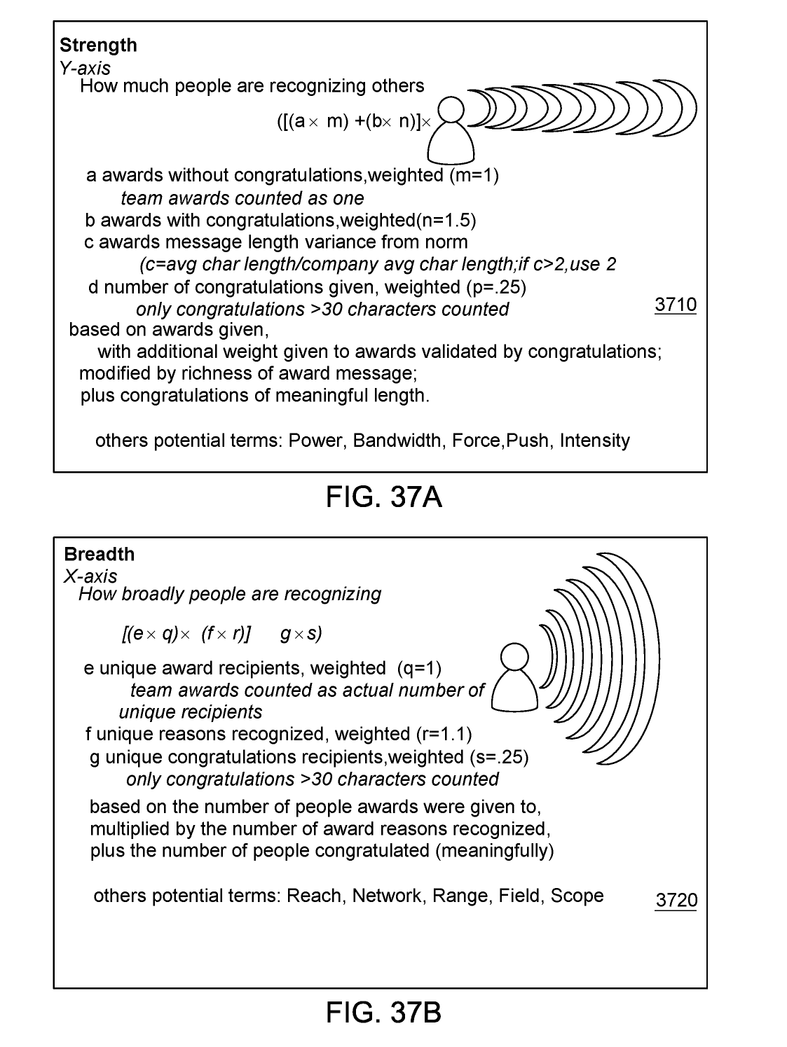

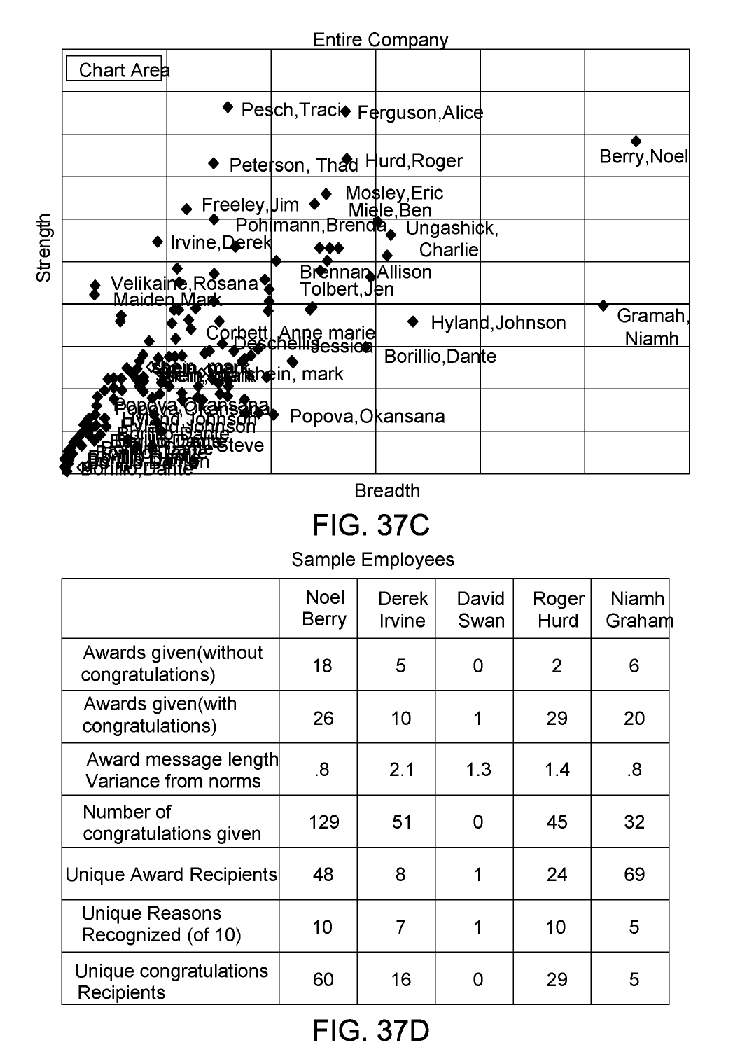

In embodiments of the invention, and as illustrated in FIGS. 37A-37D, cultural energizers may be utilized to reveal the key people in organization that energize the company's culture. FIG. 37A illustrates a “strength” variable that can be computed to illustrate how much participants are recognizing other participants and FIG. 37B illustrates a breadth variable that can be computed to illustrated how broadly participants are performing recognitions.

FIG. 37C provides a plot of the strength and breadth variables. For example, the Y-axis plots strength using the following equation: y=([(a×m)+(b×n)]×c)+(d×p), where “a” is the number of awards without congratulations, “b” is the number of awards with congratulations, “c” is the number of awards given at varying lengths from the normal, and d is the number of congratulations given. The X-axis plots the breadth variable showing how broadly people are recognizing using the following equation: (e×q)×(f×r)]+(g×s), wherein “e” is the number of unique award recipients, “f” is the number of unique reasons recognized, and “g” is the number of unique congratulations recipients. Thus, the plot of FIG. 37C and a sample list of participant participation characteristics shown in FIG. 37D can be produced. The plot of FIG. 37 enables rapid visualization of the participants having both breadth and strength and functioning as cultural energizers. The chart of FIG. 37D is a partial list showing participants on the plot and the list of characteristics that contributed to the positioning on the chart.

As briefly discussed above, the computer systems disclosed herein, may include a special purpose computer or a general purpose computing device in the form of a computer including a processing unit, a system memory, and a system bus that couples various system components including the system memory to the processing unit. Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system or platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, PHP, Prolog, Python, REXX, and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media is typically connected to the system bus through a removable or non-removable memory interface.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each processor and/or memory may be composed of different physical pieces of equipment.

A participant may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a participant input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Certain embodiments of the invention were described above. It is, however, expressly noted that the invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made expressly herein, without departing from the spirit and scope of the invention. In fact, variations, modifications, and other implementations of what was described herein will occur to those of ordinary skill in the art without departing from the spirit and the scope of the invention. In particular, it should be understood that the order of steps or order for performing certain actions is immaterial so long as the invention remains operable. Two or more steps or actions may also be conducted simultaneously. As such, the invention is not to be defined only by the preceding illustrative description.

From the foregoing, it will be seen that this invention is one well adapted to attain all the ends and objects set forth above, together with other advantages, which are obvious and inherent to the systems and methods. It will be understood that certain features and sub-combinations are of utility and may be employed without reference to other features and sub-combinations. This is contemplated and within the scope of the invention.

What is claimed is:

1. An interactive performance monitoring and enhancement system for system participants, the system comprising:
at least one non-transitory electronic storage medium storing data and instructions;
at least one computer processor executing the stored instructions and utilizing stored data to operate as:
a web rendering engine rendering a unique profile page for system participants, each unique profile page facilitating interconnectedness between the system participants and providing a feedback option for entry of feedback to the system participants, and a recognition option for recognizing the system participants;
a feedback engine for receiving textual feedback from the system participants through corresponding unique profile pages, the textual feedback directed at a target participant, and performing text analysis on the textual feedback, the text analysis determining a degree of positivity of the textual feedback, and providing guidance to the system participants based on the determined degree of positivity;
and
a recognition engine for receiving input of a recognition of an achievement of the target participant, the recognition received from another member of the organization through the corresponding unique profile page, the recognition engine delivering and displaying the recognition to the target participant, wherein the web rendering engine provides a unique timeline of feedback and recognitions on each unique profile page enabling rapid visualization of performance over time.

2. The system of claim 1, further comprising a check-in engine for receiving textual input from the system participants through the corresponding unique profile pages, the textual input initiating a conversation with at least one target participant;

3. The system of claim 2, wherein each unique profile page provides a unique history of feedback, recognition, and check-ins for the system participants along a timeline.

4. The system of claim 3, wherein the timeline includes selectable icons allowing drilling down to view recognition moments and feedback corresponding to a particular date.

5. The system of claim 1, wherein a text analysis module compares the entered textual feedback to stored company values and highlights company values in the entered textual feedback.

6. The system of claim 1, wherein if the entered textual feedback reaches a predetermined threshold of positivity, a recommendation engine recommends converting the feedback to a recognition moment for the target participant.

7. The system of claim 1, wherein the web rendering engine provides an option for multiple participants to simultaneously provide feedback to the target participant.

8. The system of claim 1, wherein the achievement of the target participant is a life event.

9. The system of claim 1, wherein the recognition engine comprises a guidance module capable of recommending conversion of a recognition to an award.

10. The system of claim 1, further comprising an analysis engine for calculating connectedness of the system participants based on recorded feedback and recognition.

11. The system of claim 1, further comprising displaying the recognition and feedback to system participants connected with the target participant.

12. The system of claim 1, further comprising a feedback notification module for delivering notification of received feedback to the target participant.

13. An interactive performance monitoring and enhancement method for system participants, the method comprising:
storing data and instructions in at least one non-transitory electronic storage medium;
executing the stored instructions and utilizing the stored data to perform steps including;
rendering a unique profile page for the system participants, each unique profile page facilitating interconnectedness between the system participants and providing a feedback option for entry of feedback to the system participants and a recognition option for recognizing the system participants;
receiving textual feedback from system participants through corresponding unique profile pages, the textual feedback directed at a target participant;
performing text analysis on the textual feedback, the text analysis determining a degree of positivity of the feedback;
providing guidance based on the determined degree of positivity and delivering the feedback to the target participant;
receiving input of a recognition of an achievement of the target member of the organization through each unique profile page, the recognition engine delivering and displaying the recognition to the target member, wherein the web rendering engine provides a unique timeline of feedback and recognitions on each unique profile page enabling rapid visualization of performance over time.

14. The method of claim 13, further comprising receiving textual input for a check-in from the system participants through the corresponding unique profile pages, the textual input initiating a conversation with at least one target participant;

15. The method of claim 14, further comprising providing, on each unique profile page, a unique history of feedback, recognition, and check-ins for the system participants along a timeline.

16. The method of claim 15, wherein the timeline includes selectable icons allowing drilling down to view recognition moments and feedback corresponding to a particular date.

17. The method of claim 13, further comprising comparing the entered textual feedback to stored company values and highlights company values in the entered textual feedback.

18. The method of claim 13, recommending, when the entered textual feedback reaches a predetermined threshold of positivity, converting the entered textual feedback to a recognition moment for the target participant.

19. The method of claim 13, further comprising providing, via the web rendering engine, an option for multiple participants to simultaneously provide feedback to the target participant.

20. The method of claim 13, wherein the achievement of the target participant is a life event.

21. The method of claim 13, further comprising providing a guidance module capable of recommending conversion of a recognition to an award.

22. The method of claim 13, further comprising providing an analysis engine for calculating connectedness of system participants based on recorded feedback and recognition.

23. The method of claim 13, further comprising displaying the recognition and feedback to system participants connected with the target participant.

24. The method of claim 13, further comprising providing a feedback notification module for delivering notification of received feedback to the target participant.

25. A performance monitoring and enhancement system for facilitating feedback exchange between participants in an organization, the system comprising:
at least one non-transitory electronic storage medium storing data and instructions;
at least one computer processor executing the stored instructions and utilizing stored data to operate as:
a web rendering engine rendering a unique profile page for the system participants, each unique profile page facilitating interconnectedness between the participants in the organization and providing a feedback option for entry of feedback to the system participants; and
a feedback engine for receiving textual feedback from the system participants entered through corresponding unique profile pages provided by the web rendering engine, the textual feedback directed to a target participant, the feedback engine including:
a text analysis module for operating on the entered text along a sentiment spectrum to determine a degree of positivity of the feedback and to evaluate the entered text against stored company values;
a recommendation engine for providing guidance in response to the entered text based on the determined degree of positivity and compliance with the stored company values; and
a notification module for electronically notifying the target participant of the received feedback.

26. The system of claim 25, wherein the text analysis module highlights company values in the entered text.

27. The system of claim 25, wherein if the entered text reaches a predetermined threshold of positivity, the recommendation engine recommends converting the feedback to a recognition moment.

28. The system of claim 25, wherein the web rendering engine further provides a recognition option through each unique profile page, the recognition option allowing the system participants to recognize other participants for achievements.

29. The system of claim 28, wherein the web rendering engine further provides a check-in option allowing participants to initiate conversations with other participants through a corresponding unique profile page.

30. The system of claim 29, wherein an analysis engine provides a timeline of received recognitions, feedback, and check-ins on each unique profile page to enable rapid visualization of individual performance.

31. The system of claim 30, wherein the timeline includes selectable icons enabling drilling down to view content of the feedback, the recognitions, and the check-ins based on a receipt date.

32. The system of claim 25, wherein the web rendering engine displays the textual feedback to the target participant and to participants connected with the target participant.

33. The system of claim 25, wherein the feedback engine receives combined feedback from multiple participants for the target participant.

34. A performance monitoring and enhancement method for facilitating feedback exchange between system participants, the method comprising:
storing data and instructions in at least one non-transitory electronic storage medium;
executing the stored instructions using at least one computer processor using the stored data perform steps including:
rendering a unique profile page for the system participants, each unique profile page accessible over a network and facilitating interconnectedness between the system participants and providing a feedback option for entry of feedback to the system participants;
receiving textual feedback from the system participants entered through corresponding unique profile pages provided by the web rendering engine, the textual feedback directed at a target participant:
operating on the entered text using a text analysis module to evaluate the entered text along a sentiment spectrum to assess a degree of positivity and to evaluate the entered text against stored company values;
providing guidance based on the text analysis on the feedback based on the determined degree of positivity and compliance with stored company values; and
electronically notifying the target member receiver of received feedback.

35. The method of claim 34, further comprising highlighting company values in the entered text.

36. The method of claim 34, further comprising recommending converting the feedback to a recognition moment when the entered text reaches a predetermined threshold of positivity.

37. The method of claim 34, further comprising providing a recognition option through each unique profile page, the recognition option allowing the system participants to recognize other system participants for achievements.

38. The method of claim 37, further comprising providing a check-in option allowing participants to initiate conversations with other participants through a corresponding unique profile page.

39. The method of claim 38, wherein an analysis engine provides a timeline of received recognitions, feedback, and check-ins on each unique profile page to enable rapid visualization of individual performance.

40. The method of claim 39, further comprising the timeline with selectable icons enabling drilling down to view content of the feedback, the recognitions, and the check-ins based on a receipt date.

41. The method of claim 34, further comprising displaying the textual feedback to the target participant and to participants connected with the target participant.

42. The method of claim 34, wherein the feedback engine receives combined feedback from multiple participants for the target participant.
